(19) United States
(12) Patent Application Publication
(10) Pub. No.: US 2026/0211779 A1
(43) Pub. Date: Jul. 23, 2026

(54) SYSTEMS AND METHODS FOR WRITE-AHEAD-LOG (WAL) FAILOVER FOR TRANSIENT DISK UNAVAILABILITY

(71) Applicant: Cockroach Labs, Inc., New York, NY (US)

(72) Inventors: Jackson Blair Owens, Brooklyn, NY (US); Sumeer Kumar Bhola, Brooklyn, NY (US)

(21) Appl. No.: 19/452,129

(22) Filed: Jan. 16, 2026

Related U.S. Application Data
(60) Provisional application No. 63/746,551, filed on Jan. 17, 2025.

(51) Int. Cl. G06F 11/1471; G06F 11/20; G06F 11/30

(52) U.S. Cl. CPC G06F 11/1471; G06F 11/2028; G06F 11/2046; G06F 11/3034

(57) ABSTRACT

Systems and methods for mitigating transient unavailability of a disk are provided. A plurality of write requests configured to write data to each of a memory table stored by a memory and a write-ahead-log (WAL) file can be received. A first group of the write requests can be executed by writing to a first WAL file segment stored by the primary disk. When the primary disk health parameter indicates transient unavailability of the primary disk, a second group of the write requests can be executed by switching and writing data to a second WAL file segment stored by a secondary disk. When at least one of the transient unavailability of the primary disk is resolved, or transient unavailability of the secondary disk exists, a third group of the write requests can be executed by switching and writing to a third WAL file segment stored by the primary disk.

### CROSS-REFERENCE TO RELATED APPLICATION

This application claims priority to and the benefit of U.S. Provisional Patent Application No. 63/746,551, filed Jan. 17, 2025, which is hereby incorporated by reference herein in its entirety.

### FIELD OF TECHNOLOGY

The present disclosure relates generally to methods and systems for mitigating transient unavailability of a disk and, more particularly, to failover between disks in the event of transient unavailability of one of the disks in a buffered-write storage system.

### BACKGROUND

In some cases, relational databases may apply replication to ensure data survivability, where data is replicated among one or more computing devices (“nodes”) of a group of computing devices (“cluster”) configured to operate as a single distributed database server. A relational database may store data within one or more ranges, such that a range may (i) include one or more key-value (KV) pairs each including a key mapped to a value, and (ii) be replicated among one or more nodes of the cluster. A range may be a partition of a data table (“table”), where a table may include one or more ranges. The database may receive and process requests (e.g., such as read or write requests originating from client devices) directed to data and/or schema objects stored by the database, thereby allowing for reading from and modification of the data and/or schema objects. Accordingly, a database may operate as a KV store, with one or more databases operating respective KV stores deployed to and stored by the cluster of nodes.

To organize data (e.g., range data including one or more KV pairs) stored by the database, nodes of the cluster operating the database may implement a buffered-write storage system including, for example, log-structured merge (LSM) tree data structures, B-epsilon tree data structures, and/or STB-epsilon-tree data structures operating at the individual nodes of the cluster. An LSM tree data structure may be referred to herein as an “LSM tree.” Accordingly, a logical KV store of the database may be implemented as a buffered-write storage system, such as an LSM tree, B-epsilon tree, and/or STB-epsilon-tree stored by a disk available to an individual node of the cluster. A buffered-write storage system may buffer received write operations directed to the database by writing data according to the write operations to both a memory table (“memtable”) in a sorted format stored in-memory (e.g., by volatile, non-persistent storage) and to a write-ahead-log (WAL) file mapped to the memtable and stored on-disk (e.g., by non-volatile, persistent storage). By buffering the written data in the memtable stored in-memory, the database may provide efficient read access to the written, sorted data within the memtable. As written data is buffered in the memtable, the size of the memtable may grow up to a storage size allowed by the volatile, non-persistent storage (e.g., random-access memory (RAM) storage). As an example, with a large amount of RAM available to a particular node, the node may receive and buffer written data derived from over ten seconds of executed KV write operations in-memory within one or more memtables stored by the RAM. Further, by writing the data to the WAL file stored on-disk, the database may further guarantee durability of the written data in the event of a failure of the volatile, non-persistent storage storing the memtable, such that the state of the memtable at the time of the failure may be recovered using the written data in the WAL file. When the memtable reaches a threshold storage size, the written data of the memtable may be flushed to non-volatile, persistent storage in an indexed, sorted format for efficient read access, and the memtable and corresponding WAL file may be deleted from storage. Additional memtables and corresponding WAL files may be subsequently generated to service received write operations directed to the database. Thus, the combination of writing to both the memtable and the WAL file operates according to a buffered-write storage system to provide durability of written data and efficient access to the written data for subsequent read operations.

Nodes of the cluster may operate using a number of physical block storage devices (also referred to herein as “physical disks”) for data storage, where a physical disk may be a persistent, non-volatile storage device such as a hard disk device, an optical disk device, a solid-state drive (SSD), a flash drive, or some other large capacity storage device. Data stored by the cluster can be stored among the physical disks available to the nodes, with each node having access (e.g., being communicatively connected) to one or more physical disks. In some cases, a node may be located in the same physical location as the one or more physical disks to which the node is communicatively connected, such as by being physically connected to the node. As an example, at least one processor, a memory (e.g., non-persistent, volatile storage), and one or more physical disks may be communicatively and/or physically connected to function and operate as an individual node of the cluster based on the at least one processor being configured to execute computer-readable instructions stored by the memory to perform the operations described herein.

Further, nodes of the cluster may operate in a cloud environment with a number of virtual block storage devices (also referred to herein as “virtual disks”) operating on the physical disks accessible to the nodes. A virtual disk may use one or more (e.g., multiple) physical disks, with the virtual disk being provisioned from, mapped to, and/or otherwise backed by one or more physical disks. As an example, multiple of such virtual disks may be multiplexed on the one or more physical disks of a node. In some cases, a virtual disk may be a distributed system that uses multiple physical disks. A virtual disk may appear to software as a block-addressable storage device and may be dynamically sized, relocated, replicated, snapshotted, and/or shared independently of the one or more underlying physical disks.

A disk (e.g., a physical disk and/or a virtual disk) may experience transient unavailability (also referred to as “transient disk unavailability”) that manifests as high latency for read requests and/or write requests directed to data stored by the disk experiencing the transient unavailability. A high latency for read requests and/or write requests may vary depending on the workload deployed to the disk and may range, for example, from 50 milliseconds (ms) to 20 seconds. Such high latencies may affect all write requests directed to the disk experiencing the transient unavailability, though read requests may avoid such latencies when data to be read by the read requests is cached in-memory, thereby allowing the read requests to avoid reading from the disk. As an example, a block cache operating in conjunction with an LSM tree may buffer frequently accessed data blocks from different levels of the LSM tree, thereby allowing read requests to execute by reading from the data of the block cache stored in-memory instead of the sorted string table (SST) files of the LSM tree stored on-disk. Further, execution of read requests may require fewer physical disks to be available, thereby avoiding further transient unavailability associated with greater numbers of physical disks. As an example, when a virtual disk uses two physical disks in a synchronous primary physical disk to backup physical disk configuration, transient unavailability of the backup disk may cause a delay in execution of write requests (e.g., based on the requirement to synchronously write to both the primary and backup physical disks), but does not affect execution of read requests.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Accordingly, improved systems and methods for failover between disks in the event of transient unavailability in a buffered-write storage system are desired to avoid increased latencies for write operations caused by transient unavailability of the disk(s) to which the write operations are directed. Thus, methods and systems for failover between disks based on detected transient unavailability of one of the disks in a buffered-write storage system are disclosed.

In one aspect, embodiments of the present disclosure feature a system for failover between disks during transient unavailability. According to one embodiment, the system may include a processor. The system may also include a memory storing instructions that, when executed by the processor, configure the system to perform operations. The operations may include receiving a plurality of write requests configured to write data to each of one or more memory tables (memtables) stored by a second memory and one or more write-ahead-log (WAL) files. The operations may include executing first write operations including execution of a first group of the plurality of write requests by writing a first part of the data to a first WAL file segment of a first WAL file of the one or more WAL files, the first write operations being directed to a primary disk and the first WAL file segment being stored by the primary disk. The operations may include monitoring a primary disk health parameter of the first write operations. The operations may include, when the primary disk health parameter indicates transient unavailability of the primary disk, switching from the primary disk to a secondary disk and executing second write operations including execution of a second group of the plurality of write requests by writing a second part of the data to a second WAL file segment of a second WAL file of the one or more WAL files, the second write operations being directed to the secondary disk and the second WAL file segment being stored by the secondary disk. The operations may include monitoring, in response to switching from the primary disk to the secondary disk, at least one of (i) at least one primary disk probe parameter of probe operations directed to the primary disk, or (ii) a secondary disk health parameter of the second write operations. The operations may include, when at least one of (i) the at least one primary disk probe parameter indicates the transient unavailability of the primary disk is resolved, or (ii) the secondary disk health parameter indicates transient unavailability of the secondary disk, switching from the secondary disk to the primary disk and executing third write operations including execution of a third group of the plurality of write requests by writing a third part of the data to a third WAL file segment of a third WAL file of the one or more WAL files, the third write operations being directed to the primary disk and the third WAL file segment being stored by the primary disk.

Various embodiments of the system may include one or more of the following features. The system may also include where the second memory is a non-persistent, volatile storage device. The system may also include where the primary disk is a first persistent, non-volatile storage device and the secondary disk is a second persistent, non-volatile storage device different from the first persistent, non-volatile storage device. The system may also include where the primary disk is a first virtual disk multiplexed on one or more first persistent, non-volatile storage devices and the secondary disk is a second virtual disk multiplexed on one or more second persistent, non-volatile storage devices, the first virtual disk being different from the second virtual disk. The system may also include where (i) the data includes key-value (KV) data, (ii) the KV data of each memtable of the one or more memtables is sorted by key, and (iii) each of the one or more memtables is mapped to a respective one of the one or more WAL files. The system may also include where two or more of the first WAL file, the second WAL file, and the third WAL file are a same WAL file of the one or more WAL files. The system may also include where two or more of the first WAL file, the second WAL file, and the third WAL file are different WAL files of the one or more WAL files.

The system may also include where (i) the first WAL file segment includes a first plurality of WAL records including the first part of the data, (ii) the second WAL file segment includes a second plurality of WAL records including the second part of the data, and (iii) at least one WAL record of the first plurality of WAL records is a duplicate of at least one WAL record of the second plurality of WAL records. The system may also include where (i) the first WAL file segment includes a first plurality of WAL records including the first part of the data, (ii) the second WAL file segment includes a second plurality of WAL records including the second part of the data, (iii) no WAL record of the first plurality of WAL records is a duplicate of any WAL record of the second plurality of WAL records, and (iv) no WAL record of the second plurality of WAL records is a duplicate of any WAL record of the first plurality of WAL records. The system may also include where (i) the second WAL file segment includes a second plurality of WAL records including the second part of the data, (ii) the third WAL file segment includes a third plurality of WAL records including the third part of the data, and (iii) at least one WAL record of the second plurality of WAL records is a duplicate of at least one WAL record of the third plurality of WAL records. The system may also include where (i) the second WAL file segment includes a second plurality of WAL records including the second part of the data, (ii) the third WAL file segment includes a third plurality of WAL records including the third part of the data, (iii) no WAL record of the second plurality of WAL records is a duplicate of any WAL record of the third plurality of WAL records, and (iv) no WAL record of the third plurality of WAL records is a duplicate of any WAL record of the second plurality of WAL records.

The system may also include where the first write operations further include at least one of generating and causing storage of the first WAL file segment by the primary disk, and synchronizing first metadata of a first memtable of the one or more memtables with the first WAL file segment by writing the first metadata to the first WAL file segment. The system may also include where the execution of the first group of the plurality of write requests further includes writing the first part of the data to a first memtable of the one or more memtables, the execution of the second group of the plurality of write requests further includes writing the second part of the data to a second memtable of the one or more memtables, and the execution of the third group of the plurality of write requests further includes writing the third part of the data to a third memtable of the one or more memtables. The system may also include where the primary disk health parameter includes a first latency of the first write operations, where the primary disk health parameter indicates the transient unavailability of the primary disk when the first latency is greater than a first threshold latency, and where the operations further include monitoring, during execution of the first write operations, the first latency of the first write operations, and when the first latency is greater than the first threshold latency, switching from the primary disk to the secondary disk and executing the second write operations directed to the secondary disk. The system may also include where the operations further include iteratively executing one or more iterations of the probe operations, each iteration of the probe operations includes generating and causing storage of a probe file by the primary disk, writing, in response to causing storage of the probe file, probe data to the probe file, synchronizing, in response to writing the probe data to the probe file, the probe data, and deleting, in response to synchronizing the probe data, the probe file from storage by the primary disk.

The system may also include where the at least one primary disk probe parameter includes at least one second latency of the probe operations, where the at least one primary disk probe parameter indicates the transient unavailability of the primary disk is resolved when the at least one second latency is less than a second threshold latency, and where the operations further include monitoring, in response to switching from the primary disk to the secondary disk and during execution of the probe operations, the at least one second latency of the probe operations, and when the at least one second latency is less than the second threshold latency, switching from the secondary disk to the primary disk and executing the third group of the plurality of write requests. The system may also include where the at least one second latency further includes a plurality of second latencies, where the operations further include determining, for each iteration of the probe operations, a respective second latency of the plurality of second latencies, the respective second latency being for that iteration of the probe operations, and when the respective second latencies of a threshold number of consecutive iterations of the probe operations are each less than the second threshold latency, switching from the secondary disk to the primary disk and executing the third write operations directed to the primary disk.

The system may also include where the secondary disk health parameter includes a third latency of the second write operations, where the secondary disk health parameter indicates the transient unavailability of the secondary disk when the third latency is greater than a third threshold latency, and where the operations further include monitoring, in response to switching from the primary disk to the secondary disk and during execution of the second write operations, the third latency of the second write operations, and when the third latency is greater than the third threshold latency, switching from the secondary disk to the primary disk and executing the third write operations directed to the primary disk.

The system may also include where the operations further include writing and causing storage of, in response to switching from the secondary disk to the primary disk, at least part of the second part of the data of the second WAL file segment to the primary disk. The system may also include where writing and causing storage of at least part of the second part of the data of the second WAL file segment to the primary disk further includes ordering and de-duplicating one or more of: (i) a first plurality of WAL records of the first WAL file segment, (ii) a second plurality of WAL records of the second WAL file segment, or (iii) a third plurality of WAL records of the third WAL file segment based on the first part of the data, the second part of the data, and the third part of the data.

The system may also include where each write request of the first group of the plurality of write requests is different from each write request of the third group of the plurality of write requests. The system may also include where at least one write request of the first group of the plurality of write requests is the same as at least one write request of the second group of the plurality of write requests, and where at least one write request of the second group of the plurality of write requests is the same as at least one write request of the third group of the plurality of write requests. The system may also include where the operations further include, when a first memtable of the one or more memtables meets or exceeds a threshold storage size, flushing the first memtable to generate a first sorted string table (SST) file of a plurality of SST files stored by the primary disk, where the plurality of SST files are organized in a log-structured merge (LSM) tree data structure including one or more levels, and in response to the flushing of the first memtable, deleting both the first memtable from storage by the second memory and the first WAL file from storage by the primary disk and generating a second memtable of the one or more memtables stored by the second memory.

In another aspect, embodiments of the present disclosure feature a method for failover between disks during transient unavailability. According to one embodiment, the method may include receiving a plurality of write requests configured to write data to each of one or more memory tables (memtables) stored by a second memory and one or more write-ahead-log (WAL) files. The method may include executing first write operations including execution of a first group of the plurality of write requests by writing a first part of the data to a first WAL file segment of a first WAL file of the one or more WAL files, the first write operations being directed to a primary disk and the first WAL file segment being stored by the primary disk. The method may include monitoring a primary disk health parameter of the first write operations. The method may include, when the primary disk health parameter indicates transient unavailability of the primary disk, switching from the primary disk to a secondary disk and executing second write operations including execution of a second group of the plurality of write requests by writing a second part of the data to a second WAL file segment of a second WAL file of the one or more WAL files, the second write operations being directed to the secondary disk and the second WAL file segment being stored by the secondary disk. The method may include monitoring, in response to switching from the primary disk to the secondary disk, at least one of (i) at least one primary disk probe parameter of probe operations directed to the primary disk, or (ii) a secondary disk health parameter of the second write operations. The method may include, when at least one of (i) the at least one primary disk probe parameter indicates the transient unavailability of the primary disk is resolved, or (ii) the secondary disk health parameter indicates transient unavailability of the secondary disk, switching from the secondary disk to the primary disk and executing third write operations including execution of a third group of the plurality of write requests by writing a third part of the data to a third WAL file segment of a third WAL file of the one or more WAL files, the third write operations being directed to the primary disk and the third WAL file segment being stored by the primary disk.

Various embodiments of the method may include one or more of the following features. The second memory may be a non-persistent, volatile storage device. The primary disk may be a first persistent, non-volatile storage device and the secondary disk may be a second persistent, non-volatile storage device different from the first persistent, non-volatile storage device. The primary disk may be a first virtual disk multiplexed on one or more first persistent, non-volatile storage devices and the secondary disk may be a second virtual disk multiplexed on one or more second persistent, non-volatile storage devices, the first virtual disk being different from the second virtual disk. In some variations, (i) the data may include key-value (KV) data, (ii) the KV data of each memtable of the one or more memtables may be sorted by key, and (iii) each of the one or more memtables may be mapped to a respective one of the one or more WAL files. Two or more of the first WAL file, the second WAL file, and the third WAL file may be a same WAL file of the one or more WAL files. Two or more of the first WAL file, the second WAL file, and the third WAL file may be different WAL files of the one or more WAL files.

In some variations, (i) the first WAL file segment may include a first plurality of WAL records including the first part of the data, (ii) the second WAL file segment may include a second plurality of WAL records including the second part of the data, and (iii) at least one WAL record of the first plurality of WAL records may be a duplicate of at least one WAL record of the second plurality of WAL records. In some variations, (i) the first WAL file segment may include a first plurality of WAL records including the first part of the data, (ii) the second WAL file segment may include a second plurality of WAL records including the second part of the data, (iii) no WAL record of the first plurality of WAL records may be a duplicate of any WAL record of the second plurality of WAL records, and (iv) no WAL record of the second plurality of WAL records may be a duplicate of any WAL record of the first plurality of WAL records. In some variations, (i) the second WAL file segment may include a second plurality of WAL records including the second part of the data, (ii) the third WAL file segment may include a third plurality of WAL records including the third part of the data, and (iii) at least one WAL record of the second plurality of WAL records may be a duplicate of at least one WAL record of the third plurality of WAL records. In some variations, (i) the second WAL file segment may include a second plurality of WAL records including the second part of the data, (ii) the third WAL file segment may include a third plurality of WAL records including the third part of the data, (iii) no WAL record of the second plurality of WAL records may be a duplicate of any WAL record of the third plurality of WAL records, and (iv) no WAL record of the third plurality of WAL records may be a duplicate of any WAL record of the second plurality of WAL records.

The first write operations may include at least one of generating and causing storage of the first WAL file segment by the primary disk, and synchronizing first metadata of a first memtable of the one or more memtables with the first WAL file segment by writing the first metadata to the first WAL file segment. In some variations, the execution of the first group of the plurality of write requests may include writing the first part of the data to a first memtable of the one or more memtables, the execution of the second group of the plurality of write requests may include writing the second part of the data to a second memtable of the one or more memtables, and the execution of the third group of the plurality of write requests may include writing the third part of the data to a third memtable of the one or more memtables. The primary disk health parameter may include a first latency of the first write operations, where the primary disk health parameter may indicate the transient unavailability of the primary disk when the first latency is greater than a first threshold latency. The method may include monitoring, during execution of the first write operations, the first latency of the first write operations, and when the first latency is greater than the first threshold latency, switching from the primary disk to the secondary disk and executing the second write operations directed to the secondary disk. The method may also include iteratively executing one or more iterations of the probe operations, where each iteration of the probe operations may include: generating and causing storage of a probe file by the primary disk; writing, in response to causing storage of the probe file, probe data to the probe file; synchronizing, in response to writing the probe data to the probe file, the probe data; and deleting, in response to synchronizing the probe data, the probe file from storage by the primary disk.

The at least one primary disk probe parameter may include at least one second latency of the probe operations, where the at least one primary disk probe parameter may indicate the transient unavailability of the primary disk is resolved when the at least one second latency is less than a second threshold latency. The method may also include monitoring, in response to switching from the primary disk to the secondary disk and during execution of the probe operations, the at least one second latency of the probe operations, and when the at least one second latency is less than the second threshold latency, switching from the secondary disk to the primary disk and executing the third group of the plurality of write requests. The at least one second latency may include a plurality of second latencies. The method may also include determining, for each iteration of the probe operations, a respective second latency of the plurality of second latencies, the respective second latency being for that iteration of the probe operations, and when the respective second latencies of a threshold number of consecutive iterations of the probe operations are each less than the second threshold latency, switching from the secondary disk to the primary disk and executing the third write operations directed to the primary disk.

The secondary disk health parameter may include a third latency of the second write operations, where the secondary disk health parameter indicates the transient unavailability of the secondary disk when the third latency is greater than a third threshold latency. The method may also include monitoring, in response to switching from the primary disk to the secondary disk and during execution of the second write operations, the third latency of the second write operations, and when the third latency is greater than the third threshold latency, switching from the secondary disk to the primary disk and executing the third write operations directed to the primary disk.

The method may also include writing and causing storage of, in response to switching from the secondary disk to the primary disk, at least part of the second part of the data of the second WAL file segment to the primary disk. Writing and causing storage of at least part of the second part of the data of the second WAL file segment to the primary disk may further include ordering and de-duplicating one or more of: (i) a first plurality of WAL records of the first WAL file segment, (ii) a second plurality of WAL records of the second WAL file segment, or (iii) a third plurality of WAL records of the third WAL file segment based on the first part of the data, the second part of the data, and the third part of the data.

Each write request of the first group of the plurality of write requests may be different from each write request of the third group of the plurality of write requests. In some variations, at least one write request of the first group of the plurality of write requests may be the same as at least one write request of the second group of the plurality of write requests, and at least one write request of the second group of the plurality of write requests may be the same as at least one write request of the third group of the plurality of write requests. The method may also include, when a first memtable of the one or more memtables meets or exceeds a threshold storage size, flushing the first memtable to generate a first sorted string table (SST) file of a plurality of SST files stored by the primary disk, where the plurality of SST files may be organized in a log-structured merge (LSM) tree data structure including one or more levels, and in response to the flushing of the first memtable, deleting both the first memtable from storage by the second memory and the first WAL file from storage by the primary disk and generating a second memtable of the one or more memtables stored by the second memory.

In some embodiments, a system may include corresponding computer systems (e.g., servers), apparatus, and computer programs recorded on one or more computer storage devices, each configured to perform the actions of a method. A system of one or more computers may be configured to perform particular actions by virtue of having software, firmware, hardware, or a combination of them installed on the system (e.g., instructions stored in one or more storage devices) that in operation causes or cause the system to perform the actions. One or more computer programs may be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular methods and systems described herein are shown by way of illustration only and not as limitations. As will be understood by those skilled in the art, the principles and features described herein may be employed in various and numerous embodiments without departing from the scope of the present disclosure. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of the present disclosure.

The foregoing Summary, including the description of some embodiments, motivations therefore, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 (“FIG. 1”) shows an illustrative distributed computing system, according to some embodiments.

FIG. 2A shows an example of execution of a read transaction at a distributed computing system, according to some embodiments.

FIG. 2B shows an example of execution of a write transaction at a distributed computing system, according to some embodiments.

FIG. 3 shows an exemplary illustration of a log-structured merge (LSM) tree of a computing system, according to some embodiments.

FIG. 4 shows an exemplary block diagram of a storage layer of a computing system, according to some embodiments.

FIG. 5 shows an exemplary illustration of a relationship between an LSM tree and a memtable, according to some embodiments.

FIG. 6 shows an exemplary illustration of an SST file, according to some embodiments.

FIG. 7 shows an exemplary block diagram illustrating disk failover by a node of a distributed computing system, according to some embodiments.

FIG. 8 shows an exemplary flowchart of a method for failover between disks in the event of transient unavailability of one of the disks, according to some embodiments.

FIG. 9 shows a block diagram of an example computer system, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Methods and systems for failover between disks during transient unavailability are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Motivation for Some Embodiments

In some embodiments, as described herein, nodes of a cluster may operate a distributed database system including one or more KV stores, with data (e.g., metadata and KV data) of the KV stores being both buffered in-memory by memory available to nodes of the cluster and stored by disks (e.g., physical disks and/or virtual disks) available to the nodes of the cluster. For a particular workload, one or more individual KV stores operated by disks of nodes may form a single, unified KV store accessible for read and write operations. The nodes may receive write operations including one or more write requests directed to, for example, writing values as new versions of existing keys and/or writing values for new keys within a key space of KV data. Each node may operate one or more KV stores implemented as one or more buffered-write storage systems using the one or more disks available to that node, with data organized, for example, in an LSM tree, a B-epsilon tree, or an STB-epsilon-tree stored by a disk. In some cases, a particular KV store may correspond to one or more disks on which data of that KV store is physically stored. In some cases, a particular KV store may include KV data corresponding to one or more ranges of one or more workloads. Such a buffered-write storage system may buffer received write requests directed to stored range(s) by writing data according to the write requests to both a sorted memtable stored in-memory (e.g., by volatile, non-persistent storage) and to a WAL file mapped to the memtable and stored on-disk (e.g., by non-volatile, persistent storage). In some cases, the WAL file may be stored by a virtual disk that is provisioned from, mapped to, and/or otherwise backed by one or more physical disks available to a node that generates and writes to the WAL file.

As data is written to a disk by a node, transient unavailability of the disk may occur in which a latency of write operations directed to writing to the disk increases to undesirable levels for a period of time, without the disk becoming completely inoperable, defective, offline, and/or otherwise unavailable for write operations. Such transient unavailability may manifest as high latencies for executing read requests and/or write requests directed to data stored by the disk experiencing the transient unavailability, and may particularly impact latencies for executing write requests directed to such disk. As an example, execution of write requests by writing to the disk may slow and stall for unacceptable periods of time, thereby increasing database latency and reducing a rate at which write requests are executed. Accordingly, database performance may suffer due to users and their applications experiencing high latencies (e.g., 50 ms to 20 seconds) for execution of transactions involving write requests directed to data stored by disks experiencing transient unavailability.

Accordingly, improved systems and methods for failover between disks in the event of transient unavailability in a buffered-write storage system are provided that may avoid increased latencies for execution of write requests directed to a primary disk having transient unavailability by causing failover of execution of the write requests to a secondary disk unaffected by transient unavailability. As provided herein, a node operating using primary and secondary disks for storage purposes may cause switching and failover of execution of write requests between the primary and secondary disks. To cause failover to the secondary disk from the primary disk having transient unavailability, the node may continuously monitor and/or periodically monitor a primary disk health parameter of write operations (e.g., generating a WAL file, writing data to a WAL file, synchronizing metadata from a memtable to a WAL file, deleting a WAL file, etc.) directed to the primary disk to detect transient unavailability of the primary disk.

When the monitored primary disk health parameter of write operations to the primary disk is determined to be unsatisfactory (e.g., by exceeding a threshold latency and/or threshold rate) to indicate transient unavailability of the primary disk, ongoing write operations and subsequent write operations directed to writing to the primary disk may switch and failover to the secondary disk designated to receive and store data to be written by the write operations, thereby causing failover from the primary disk to the secondary disk. Accordingly, by switching from the primary disk to the secondary disk upon detection of transient unavailability of the primary disk, the node may continue to process and execute write operations by writing to the secondary disk to avoid the transient unavailability of the primary disk and the increased write latencies resulting therefrom.

During execution of write operations by writing to the secondary disk after switching from the primary disk to the secondary disk, the node may probe the primary disk to determine whether the transient unavailability of the primary disk remains ongoing. For example, after switching to the secondary disk and during execution of write operations by writing to the secondary disk, the node operating using the primary and secondary disks by writing to and reading from the primary and secondary disks may probe the primary disk. Probing the primary disk may include iteratively writing to the primary disk for one or more iterations and monitoring a primary disk probe parameter for each iteration of writing to the primary disk. When the monitored primary disk probe parameter of the iterative writing to the primary disk is determined to be satisfactory (e.g., by being less than a threshold latency and/or greater than a threshold rate) to indicate the transient unavailability of the primary disk is resolved, the node may switch back to the primary disk, thereby causing ongoing write operations directed to writing to the secondary disk to switch back to the primary disk designated to receive and store data to be written by the write operations.

Further, during execution of write operations by writing to the secondary disk after switching from the primary disk to the secondary disk, the node may continuously monitor and/or periodically monitor a secondary disk health parameter of write operations (e.g., generating a WAL file, writing data to a WAL file, synchronizing metadata from a memtable to a WAL file, deleting a WAL file, etc.) directed to the secondary disk to detect transient unavailability of the secondary disk. When the monitored secondary disk health parameter of write operations directed to the secondary disk is determined to be unsatisfactory (e.g., by exceeding a threshold latency and/or threshold rate) to indicate transient unavailability of the secondary disk, ongoing write operations and subsequent write operations directed to writing to the secondary disk may switch back and failover to the primary disk originally designated to receive and store data to be written by the write operations, thereby causing failover from the secondary disk to the primary disk. Accordingly, by switching from the secondary disk back to the primary disk upon detection of transient unavailability of the secondary disk, the node may continue to process and execute write operations by writing to the primary disk to avoid the transient unavailability of the secondary disk and the increased write latencies resulting therefrom. Thus, after switching from the primary disk to the secondary disk, the node may use one or more of the (i) monitored primary disk probe parameter for the primary disk and (ii) monitored secondary disk health parameter of write operations to the secondary disk to determine when to switch back from the secondary disk to the primary disk.

Based on the switching between the primary and secondary disks, the node may write different physical WAL file segments of a single logical WAL file to the primary and secondary disks, with each WAL file segment including one or more WAL records, with each WAL record including written KV data. As an example, each WAL record may correspond to a batch of one or more executed KV write requests, with that WAL record including the written KV data corresponding to such batch of executed KV write requests. Further, based on the switching between the primary and secondary disks, the node may write different physical WAL file segments of a multiple logical WAL files to the primary and secondary disks, with each WAL file segment including one or more WAL records, with each WAL record including written KV data. In some cases, based on the timing of the switching between the primary and secondary disks and a status of writing a WAL record to either of the primary and secondary disks, WAL file segments stored on different disks may overlap and include one or more of the same WAL records including the same written KV data. Accordingly, in response to causing ongoing write operations directed to writing to the secondary disk to switch back to writing to the primary disk, the node may cause recovery of the WAL file by writing the one or more WAL file segments that were previously written to the secondary disk to the primary disk. In some cases, writing the one or more WAL file segments that were previously written to the secondary disk to the primary disk may include ordering the WAL records of the different WAL file segments stored by the primary disk and de-duplicating any duplicate WAL records (e.g., having the same assigned sequence identifiers) between the different WAL file segments. As an example, the node may copy and write only non-duplicate WAL records from the one or more WAL file segments stored by the secondary disk to the primary disk based on comparison of sequence identifiers of each WAL record. Thus, by switching between the primary and secondary disks and recovering the WAL record(s) from the WAL file segment of a particular logical WAL file written to the secondary disk, the node may continue to execute write requests directed to data stored by the disks available to the nodes, thereby providing performance benefits that may include mitigating and avoiding the increased write latencies for executing write requests that would otherwise result from transient unavailability of the primary disk. Further, the techniques for WAL failover described herein may be achieved without requiring the additional overhead of additional, dedicated secondary disks, as existing disks of the cluster may be configured as primary disks for first KV stores and secondary disks for different, second KV stores.

### Terms

“Cluster” may refer to a deployment of computing devices that may collectively comprise a database. A cluster may include computing devices (e.g., computing nodes) located in one or more geographic locations (e.g., data centers). The one or more geographic locations may be located within a single geographic region (e.g., eastern United States, central United States, etc.) or more than one geographic location. For example, a cluster may include computing devices located in both the eastern United States and the western United States, with two data centers in the eastern United States and four data centers in the western United States.

“Node” or “computing node” may refer to an individual computing device (e.g., server) that is a part of a cluster. At least one processor, a memory (e.g., non-persistent, volatile storage), and one or more physical disks may be communicatively connected to function and operate as a node of the cluster based on computer-readable instructions stored by the memory. A node may include and operate one or more stores for organizing and managing stored data, such as one or more KV stores for organizing and managing stored KV data. A node may join with one or more other nodes to form a cluster. One or more nodes that comprise a cluster may store data (e.g., tables, indexes, etc.) in a map of KV pairs. Each node may operate a state machine encoded by state variables among its one or more stores. A node may store a “range,” encoded by state variables as part of its state machine, with the range of the state machine being modifiable by one or more commands (e.g., read requests, write requests, schema change requests, etc.). A range may include a subset of the KV pairs (or all of the KV pairs, depending on the size of the range) stored by the cluster, with a node storing one or more ranges. A range may also be referred to as a “shard,” a “tablet,” and/or a “partition.” A table and its secondary indexes may be mapped to one or more ranges, such that each KV pair in a range may represent a single row in the table (which may also be referred to as the primary index based on the table being sorted by the primary key) or a single row in a secondary index. Based on a range reaching or exceeding a threshold storage size, the range may be split into two ranges. For example, based on reaching 512 mebibytes (MiB) in size, the range may be split into two ranges. Successive ranges may be split into one or more ranges based on reaching or exceeding a threshold storage size.

“Index” may refer to a copy of the rows corresponding to a single table, where the rows are sorted by one or more columns (e.g., a column or a set of columns) of the table. Each index may correspond to and/or otherwise belong to a single table. In some cases, an index may include a type. An example of a first type of index may be a primary index. A primary index may be an index on row-identifying primary key columns. A primary key constraint may be applied to one or more columns of a table to uniquely identify each row of the table, such that the primary key adds structure to the table data. For a column configured with a primary key constraint, values stored in the column(s) must uniquely identify each row. One or more columns of a table may be configured with a primary key constraint, and the database that includes the table may automatically create an index (referred to as a “primary index”) for the primary key column(s). A primary key may be defined for each table stored by a database as described herein. An example of a second type of index may be a “secondary index.” A secondary index may be defined on non-primary key columns of a table. A table that does not include a defined primary index may include a hidden row identifier (ID) (e.g., referred to as rowid) column that uniquely identifies each row of the table as an implicit primary index.

“Replica” may refer to a copy of a range. A range may be replicated at least a threshold number of times to produce a corresponding number of replicas. For example, by default, a range may be replicated three times to produce three distinct replicas. Each replica of a range may be stored by a distinct node of a cluster. For example, three replicas of a range may each be stored by a different node of a cluster, with no node of the cluster storing more than one replica of a particular range. In some cases, a range may be required to be replicated a minimum of three times to produce at least three replicas. A node may store one or more replicas corresponding to one or more different ranges among its one or more stores. In some cases, ranges may be replicated based on data survivability preferences as described further in U.S. patent application Ser. No. 17/978,752, filed on Nov. 1, 2022, and published as U.S. Patent Application Publication No. 2023/0145054 on May 11, 2023, and in U.S. patent application Ser. No. 18/365,888, filed on Aug. 4, 2023, and published as U.S. Patent Application Publication No. 2024/0045887 on Feb. 8, 2024, which are hereby incorporated by reference herein in their entireties.

“Leaseholder” or “leaseholder replica” may refer to a replica of a range that is configured to hold the lease for the replicas of the range. The leaseholder may receive and coordinate read requests and write requests directed to one or more KV pairs stored by the range. “Leaseholder node” may refer to the node of the cluster that stores the leaseholder replica. The leaseholder may receive read requests of read transactions and may serve the read requests to transaction coordinators operating on gateway nodes that received the read transactions by providing read KVs to the transaction coordinators, such that the transaction coordinators can send the read KVs to client devices from which the read transactions originate. Other replicas of the range that are not the leaseholder may receive read requests and may send (e.g., route) the read requests to the leaseholder, such that the leaseholder may serve the read requests based on the read transaction. The leaseholder may receive write requests of write transactions and may route the write requests to the leader replica of the range for execution via distributed consensus. The leaseholder may be assigned as the leaseholder for a period of time among the replicas of the range and may change among replicas as described herein. For each lease, the period of time for which a leaseholder replica will be granted a lease on the range may be defined as starting at a starting timestamp and lasting up to (e.g., but not including) an expiration timestamp. For each lease granted to a leaseholder replica, such a period of time may be enforced based on multi-version concurrency control (MVCC) timestamps and clocks (e.g., hybrid logical clocks (HLCs)) operated by nodes of the cluster, with read requests that are served and write requests that are caused to execute by that leaseholder replica having MVCC timestamps that are within the period of time for that lease. Each lease may be disjoint such that no two different replicas of a range hold a lease on the range at the same time.

“Raft group” or “consensus group” may refer to a group of the replicas for a particular range. The consensus group may include only voting replicas (e.g., leader and follower replicas) for the range, and the consensus group may participate in a distributed consensus protocol and perform operations as described herein.

“Raft leader” or “leader” may refer to a replica of a range that serves as the leader for managing write transactions for the range. The leader may receive write requests included in write transactions directed to the range from the leaseholder for the range (e.g., unless the leaseholder and leader are the same replica) and may coordinate execution of the write requests among the consensus group. In some cases, the leader and the leaseholder are the same replica for a range (e.g., leader is inclusive of leaseholder and/or leaseholder is inclusive of leader). In other cases, the leader and the leaseholder are not the same replica for a range. “Raft leader node” or “leader node” may refer to a node of the cluster that stores the leader replica. The leader may determine that a threshold number of the replicas of a range agree to commit a write transaction prior to committing the write transaction. In some cases, the threshold number of the replicas of the range may be a majority (i.e., quorum) of the replicas of the range.

“Follower” or “follower replica” may refer to a voting replica of the range that is not the leader. “Follower node” may refer to a node of the cluster that stores the follower replica. Follower replicas may receive write requests corresponding to transactions from the leader replica. The leader replica and the follower replicas of a range may constitute voting replicas that participate in a distributed consensus protocol and perform operations (also referred to as “Raft protocol” and “Raft operations”) as described herein.

“Raft log” and “write log” may refer to a time-ordered log of log entries indicative of write requests (e.g., included in transactions) to a range, where the log of log entries indicate write requests and the included updates to a state of the range agreed to by at least a threshold number of the replicas of the range. Each replica of a range may include a Raft log stored by the node that stores the replica. A Raft log for a replica may be stored by persistent storage (e.g., non-volatile storage such as disk storage, solid state-drive (SSD) storage, etc.). A Raft log may be a source of truth for replication among nodes for a range. Each log entry included in the Raft log may be ordered based on a timestamp at which the log entry was added to the Raft log, such that the application order of the updates to each replica is the same for each replica of the range.

“Consistency” may refer to causality and the ordering of transactions within a distributed system. Consistency defines rules for operations within the distributed system, such that data stored by the system will remain consistent with respect to read and write requests originating from different sources.

“Consensus” may refer to a threshold number of replicas for a range, based on receiving a write transaction, acknowledging the write transaction. In some cases, the threshold number of replicas may be a majority of replicas for a range. Consensus may be achieved even if one or more nodes storing replicas of a range are offline, such that the threshold number of replicas for the range can acknowledge the write request of a write transaction. Based on achieving consensus, data modified by the write request of the write transaction may be stored within the range(s) targeted by the write transaction.

“Replication” may refer to generating and distributing copies (e.g., replicas) of data stored by a cluster. In some cases, replication can ensure that replicas of a range remain consistent among the nodes that store a replica of such range. In some cases, replication may be synchronous such that write transactions are acknowledged and propagated to a threshold number of replicas of a range before being considered committed to such range.

### Database Overview

A database stored by a cluster of nodes may operate based on one or more remote procedure calls (RPCs). The database may comprise a unified KV store distributed among the individual KV stored operated by nodes of the cluster. In some cases, the RPCs may be structured query language (SQL) RPCs, though RPCs based on other programming languages may also be used. Nodes of the cluster may receive SQL RPCs from client devices. Upon receiving SQL RPCs, nodes may convert such SQL RPCs into operations (e.g., requests) that operate on the distributed KV store.

In some embodiments, as described herein, the KV store of the database may be comprised of one or more ranges. A range may have a selected maximum storage size. For example, a range may have a maximum size of 512 MiB. Each range may be replicated to more than one node to maintain data survivability. For example, each range may be replicated to at least three nodes. By replicating each range to more than one node, if a node fails, replica(s) of the range would still exist on and remain available from other nodes such that the range can still be accessed by client devices and replicated to other nodes of the cluster.

In some embodiments, operations directed to KV data as described herein may be executed by one or more transactions. In some cases, a node may receive a read transaction including at least one read request from a client device. A node may receive a write transaction including at least one write request from a client device. In some cases, a node may receive a read transaction or a write transaction from another node of the cluster. For example, a leaseholder node may receive a read transaction from a gateway node that originally received the read transaction from a client device. In some cases, a node can send a read transaction to another node of the cluster. For example, a node that received a read transaction, but cannot serve the read transaction may send the read transaction to the leaseholder node. In some cases, when a node receives a read transaction or write transaction that it cannot directly serve, the node may send and/or otherwise route the transaction to the node that can serve the transaction.

In some embodiments, modifications to the data of a range may rely on a consensus protocol (e.g., a Raft protocol) to ensure a threshold number of replicas of the range agree to commit the change. The threshold number of replicas may be a majority number of the replicas of the range. The consensus protocol may enable consistent reads of data stored by a range.

In some embodiments, data may be written to and/or read from a storage device of a node using a storage engine that tracks the timestamp associated with the data. By tracking the timestamp associated with the data, client devices may query for historical data from a specific period of time (e.g., at a specific timestamp). A timestamp associated with a key corresponding to KV data may be assigned by a gateway node that received the transaction that wrote and/or otherwise modified the key. For a transaction that wrote and/or modified the respective key, the gateway node (e.g., the node that initially receives a transaction) may determine and assign a timestamp to the transaction based on a time of a clock of the node (e.g., at the timestamp indicated by the clock when the transaction was received by the gateway node). The transaction may assign the timestamp to the KVs that are subject to (e.g., modified by) the transaction. Timestamps may enable tracking of versions of KVs (e.g., through multi-version concurrency control (MVCC) as to be described herein) and may provide guaranteed transactional isolation. In some cases, additional or alternative methods may be used to assign versions and/or timestamps to keys and respective values.

In some embodiments, a “table descriptor” may correspond to a respective table of the database, where the table descriptor may include the schema of such table and information associated with such table. Each table descriptor may be stored in a “descriptor table,” where each version of a table descriptor may be accessed by nodes of the cluster. In some cases, a “descriptor” may correspond to any suitable schema or subset of a schema and may include the schema or the subset of the schema and information associated with the schema (e.g., a state of the schema). Examples of a descriptor may include a table descriptor, type descriptor, database descriptor, and schema descriptor. A view and/or a sequence as described herein may correspond to a table descriptor. Each descriptor may be stored by nodes of the cluster in a normalized or denormalized form. Each descriptor may be stored in a KV store by nodes of a cluster. In some embodiments, the contents of a descriptor may be encoded as rows in a database (e.g., SQL database) stored by nodes of a cluster. Descriptions of a table descriptor corresponding to a table may be adapted for any suitable descriptor corresponding to any suitable schema (e.g., a user-defined schema) or schema element as described herein. In some cases, a database descriptor of a database may include indications of a primary region and one or more other database regions configured for the database.

In some embodiments, a database architecture for the cluster of nodes may include one or more architectural layers. The one or more architectural layers may process received SQL RPCs into actionable processes to access, modify, store, and return data to client devices while providing data replication and consistency among nodes of the cluster. The layers may include one or more of: a SQL layer, a transactional layer, a distribution layer, a replication layer, and a storage layer.

In some cases, the SQL layer of the database architecture may expose a SQL application programming interface (API) to developers and converts high-level SQL statements into low-level read and write requests to an underlying KV store, which are passed to the transaction layer. The transaction layer of the database architecture may implement support for atomic, consistent, isolated, and durable (ACID) transactions by coordinating concurrent operations. The distribution layer of the database architecture may provide a unified view of a cluster's data. The replication layer of the database architecture may copy data between nodes and ensure consistency between these copies by implementing a consensus protocol (e.g., consensus algorithm). The storage layer may commit writes from the Raft log to disk storage (e.g., a non-volatile, persistent computer-readable storage medium of a node), as well as return requested data (e.g., read data) to the replication layer.

In some embodiments, the transaction layer may enable ACID semantics for transactions directed to the database. The transaction layer may receive binary KV operations from the SQL layer and control KV operations sent to a distribution layer. In some cases, the storage layer of the database may use MVCC to maintain multiple versions of keys and values mapped to the keys stored in ranges of the cluster. For example, each key stored in a range may have a stored MVCC history including respective versions of the key, values for the versions of the key, and/or timestamps at which the respective versions were written and/or committed. Each version of a particular key may have a different timestamp, such that no two versions of the same key can have the same timestamp.

### Transaction Layer

In some embodiments, the database architecture for a database stored by a cluster of nodes (e.g., cluster 102) may include a transaction layer. The transaction layer may enable ACID semantics for transactions operating on data and schemas within the database. The transaction layer may receive binary KV operations from the SQL layer and control KV operations sent to the distribution layer. In some cases, a storage layer of the database may use MVCC to maintain multiple versions of keys and values mapped to the keys stored in ranges of the cluster. For example, each key stored in a range may have a stored MVCC history including respective versions of the key, values for the versions of the key, and/or timestamps at which the respective versions were written and/or committed. Each version of a key may have a different timestamp, such that no two versions of the same key can have the same timestamp.

In some embodiments, for write transactions, the transaction layer may generate one or more locks. A lock may represent a provisional, uncommitted state for a particular value of a KV pair. The lock may be written as part of a write request of the write transaction. The database architecture described herein may include multiple lock types. In some cases, the transaction layer may generate unreplicated locks, which may be stored in an in-memory lock table (e.g., stored by volatile, non-persistent storage of a node) that is specific to the node storing the replica on which the write transaction executes. An unreplicated lock may not be replicated other replicas based on a consensus protocol as described herein. In other cases, the transaction layer may generate one or more replicated locks (referred to as “intents” or “write intents”). An intent may be a persistent, provisional value written by a transaction before the transaction commits that is stored by persistent storage (e.g., non-volatile storage such as disk storage, SSD storage, etc.) of nodes of the cluster. Each KV write operation performed by a transaction can initially be an intent, which includes a provisional version and a reference to the transaction's corresponding transaction record. An intent may differ from a committed value by including a pointer to a transaction record of a transaction that wrote the intent. In some cases, the intent functions as an exclusive lock on the KV data of the replica stored on the node on which the write request of the write transaction executes, thereby preventing conflicting read and write requests having timestamps greater than or equal to a timestamp corresponding to the intent (e.g., the timestamp assigned to the transaction when the intent was written). An intent may be replicated to other nodes of the cluster storing a replica of the range based on the consensus protocol as described herein. An intent for a particular key may be included in an MVCC history corresponding to the key, such that a reader of the key can distinguish the intent from other versions of committed MVCC values stored by persistent storage for the key.

In some embodiments, each transaction directed to the cluster may have a unique replicated KV pair (referred to as a “transaction record”) stored on a range stored by the cluster. The transaction record for a transaction may be added and stored in a replica of a range on which a first write request of the write transaction occurs. The transaction record for a particular transaction may store metadata corresponding to the transaction. The metadata may include an indication of a status of a transaction and a unique identifier (ID) corresponding to the transaction. The status of a transaction may be one of: “pending” (also referred to as “PENDING”), staging (also referred to as “STAGING”), “committed” (also referred to as “COMMITTED”), or “aborted” (also referred to as “ABORTED”) as described herein. A pending state may indicate that the transaction is in progress. A staging state may be used to enable a parallel commit protocol. A committed state may indicate that the transaction has committed and the write intents written by the transaction have been recorded by follower replicas. An aborted state may indicate the write transaction has been aborted and the values (e.g., values written to the range) associated with the write transaction may be discarded and/or otherwise dropped from the range. As write intents are generated by the transaction layer as a part of one or more write requests of a write transaction, the transaction layer may check for newer (e.g., more recent) committed values at the KVs of the range on which the write transaction is operating. If newer committed values exist at the KVs of the range, the write transaction may be restarted. Alternatively, if the write transaction identifies write intents at the KVs of the range, the write transaction may proceed as a transaction conflict as to be described herein. The transaction record may be addressable using the transaction's unique ID, such that requests can query and read a transaction's record using the transaction's ID.

In some embodiments, for read transactions, the transaction layer may execute a read transaction for KVs of a range indicated by the read transaction. The transaction layer may execute the read transaction if the read transaction is not aborted. The read transaction may read MVCC values at the KVs of the range. Alternatively, the read transaction may read intents written at the KVs, such that the read transaction may proceed as a transaction conflict as to be described herein.

In some embodiments, to commit a write transaction, the transaction layer may determine a state of a transaction record of the write transaction as it executes. The transaction layer may restart the write transaction based on determining the state of the write transaction indicated by the transaction record is aborted. Alternatively, the transaction layer may determine the transaction record to indicate the state as pending or staging. Based on the transaction record indicating that the write transaction is in a pending state, the transaction layer may set the transaction record to staging and determine whether the write intents of the write transaction have succeeded (e.g., succeeded by replication to the other nodes storing replicas of the range). If the write intents have succeeded, the transaction layer may report the commit of the transaction to the transaction coordinator operating at the gateway node. The gateway node may send an indication of a successful commit of the write transaction to the client device that initiated the write transaction.

In some embodiments, based on committing a write transaction, the transaction layer may cleanup the committed write transaction. A coordinating node to which the write transaction was directed may cleanup the committed write transaction via the transaction layer. A coordinating node may be a node that stores a replica of a range that is the subject of the transaction. In some cases, a coordinating node may be the gateway node for the transaction. The coordinating node may track a record of the KVs that were the subject of the write transaction. To clean up the transaction, the coordinating node may modify the state of the transaction record for the write transaction from staging to committed. In some cases, the coordinating node may resolve the write intents written for new versions of keys by the write transaction to MVCC (e.g., committed) values by removing the pointer to the transaction record. In some cases, the coordinating node may resolve the write intents written for new versions of keys by the write transaction to MVCC (e.g., committed) values using time bound iteration to filter and avoid reading keys having timestamps less than a target timestamp or external to a target timestamp range, thereby reducing an amount of time required to resolve the write intents. Based on removing the pointer to the transaction record for the write transaction, the coordinating node may delete the write intents of the transaction. Based on the deletion of each of the write intents for the transaction, the transaction record may be deleted. Additional features for a commit protocol are described at least in U.S. patent application Ser. No. 18/316,851, filed on May 12, 2023, and published as U.S. Patent Application Publication No. 2024/0378191 on Nov. 14, 2024, which is hereby incorporated by reference herein in its entirety.

In some embodiments, the transaction layer may track timing of transactions to maintain serializability. The transaction layer may implement hybrid logical clocks (HLCs) to track time within the cluster. An HLC may comprise a physical component (e.g., which may be close to local actual time) and a logical component (e.g., which is used to distinguish between events with the same physical component). HLC time may always be greater than or equal to the actual time. Each node may include a local HLC, such that the cluster operates based on locally distributed clocks operating at individual nodes.

For a transaction having a per-transaction read snapshot scope, the gateway node (e.g., the node that initially receives a transaction from a client device) may determine a timestamp for the transaction and constituent requests (e.g., requests derived from the transaction) based on an HLC time for the node. For example, the gateway node may determine and assign a timestamp for the transaction to be equal to an HLC time of the gateway node at which the gateway node received the transaction. For a transaction having a per-statement read snapshot scope, the gateway node (e.g., the node that initially receives the transaction) may determine a timestamp for each received statement of the transaction and constituent requests of each statement based on an HLC time for the node. For example, the gateway node may determine a timestamp for a statement of the transaction to be equal to an HLC time of the gateway node at which the gateway node received the statement of the transaction. The transaction layer may enable transaction timestamps based on HLC time. A timestamp within the cluster may be used to track versions of KVs (e.g., through MVCC as to be described herein) and provide guaranteed transactional isolation. A timestamp for a write intent as described herein may be equal to the assigned timestamp of a transaction corresponding to the write intent when the write intent was written to storage. A timestamp for a write intent corresponding to a transaction may be less than or equal to a commit timestamp for a transaction. When a timestamp for a write intent is less than a commit timestamp for the transaction that wrote the write intent (e.g., based on advancing the commit timestamp due to a transaction conflict or a most-recent timestamp indicated by a timestamp data structure), during asynchronous intent resolution, the committed, MVCC version of the write intent may have its respective timestamp advanced to be equal to the commit timestamp of the transaction.

For a transaction in which a node sends a request for the transaction to another node, the sending node may include the timestamp for the request that was generated by the local HLC (e.g., the HLC of the sending node) with the sent request. Upon receiving a request from another node (e.g., a sender node), a node (e.g., a receiver node) may inform the local HLC of the timestamp supplied with the transaction by the sender node. In some cases, the receiver node may update the local HLC of the receiver node with the timestamp included in the received transaction. Such a process may ensure that all data read and/or written to a node has a timestamp less than the HLC time at the node. Accordingly, the leaseholder for a range may serve read requests for data stored by the leaseholder, where the read requests of the read transaction that reads the data have an HLC timestamp greater than or equal to the HLC timestamp of the MVCC value read by the read transaction (e.g., such that the read occurs after the write). Timestamps for a leaseholder replica's lease on a range may be derived from HLCs of nodes of the cluster, such as the HLC operated by the leaseholder node storing the leaseholder replica as described herein.

To provide isolation within the cluster, upon a request of a transaction reading a value of a range via a read request, the transaction layer may store the request's timestamp in a timestamp data structure (e.g., timestamp cache) stored at the leaseholder replica of the range. For each read request directed to a range, the timestamp cache may record and include an indication of the latest timestamp (e.g., the timestamp that is the furthest ahead in time) at which value(s) of the range that were read by a read request of a transaction. Upon execution of a write transaction, the transaction layer may compare the timestamp of the write transaction to the latest timestamp indicated by the timestamp cache. If the timestamp of the write transaction is less than the latest timestamp indicated by the timestamp cache, the transaction layer may attempt to advance the timestamp of the write transaction forward to a new, later timestamp that is greater than the latest timestamp indicated by the timestamp cache. In some cases, advancing the timestamp may cause the write transaction to restart in the second phase of the transaction as to be described herein with respect to read refreshing.

In some embodiments, according to replication (e.g., database, table, index, etc.) zone configurations, non-voting replicas may be placed in database regions that do not include a voting replica. To reduce latencies in a multi-region database, non-voting (e.g., follower) replicas may be made available to serve historical (e.g., stale) read requests originating from client devices located within their respective database region, such that read requests may be routed from a gateway node to a local follower node for a respective range without requiring direction to the leaseholder node for such range. A historical (e.g., stale) read request may include a read timestamp that is sufficiently in the past (e.g., such that write transactions have completed propagating to non-voting replicas). Accordingly, follower reads may be consistent reads at historical (e.g., stale) timestamps from non-leaseholder replicas of a range, which may be enabled by closed timestamp updates. A closed timestamp update may be a data store-wide timestamp that includes per-range information indicative of Raft (e.g., consensus) progress among a leader replica (e.g., typically the leaseholder replica) and follower (e.g., voting) replicas. A leader node for a range may send (e.g., periodically) a closed timestamp update to one or more follower nodes storing replicas of the range, where the closed timestamp update includes a closed timestamp indicative of the time at which the range was most recently updated and/or otherwise modified according to the consensus (e.g., Raft) protocol. Based on received closed timestamp updates, a follower node storing a follower replica for range may have the necessary information to serve consistent, non-stale reads for read requests directed to the range having read timestamps that are less than or equivalent to the received closed timestamp from the leader replica and serve stale reads for read requests directed to the range having timestamps that are above the received closed timestamp. Accordingly, in some embodiments, follower nodes storing follower replicas for a range may serve read requests when follower reads are enabled. For ranges configured as non-blocking ranges, follower replicas may serve consistent reads at a present time based on receiving a closed timestamp update with a synthetic timestamp. Examples of applications of closed timestamp updates, follower reads, and non-blocking transactions can be found in at least U.S. patent application Ser. No. 17/371,403, filed on Jul. 9, 2021, now issued as U.S. Pat. No. 11,860,860 on Jan. 2, 2024, which is hereby incorporated by reference in its entirety.

As described herein, the SQL layer may convert SQL statements (e.g., received from client devices) to KV operations. KV operations generated from the SQL layer may use a Client Transaction (CT) transactional interface of the transaction layer to interact with the KVs stored by the cluster. The CT transactional interface may include a transaction coordinator as described herein. The transaction coordinator may perform one or more operations as a part of the transaction layer. Based on the execution of a transaction, the transaction coordinator may send (e.g., periodically send) “heartbeat” messages to a transaction record for the transaction. Such messages may indicate that the transaction should continue executing (e.g., be kept alive). If the transaction coordinator fails to send the “heartbeat” messages, the transaction layer may modify the transaction record for the transaction to an aborted status. The transaction coordinator may track each written KV and/or written span of KVs during execution of a transaction. In some embodiments, the transaction coordinator may clean and/or otherwise clear accumulated transaction operations. The transaction coordinator may clear an accumulated write intent for a write transaction based on the status of the transaction changing to committed or aborted.

As described herein, to track the status of a transaction during execution, the transaction layer can write to a transaction record corresponding to the transaction. Write intents of the transaction may route conflicting transactions to the transaction record based on the pointer to the transaction record included in such write intents, thereby enabling the conflicting transaction to determine a status for conflicting write intents as indicated in the transaction record. The transaction layer may write a transaction record to the same range as the first key subject to a transaction. The transaction coordinator may track the first key subject to a transaction. In some cases, the transaction layer may generate the transaction record when one of the following occurs: the write request commits; the transaction coordinator sends heartbeat messages for the transaction; or a request forces the transaction to abort. As described herein, a transaction record may have one of the following states: pending, committed, staging, or aborted. In some cases, the transaction record may not exist. If a transaction encounters a write intent where a transaction record corresponding to the write intent does not exist, the transaction may use the timestamp of the write intent to determine how to proceed with respect to the observed write intent. If the timestamp of the write intent is within a transaction liveness threshold, the write intent may be treated as pending. If the timestamp of the write intent is not within the transaction liveness threshold, the write intent may be treated as aborted. A transaction liveness threshold may be a duration configured based on a time period for sending “heartbeat” messages. For example, the transaction liveness threshold may be a duration lasting for five “heartbeat” message time periods, such that after five missed heartbeat messages, a transaction may be aborted. The transaction record for a committed transaction may remain until each of such write intents of the transaction are converted to committed MVCC values stored by persistent storage of a node.

As described herein, in the transaction layer, values may not be written directly to the storage layer as committed MVCC values during a write transaction. Values may be written in a provisional (e.g., uncommitted) state, referred to as a write intent. Write intents may be MVCC values including a pointer to a transaction record to which the MVCC value belongs. Based on interacting with a write intent (instead of a committed MVCC value), a request may determine the status of the transaction record and thereby determine how to interpret the write intent. As described herein, if a transaction record is not found for a write intent, the request may determine the timestamp of the write intent to evaluate whether or not the write intent may be considered to be expired.

In some embodiments, the transaction layer may include a concurrency manager for concurrency control. The concurrency manager may sequence incoming requests (e.g., from transactions) and may provide isolation between the transactions that issued those requests that intend to perform conflicting operations. Such activity may be referred to as concurrency control. The concurrency manager may combine the operations of a latch manager and a lock table to accomplish this work. The latch manager may sequence the incoming requests and may provide isolation between those requests. The lock table may provide locking and sequencing of requests (in combination with the latch manager). The lock table may be a per-node, in-memory (e.g., stored by volatile, non-persistent storage) data structure. The lock table may hold a collection of locks acquired by transactions that are in-progress as to be described herein.

As described herein, the concurrency manager may be a structure that sequences incoming requests and provides isolation between the transactions that issued those requests that intend to perform conflicting operations. During sequencing, the concurrency manager may identify conflicts. The concurrency manager may resolve conflicts through passive queuing and/or active pushing. Once a request has been sequenced by the concurrency manager, the request may execute without interference from other conflicting requests based on the isolation provided by the concurrency manager. Such isolation may persist for the duration of the request. The isolation may terminate upon completion of the request. Each request in a transaction may be isolated from other requests. Each request may be isolated during the duration of the request, after the request has completed (e.g., based on the request acquiring locks), and/or within the duration of the transaction comprising the request. The concurrency manager may allow transactional requests (e.g., requests originating from statements of transactions) to acquire locks, where the locks may exist for durations longer than the duration of the requests themselves. The locks may extend the duration of the isolation provided over specific keys of ranges stored by the cluster for the duration of the transaction. The locks may be released when the transaction commits or aborts. Other requests that encounter and/or otherwise interact with the locks (e.g., while being sequenced) may wait in a queue for the locks to be released. Upon release of the locks, the other requests may proceed to execute. The concurrency manager may include information for external locks (e.g., the write intents).

In some embodiments, one or more locks may not be controlled by the concurrency manager and accordingly may not be discovered during sequencing. As an example, write intents (e.g., replicated, exclusive locks) may be stored such that they may not be detected until request evaluation time. In some embodiments, fairness may be ensured between requests, such that if any two requests conflict, the request that arrived first will be sequenced first. Sequencing may provide first-in, first-out (FIFO) semantics. An exception to FIFO semantics is that a request that is part of a transaction which has already acquired a lock may not be required to wait on that lock during sequencing. The request may disregard any queue that has formed on the lock. Lock tables as to be described herein may include one or more other exceptions to the FIFO semantics described herein.

In some embodiments, as described herein, a lock table may be a per-node, in-memory data structure. The lock table may store a collection of locks acquired by in-progress transactions. Each lock in the lock table may have an associated lock wait-queue. Conflicting transactions may queue in the associated lock wait-queue while waiting for the lock to be released. Items in the locally stored lock wait-queue may be propagated as necessary (e.g., via RPC) to a Transaction Wait Queue (TWQ). The TWQ may be stored on the leader replica of the range, where the leader replica on which the first write request of a transaction occurred may contain the transaction record.

As described herein, databases stored by the cluster may be read and written using one or more “requests.” A transaction may be composed of one or more statements (e.g., SQL statements), where each statement may include one or more requests, such as read requests and write requests. A read request may be a request to read data stored by a range, such as a value of a particular key at a timestamp corresponding to the request. A write request may be a request to write (e.g., update or modify) data stored by a range, such that the write request may write a value for a key included in the range. For example, a write request may write a value for a new version of a key. Isolation may be needed to separate requests. Additionally, isolation may be needed to separate transactions. Isolation for requests and/or transactions may be accomplished by maintaining multiple versions and/or by allowing requests to acquire locks. Isolation based on multiple versions may require a form of mutual exclusion to ensure that a read and a conflicting lock acquisition do not occur concurrently. The lock table may provide locking and/or sequencing of requests (in combination with the use of latches).

In some embodiments, locks may persist for a longer duration than the requests associated with the locks. Locks may extend the duration of the isolation provided over specific KVs to the duration of the transaction associated with the lock. As described herein, locks may be released when the transaction commits or aborts. Other requests that encounter and/or otherwise interact with the locks (e.g., while being sequenced) may wait in a queue for the locks to be released. Upon release of the locks, the other requests may proceed. In some embodiments, the lock table may enable fairness between requests, such that if two requests conflict, then the request that arrived first may be sequenced first. In some cases, there may be exceptions to the FIFO semantics as described herein. A request that is part of a transaction that has acquired a lock may not be required to wait on that lock during sequencing and may accordingly disregard a queue that has formed on the lock. In some embodiments, contending requests that encounter different levels of contention may be sequenced in a non-FIFO order. Such sequencing in a non-FIFO order may enable greater concurrency. As an example, if requests R₁ and R₂ contend on key K₂, but R₁ is also waiting at key K₁, R₂ may be determined to have priority over R₁, such that R₂ may be executed on K₂.

In some embodiments, as described herein, a latch manager may sequence incoming requests and provide isolation between those requests. The latch manager may sequence and provide isolation to requests under supervision of the concurrency manager. A latch manager may operate as follows. As write requests occur for a range, a leaseholder of the range may receive and serialize write requests for the range. Serializing the requests may group the requests into a consistent order. To enforce the serialization, the leaseholder may create a “latch” for the keys in the write value, such that a write request may be given uncontested access to the keys. If other requests access the leaseholder for the same set of keys as the previous write request, such requests may wait for the latch to be released before proceeding. In some cases, read requests may generate latches. Multiple read latches over the same keys may be held concurrently. A read latch and a write latch over the same keys may not be held concurrently.

In some embodiments, the transaction layer may execute transactions at a serializable transaction isolation level. A serializable isolation level may not prevent anomalies in data stored by the cluster. A serializable isolation level may be enforced by requiring the client device to retry transactions if serializability violations are possible. In some embodiments, the transaction layer may execute transactions at an isolation level different from a serializable isolation level. In some cases, the transaction layer may execute transactions at other isolation levels, such as a read committed isolation level and a snapshot isolation level.

In some embodiments, the transaction layer may allow for one or more transaction conflict types, where a conflict type may result from a transaction encountering a write intent at a key (e.g., at least one key). A write/write conflict may occur when two concurrent transactions attempt to write to the same key (e.g., by creating write intents for the same key). A write/read conflict may occur when a read request of a transaction encounters an existing write intent having a timestamp less than or equal to the timestamp of the read request. To resolve the transaction conflict, the transaction layer may proceed through one or more operations. Based on a transaction within the transaction conflict having a defined transaction priority (e.g., high priority, low priority, etc.), the transaction layer may abort the transaction with lower priority (e.g., in a write/write conflict) or advance the timestamp of the transaction having a lower priority (e.g., in a write/read conflict). Based on a transaction within the conflicting transactions being expired, the expired transaction may be aborted. A transaction may be considered expired if the transaction does not have a transaction record or the timestamp for the transaction is outside of the transaction liveness threshold. A transaction may be considered expired if the transaction record corresponding to the transaction has not received a “heartbeat” message from the transaction coordinator within the transaction liveness threshold. A transaction (e.g., a low priority transaction) that is required to wait on a conflicting transaction may enter the TWQ as described herein.

In some embodiments, the transaction layer may allow for one or more additional conflict types that do not involve write intents. A read/write conflict (also referred to herein as a “write after read conflict”) may occur when a write transaction having a lower timestamp conflicts with a read transaction having an equal or higher timestamp. The timestamp of the write transaction may be advanced to be greater than the timestamp of the read transaction, such that the write transaction may execute. A read within an uncertainty interval (also referred to as an “uncertainty window”) may occur when a read transaction encounters a KV having a higher timestamp than the timestamp of the read transaction and ambiguity exists as to whether the KV should be considered to be committed in the future or in the past of the read transaction. An uncertainty interval may be configured based on the maximum allowed offset (e.g., maximum allowed difference in time) between the clocks (e.g., HLCs) of any two nodes within the cluster. In an example, a duration of the uncertainty interval may be equal to the maximum allowed offset, where the uncertainty interval is defined as (t, t+d], where t refers to the initial timestamp of the read transaction and d refers to the duration of the uncertainty interval. A read within an uncertainty interval may occur based on clock skew between clocks operating on different nodes. In some cases, the transaction layer may advance the timestamp of the read transaction to a timestamp greater than the timestamp of the KV according to read refreshing as described herein. If the read transaction associated with a read within an uncertainty interval has to be aborted and retried, the read transaction may never encounter an uncertainty interval on any node which was previously visited by the read transaction. In some cases, there may not exist an uncertainty interval for KVs read from the gateway node of the read transaction. An amount of work to be aborted and retried may depend on a read snapshot scope and corresponding isolation level for a transaction. A first transaction adhering to an isolation level having a per-statement read snapshot scope may only be required to abort and retry an individual statement of the first transaction while a second transaction adhering to an isolation level having a per-transaction read snapshot scope may be required to abort and retry all statements of the transaction. When a first transaction adheres to an isolation level having a per-statement read snapshot scope, an amount of work aborted and retried by the first transaction may be relatively less work than a second transaction that adheres to an isolation level having a per-transaction read snapshot scope.

In some embodiments, as described herein, the TWQ may track all transactions that could not advance due to another blocking, ongoing transaction that wrote write intents observed by the tracked transactions. The transactions tracked by the TWQ may be queued and may wait for the blocking transaction to complete before the transaction can proceed to execute. The structure of the TWQ may map a blocking transaction to the one or more other transactions that are blocked by the blocking transaction via the respective unique IDs corresponding to each of the transactions. The TWQ may operate on the leader replica of a range, where the leader replica includes the transaction record based on being subject to the first write request included in the blocking, ongoing transaction. Based on a blocking transaction resolving (e.g., by committing or aborting), an indication may be sent to the TWQ that indicates the queued transactions blocked by the blocking transaction may begin to execute. A blocked transaction (e.g., a transaction blocked by a blocking transaction) may examine their transaction status to determine whether they are active. If the transaction status for the blocked transaction indicates the blocked transaction is aborted, the blocked transaction may be resolved by the transaction layer. In some cases, deadlock may occur between transactions, where a first transaction may be blocked by second write intents of a second transaction and the second transaction may be blocked by first write intents of the first transaction. If transactions are deadlocked (e.g., blocked on write intents of another transaction), one of the deadlocked transactions may be randomly aborted, such that the remaining active (e.g., alive) transaction may execute and the deadlock may be resolved. A deadlock detection mechanism may identify whether transactions are deadlocked and may cause one of the deadlocked transactions to abort.

In some embodiments, the transaction layer may enable read refreshing. When a timestamp of a transaction has been advanced to a new, later timestamp, additional considerations may be required before the transaction may commit at the advanced timestamp. The considerations may include checking KVs previously read by the transaction to verify that no write transactions have occurred at the KVs between the original transaction timestamp and the advanced transaction timestamp. This consideration may prevent serializability violations. The check may be executed by tracking each read using a Refresh Request (RR). If the check succeeds (e.g., no write transactions have occurred between the original transaction timestamp and the advanced transaction timestamp), the transaction may be permitted to commit at the advanced timestamp. A transaction may perform the check at a commit time if the transaction was advanced by a different transaction or by the timestamp cache. A transaction may perform the check based on encountering a read within an uncertainty interval or a write/write conflict. If the check is unsuccessful, then the transaction may be retried at the advanced timestamp.

In some embodiments, the transaction layer may enable transaction pipelining. Write transactions may be pipelined when being replicated to follower replicas and when being written to storage. Transaction pipelining may reduce the latency of transactions that perform multiple writes. In transaction pipelining, write intents may be replicated from leader replicas (e.g., combined leaseholder and leader replicas) to follower replicas in parallel, such that waiting for a commit occurs at transaction commit time. Transaction pipelining may include one or more operations. In transaction pipelining, for each received statement (e.g., including one or more requests) of a transaction, the gateway node corresponding to the transaction may communicate with the leaseholders (L₁, L₂, L₃, . . . , Lᵢ) for the range(s) indicated by the transaction. Each leaseholder Lᵢ may receive the communication from the gateway node and may perform one or more operations in parallel. Each leaseholder Lᵢ may cause the respective leader replica for the range(s) to (i) create write intents, and (ii) send the write intents to corresponding follower nodes for the leader replica. After sending the write intents to the corresponding follower nodes, each leader replica may cause the respective leaseholder Lᵢ to send an indication to the transaction coordinator on the gateway node that the write intents have been sent. Replication of the intents may be referred to as “in-flight” once the leader replica sends the write intents to the follower replicas. Before committing the transaction (e.g., by updating the transaction record for the transaction via a transaction coordinator), the gateway node may wait for the write intents to be replicated in parallel to each of the follower nodes of the leader nodes. Upon receiving responses from the leader nodes and leaseholder nodes indicating that the write intents have propagated to the follower nodes, the gateway node may commit the transaction by causing an update to the status of the transaction record of the transaction. Additional features of distributed consensus (e.g., Raft) operations are described with respect to “Transaction Execution.”

### Replication Layer

In some embodiments, the database architecture for the cluster may include a replication layer. The replication layer may copy data (e.g., ranges) between nodes of the cluster and enable consistency between the copied data based on a consensus protocol as described herein. The replication layer may allow the cluster to tolerate a subset of nodes going offline and/or otherwise being unavailable, such that the range data stored by the cluster is still available to client devices. The replication layer may receive requests from the distribution layer (e.g., from the DistSender). The replication layer may send responses (e.g., Batch Responses) to the distribution layer (e.g., the DistSender). In the replication layer, when the node receiving a request is the leaseholder for the range, the node may accept the request. When the node receiving a request is not the leaseholder for the range, the node may return an error to the source of the request, where the error may include an indication of a pointer to the leaseholder (or the node last known to be the leaseholder) based on lease information available to the node. The KV requests may be converted to Raft commands. The replication layer may write accepted requests to a storage layer as to be described herein. Committed Raft commands may be written to the Raft log and stored by a storage medium of a node via the storage layer. The leaseholder may serve reads from the storage layer.

In some embodiments, the replication layer may implement a consensus protocol. The consensus protocol may require a threshold number (e.g., a quorum or a majority) of replicas of a range to confirm a modification (e.g., a write transaction) to the range prior to committing the modification. Based on the consensus protocol, the replication layer may require at least three nodes to include a replica of a range, such that a threshold number of replicas may agree to a modification to the range. In some cases, if the threshold number of replicas required to confirm a modification is a majority of the replicas, the replication layer may enable the database to tolerate a number of node failures as described by Equation 1:

$$Tolerable Node Failures = \frac{Replication Factor - 1}{2} \qquad ( 1 )$$

As described by Equation 1, the “Replication Factor” may be the number of replicas of a range stored by the cluster. For example, based on a “Replication Factor” equal to five nodes, the replication layer may tolerate node failure for two nodes of a cluster, where the failed nodes each store a replica of a range and three other nodes that are online and available store replicas of the range. In some cases, the “Replication Factor” may be configured at the cluster, database, and/or table level, where a cluster may store one or more databases and a database may include one or more ranges distributed among the nodes of the cluster.

In some embodiments, as described herein, the replication layer may include a consensus protocol (referred to as Raft). Raft may be an algorithm (e.g., distributed consensus algorithm) that stores data among one or more nodes of the cluster, such that the nodes may approve of the state of the data in their respective state machines based on reaching consensus. Raft may organize the nodes storing a replica of a range in a group referred to as a Raft group as described herein. Each replica of a Raft group may be classified as a leader replica or a follower replica as described herein. The leader replica may coordinate writes to the follower replicas of the Raft group. The leader replica may send “heartbeat” messages to the follower replicas (e.g., periodically) to maintain its status as a leader replica.

In some embodiments, the replicas forming a consensus group for a range may vote to elect a leader replica when a leader election is started as described herein. The replicas forming a consensus group for a range may execute a voting protocol to elect a leader replica for the range, for example, when the existing leader replica fails or when the Raft algorithm initializes for a new range. The replicas forming a consensus group for a range may perform a voting protocol to vote to elect a leader replica based on one or more additional or alternative conditions as described herein. For each election for a leader replica of a range started by a particular candidate node storing a candidate replica for the range, a new term for that range can start in the cluster. A term (also referred to as “leader term”) can be an arbitrary period of time for which a replica attempts to be and/or is elected as the leader replica for a range, with each term associated with a respective term number. In some cases, the term number is a positive integer that increases linearly over time for each term as determined by a node that starts the leader election. For example, for a first term having a term number equal to the positive integer t, a subsequent second term immediately following the first term may have a term number equal to the positive integer t+1. Each term can start with an election of a leader replica. When the election of a leader replica is completed successfully (e.g., such that a single leader replica is elected for the range), the term for that election continues with normal write operations orchestrated by the newly elected leader replica and ends when a new term is started. When the election is a failure (e.g., such that a single leader replica is not elected for the range), a new term can start for a new election for a leader replica of the range.

In some embodiments, a candidate node of the cluster storing a candidate replica of a range may start a leader election intended to cause its stored replica to become the leader replica for the range and cause execution of a voting protocol. A candidate node may be a node that initiates (e.g., calls) an election for a leader replica of a range, with that node's replica of that range being a candidate replica to become the leader replica of the range. A node of the cluster storing a replica of a range may become a candidate node when it fails to receive any communication from the leader replica during a particular period of time (referred to as “election timeout”), such that the candidate node may determine and assume there is no longer an acting leader replica for the range. The candidate node may start the leader election by increasing (e.g., incrementing) a term number for the term of the range to generate a new term associated with the increased term number beginning after the immediately preceding term. In response to generating the new term with the increased term number, the candidate may cause execution of the voting protocol by voting for its stored replica of the range as a new leader replica for the range and sending a vote message to all other nodes storing replicas of the consensus group requesting their vote for the candidate node's replica as leader replica. A node may only vote once per term on a first-come-first-served basis and only one replica of a range may be elected leader replica for a particular term. In response to a node storing a replica of the consensus group receiving a vote message from the candidate node requesting their vote for the candidate node's replica as leader replica, the node may send an affirmative vote response to the candidate node voting for the candidate node's replica as leader replica when that node does not recognize the current term number for the range as being greater than the term number for which the candidate node is requesting an election. In response to a node storing a replica of the consensus group receiving a message from the candidate node requesting their vote for the candidate node's replica as leader replica, the node may send a rejection vote response to the candidate node with a current term number for the range without voting for the candidate node's replica as leader replica when that node recognizes the current term number for the range as being greater than the term number for which the candidate node is requesting an election.

In some embodiments, when a candidate node receives a message (e.g., vote response) from another node storing a replica of the consensus group with a current term number greater than the term number for which the candidate node is requesting an election, then the candidate node's election is defeated and the candidate node (i) determines its stored replica of the range is a follower replica of the range and (ii) recognizes there exists a different, leader replica for the range (e.g., corresponding to the current, greater term number received from the other replica). In response to the candidate node receiving votes for its replica to become the leader replica from a threshold (e.g., majority) number of the replicas of the consensus group (e.g., including from itself), the candidate node may become the leader node for the range by determining its stored replica of the range is a new leader replica of the range, with other replicas of the consensus group of the range may recognize that replica as the leader replica of the range. When the candidate node (i) fails to receive votes for its replica to become the leader replica from a threshold (e.g., majority) number of the replicas of the consensus group or (ii) receives a message from another node storing a replica of the consensus group with a current term number greater than the term number for which the candidate node is requesting an election (e.g., because of a split vote), the election for the term number for which the candidate node requested an election may fail and another election may be called (e.g., by the same candidate node or a different candidate node) for a new term and further increased term number.

In some embodiments, prior to initiating a leader election, a node that intends to initiate a leader election based on the one or more conditions described herein (e.g., such as an election timeout or leader node storing a leader replica choosing to step down as leader) can cause execution of a pre-vote protocol. In response to intending to initiate a leader election, the candidate node, without generating a new term and increased term number, can cause execution of the pre-vote protocol by voting for its stored replica of the range as a new leader replica for the range and sending a vote message to all other nodes storing replicas of the consensus group requesting their vote for the candidate node's replica as leader replica. In some cases, the candidate node may only proceed to initiate the election and cause execution of the voting protocol by generating a new term and increased term number when the candidate causes execution of the pre-vote protocol for its consensus group and receives votes for its replica to become the leader replica from a threshold (e.g., majority) number of the replicas of the consensus group (e.g., including from itself). In other cases, the candidate node may proceed to initiate a leader election without causing execution of the pre-vote protocol.

In some embodiments, the consensus protocol (e.g., Raft) described herein may implement a randomized election timeout to ensure that split votes are quickly resolved. Such a randomized election timeout may reduce the chance of a split vote because nodes storing replicas of a range may not become candidate nodes for the range at the same time. Rather, a single node storing a replica of the range may time out after calling an election as a candidate node (e.g., after a particular period of time from when it called the election), call a new election as a candidate node and be elected leader replica for the range, and then send heartbeat messages to other nodes storing replicas of the range before any of those follower replicas can become candidate replicas attempting to become the leader replica.

In some embodiments, as described herein, a leader node storing a leader replica of a range may be responsible for replication to its Raft log and Raft logs of the follower nodes and corresponding to the follower replicas stored by those nodes. To remain leader replica and prevent a follower replica from calling an election to become the leader replica, the leader node may inform the follower nodes of the existence of the leader replica by periodically sending a heartbeat message to each of the follower nodes. Each follower node storing a follower replica of the range may have a timeout threshold (e.g., typically between one and ten seconds, and preferably between two and four seconds) within which the follower node expects to receive the heartbeat message for the range from the leader node. Each follower node may reset its timeout threshold (e.g., to zero) for the range upon receiving the heartbeat message corresponding to the range from the leader node. When a follower node fails to receive a heartbeat message before the expiration of the timeout threshold, the follower node may modify its status and the status of its follower replica to become a candidate node and candidate replica, respectively. Based on modifying its status and the status of its follower replica, that candidate replica may initiate a new leader election for a new term as described herein. In some cases, additional or alternative requirements may control operation of a leader election as described herein.

In some embodiments, upon receiving a Batch Request for a range, a node may convert the KV operations indicated by the Batch Request into one or more Raft commands. The node may send the Raft commands to the Raft leader (e.g., when the node that received the Batch Request is not the leader node). Upon receiving the Raft commands, the leader node may write the Raft commands to the Raft log as described herein.

In some embodiments, in response to a threshold number (e.g., a majority) of nodes writing a transaction and the writes being committed by the leader replica, the writes may be appended to the Raft log as described herein. The Raft log may be an ordered set of commands agreed on by a threshold number of replicas of the range. The Raft log may be a source of truth for consistent replication among nodes of the cluster. In some cases, each replica can be “snapshotted”, such that a copy of the data stored by the replica may be generated for a specific applied log index. Such copy of the data (e.g., a snapshot) may be sent to other nodes during a rebalance event to enable and/or expedite replication. A rebalance event may update data stored by a node to a specific log index based on the snapshot. Upon loading the snapshot, a node may be updated by executing operations (e.g., indicated by the Raft log) that have occurred since the snapshot was taken.

In some embodiments, as described herein, a single node in the Raft group may be configured as the leaseholder node. The leaseholder node may be the only node that can serve reads to a client device or propose writes to the Raft leader node (e.g., both actions may be received as Batch Requests from the DistSender as described herein with respect to “Distribution Layer”). When serving reads, the leaseholder may bypass the Raft protocol. The leaseholder may bypass the Raft protocol based on consensus previously achieved for the values stored by the range. In most embodiments, the leaseholder and the leader replica may be the same replica stored by a node of the range, such that write requests may be proposed directly to the leaseholder/leader replica. The replication layer may attempt to collocate the leaseholder and leader replica during each lease renewal or transfer. When a leaseholder is not configured for a range (e.g., based on expiration of the leaseholder's lease period), any node storing a replica of the range receiving a request directed to (e.g., reading from or writing to) the range may send a request to become the leaseholder for the range by causing execution of a write request to acquire the lease among that consensus group. The request may be sent to each node storing a replica of the range, with the nodes voting to use the consensus protocol for the node to become the leaseholder. A node that sends a request to become the leaseholder may include a copy of the last valid lease stored by the node. If the last valid lease is equivalent to the current configured leaseholder, the request may be granted by a replica in response to receiving the request. Alternatively, if the last valid lease is not equivalent to the current configured leaseholder, the request may be ignored or otherwise denied by a replica. After the nodes vote to elect the leaseholder replica for the range, the leaseholder node storing that range can periodically send a request to extend the expiration timestamp for the lease on the range by causing execution of a write request to extend the lease among that consensus group. When the leaseholder fails to extend the lease by causing execution of a write request to extend the lease among that consensus group, the leaseholder's lease term can expire, thereby allowing any of the nodes storing replicas of the range to become the leaseholder.

In some embodiments, to manage leases for ranges included in tables as table data, the replication layer may use “epochs.” An epoch may be a period between a node joining a cluster and a node disconnecting from a cluster. To extend a lease (e.g., to remain leaseholder for a particular range), a leaseholder node may periodically update a liveness record corresponding to the node. The liveness record may be stored on a system range key by one or more nodes of the cluster. Based on disconnecting from the cluster, a node may fail to update the liveness record. An epoch may be considered to be changed based on a node disconnecting from the cluster and/or failing to update the liveness record, at which point any node storing a replica of the range may become the leaseholder for the range as described herein. The replication layer may cause a leaseholder node to lose the lease for a range based on the leaseholder node disconnecting from the cluster. In some cases, a leaseholder may not be required to renew a lease for a range. The leaseholder may lose the lease for a range based on disconnecting from the cluster. In some cases, additional or alternative techniques may be used to assign a leaseholder for a range.

In some embodiments, as described herein, meta ranges and/or system ranges may be stored as KV data. System ranges may be restricted from epoch-based leases. System ranges may use expiration-based leases. An expiration-based lease may expire at (or substantially close to) a timestamp. In some cases, a leaseholder for a system range may retain the expiration-based lease after the timestamp at which the expiration-based lease is configured to expire. The leaseholder for the system range may retain the expiration-based lease based on the leaseholder continuing to generate and/or otherwise propose Raft commands to a Raft group.

In some embodiments, the replication layer may enable leaseholder rebalancing. Each leaseholder for a cluster may consider (e.g., periodically consider) whether to transfer the lease to another replica of the range. As an example, a leaseholder may periodically determine whether to transfer the lease to another replica of the range every ten minutes. Each leaseholder may be configured to transfer the lease for a range based on the number of requests from each locality (e.g., region) for the range, the number of leases on each node storing a replica of the range, and/or the latency between localities. If replicas for a range are distributed among different localities, the replication layer may determine which replica of the cluster is optimized to be the leaseholder. In some cases, a replica may be suited to be the leaseholder based on providing the lowest latency to requests from client devices.

For leaseholder rebalancing, a leaseholder may track a number of requests received by the leaseholder from each locality of the cluster. Such number of requests may be tracked as an average (e.g., an exponentially weighted moving average). The average may be used to determine the localities that most frequently send requests to the range. In some cases, for an exponentially weighted moving average, the locality that has most recently requested the range most frequently may be assigned the greatest weight. Based on another locality frequently requesting the range, the moving average may cause such locality to be assigned the greatest weight.

For leaseholder rebalancing, the leaseholder may correlate each requesting locality's weight (e.g., the proportion of recent requests) to the locality of each replica by determining a similarity (e.g., similarity between country and/or region) between localities. For example, if the leaseholder received requests from gateway nodes in a region defined as the Central United States (e.g., Country=United States, Region=Central), the replication layer (or leaseholder) may assign the following weights to replicas as described in Table 1 as follows:

TABLE 1

| Replica | | Replica Leaseholder |
|---|---|---|
| Number | Replica Locality | Rebalancing Weight |
| 1 | Country = United States; Region = Central | 100% |
| 2 | Country = United States; Region = East | 50% |
| 3 | Country = Australia; Region = Central | 0% |

As shown in Table 1, the “Replica Number” identified by 1 and having a “Replica Locality” of the Central United States may be assigned a “Replica Leaseholder Rebalancing Weight” of 100% based on a complete match with both the Country and the Region of the “Replica Locality.” The “Replica Number” identified by 2 and having a “Replica Locality” of the East United States may be assigned a “Replica Leaseholder Rebalancing Weight” of 50% based on a partial match with only the Country of the “Replica Locality.” The “Replica Number” identified by 3 and having a “Replica Locality” of Central Australia may be assigned a “Replica Leaseholder Rebalancing Weight” of 0% based on a lack of any match with either the Country or the Region of the “Replica Locality.” Based on the assignment of rebalancing weights to the replicas of the range, the leaseholder may determine a rebalancing weight and latency corresponding to the leaseholder. The rebalancing weight and latency may be compared to the rebalancing weight and latency corresponding to the other replicas (e.g., as shown in Table 1) to determine an adjustment factor for each replica. In an example, the greater the disparity between weights and the larger the latency between localities, the more the replication layer may favor transferring the lease to the replica from the locality with the larger weight.

For leaseholder rebalancing, the leaseholder may evaluate each replica's rebalancing weight and adjustment factor for the localities with the largest weights. The leaseholder may transfer the lease to another replica, such as the replica of the node having the largest weight and/or adjustment factor. The leaseholder may transfer the lease to the replica if transferring the lease is beneficial and/or viable.

In some embodiments, based on a change to the number of nodes of a cluster, replicas for a range may require rebalancing. The replicas may require rebalancing based on changes to the membership of a Raft group resulting from the change to the number of nodes of the cluster. Rebalancing may enable optimal survivability and performance. Rebalancing may vary based on whether nodes are added to the cluster or removed from the cluster for the change to the number of nodes of the cluster. Based on nodes being added to the cluster, the added node(s) may communicate identifying information to the existing nodes of the cluster. The identifying information may include an indication that the added node(s) have available storage capacity. The cluster may rebalance replicas stored by the existing nodes to the added node(s). A node may be removed from a Raft group of a cluster based on a failure to respond to the Raft group after a period of time. In an example, the period of time may be 5 minutes. Based on nodes being removed from the cluster (e.g., due to a failure to respond to the Raft group), nodes of the cluster may rebalance data stored by the removed node(s) to the remaining nodes of the cluster.

Rebalancing may be enabled based on using a snapshot of a replica from the leaseholder. The snapshot may be sent to another node (e.g., over gRPC as described herein). Based on receiving and/or replicating the snapshot, the node with a replica (e.g., a replicated replica from the snapshot) may join the Raft group of the range corresponding to the replica. The node may determine the index of the added replica to lag one or more entries (e.g., the most recent entries) in the Raft log. The node may execute the actions indicated in the Raft log to update the replica to the state indicated by the most recent index of the Raft log. In some cases, replicas may be rebalanced based on the relative load stored by the nodes within a cluster.

### Storage Layer

In some embodiments, the database architecture for databases stored by a cluster (e.g., cluster 102) of nodes may include a storage layer. The storage layer may enable the cluster to read data from and write data to storage device(s) of each node. As described herein, data may be stored as KV pairs on the storage device(s) using a storage engine. In some cases, the storage engine may be a Pebble storage engine. The storage layer may serve successful read transactions and write transactions from the replication layer.

In some embodiments, each node of the cluster may include at least one store, which may be specified when a node is activated and/or otherwise added to a cluster. Read transactions and write transactions may be processed by the store. Each store may contain two instances of the storage engine as described herein. A first instance of the storage engine may store temporary distributed SQL data. A second instance of the storage engine may store data other than the temporary distributed SQL data, including system data (e.g., meta ranges) and user data (e.g., table data, client data, etc.). For each node, a block cache may be shared between each store of the node. The store(s) of a node may store a collection of replicas of a range as described herein, where a particular replica may not be replicated among stores of the same node (or the same node), such that a particular replica may exist only once on a particular node.

In some embodiments, as described herein, the storage layer may use one or more embedded KV stores (e.g., Pebble stores). A KV store may be used with an API to read data from and write data to storage devices (e.g., persistent storage devices) of nodes of the cluster. A KV store may enable atomic write batches and snapshots.

In some embodiments, the storage layer may use MVCC to enable concurrent requests. In some cases, use of MVCC by the storage layer may guarantee consistency for the cluster. As described herein, HLC timestamps may be used to differentiate between different versions of data (e.g., KVs) by tracking commit timestamps for the data. HLC timestamps may be used to identify a garbage collection expiration for a value as described herein. In some cases, the storage layer may support time travel queries (e.g., queries directed to MVCC versions of keys at previous timestamps). Time travel queries may be enabled by MVCC versions of keys.

In some embodiments, the storage layer may aggregate MVCC values (e.g., garbage collect MVCC values) to reduce the storage size of data stored by the persistent, non-volatile storage of nodes. The storage layer may compact MVCC values (e.g., old MVCC values) based on the existence of a newer MVCC value with a timestamp that is older than a garbage collection period. A garbage collection period may be configured for the cluster, database, and/or table. Garbage collection may be executed for MVCC values that are not configured with a protected timestamp. A protected timestamp subsystem may ensure safety for operations that rely on historical data. Operations that may rely on historical data may include imports, backups, streaming data using change feeds, and/or online schema changes. Protected timestamps may operate based on generation of protection records by the storage layer. Protection records may be stored in an internal system table. In an example, a long-running job (e.g., a backup) may protect data at a certain timestamp from being garbage collected by generating a protection record associated with that data and timestamp. Based on successful creation of a protection record, the MVCC values for the specified data at timestamps less than or equal to the protected timestamp may not be garbage collected. When the job (e.g., the backup) that generated the protection record is complete, the job may remove the protection record from the data. Based on removal of the protection record, the garbage collector may operate on the formerly protected data.

In some embodiments, a storage layer as described herein may be an embedded KV store. The storage layer may enable the cluster to read data from and write data to storage device(s) of each node. As described herein, data may be stored as KV pairs on the storage device(s) using a storage engine. The storage layer may provide atomic write batches and snapshots, which may indicate a subset of transactions. In some cases, the storage layer may operate at least one LSM tree at each node of the cluster to manage data storage, where each node stores replicas of one or more ranges of a database within the LSM tree. In some cases, other types of data storage structures, such as a B-tree, may be used in addition to or in place of an LSM tree at each node.

In some embodiments, the LSM tree may be a hierarchical tree data structure including a number of levels. For each level of the LSM tree, one or more files may be stored by one or more disks (e.g., physical and/or virtual disks) that include the data referenced at that respective level. The files may be SST files as described herein. In some cases, SST files may be an on-disk (e.g., on persistent, non-volatile storage such as disk storage, SSD storage, etc.) representation of sorted lists of KV pairs. SST files may be immutable, such that they are not modified (e.g., even during a compaction process) after being written and instead are deleted and rewritten.

### Transaction Execution

In some embodiments, as described herein, distributed transactional databases stored by the cluster (e.g., cluster 102) of nodes may enable receipt and execution of one or more transactions. Each transaction may include one or more requests directed to performing one or more operations. The one or more requests may include read requests and/or write requests. A read transaction may include at least one read request. A write transaction may include at least one write request. A transaction may be both a read and write transaction when the transaction includes at least one read request and at least one write request. In some cases, a request may be a query (e.g., a SQL query). A request may traverse one or more nodes of a cluster to execute the request. A request may interact with (e.g., sequentially interact with) one or more of the following: a SQL client, a load balancer, a gateway node, a leaseholder node, and/or a leader node as described herein. A SQL client may send a request (e.g., query) to a cluster. The request may be included in a transaction, where the transaction is a read and/or a write transaction as described herein. A load balancer may route the request from the SQL client to the nodes of the cluster. A gateway node may be a node that initially receives the request and/or sends a response to the SQL client. A leaseholder node may be a node that serves read requests and coordinates write requests for a range of keys (e.g., keys indicated in the request) as described herein. Serving a read request may include reading, by a request, one or more values of stored keys and sending the read values from the node on which the values were stored to the transaction coordinator for the transaction corresponding to the request, where the transaction coordinator for the transaction can operate on a gateway node that originally received the transaction (e.g., from a client device). A leader node may be a node that maintains consensus among the replicas for a range via coordination of a consensus protocol.

A SQL client (e.g., operating at a client device 106a) may send a request (e.g., a SQL request) to a cluster (e.g., cluster 102). The request may be sent over a network (e.g., the network 111). A load balancer may determine a particular node of the cluster to which to send the request. The node (operating as the gateway node for the client) may be a node of the cluster that is closest to the SQL client (e.g., having the lowest latency and/or having the closest geographic location to the computing device on which the SQL client is operating). A gateway node (e.g., a node 120a) may receive the request from the load balancer. The gateway node may parse the request to determine whether the request is valid. The request may be valid based on conforming to the syntax (e.g., SQL syntax) of the database(s) stored by the cluster. An optimizer operating at the gateway node may generate a number of logically equivalent query plans based on the received request. Each query plan may correspond to a physical operation tree configured to be executed for the query. The optimizer may select an optimal query plan from the number of query plans (e.g., based on a cost model). Based on the completion of request planning, a query execution engine may execute the selected, optimal query plan using a transaction coordinator as described herein. In some cases, a query plan may be generated and selected as described further in U.S. patent application Ser. No. 18/090,994, filed on Nov. 29, 2022, and published as U.S. Patent Application Publication No. 2024/0220498 on Jul. 4, 2024, which is hereby incorporated by reference herein in its entirety. A transaction coordinator operating on a gateway node may perform one or more operations as a part of the transaction layer. The transaction coordinator may cause execution of KV operations on a database stored by the cluster. The transaction coordinator may account for keys indicated and/or otherwise involved in a transaction. The transaction coordinator may package KV operations into a Batch Request as described herein, where the Batch Request may be forwarded on to a Distribution Sender (DistSender) operating on the gateway node.

A DistSender of a gateway node and/or coordinating node may receive Batch Requests from a transaction coordinator of the same node. The DistSender of the gateway node may receive the Batch Request from the transaction coordinator. The DistSender may determine the operations indicated by the Batch Request and may determine the node(s) (e.g., the leaseholder node(s)) that should receive requests corresponding to the operations for the range. The DistSender may identify and determine the node(s) (e.g., the leaseholder node(s)) that should receive requests corresponding to the operations for the range based on leaseholder information available to the DistSender at the gateway node. The leaseholder information may identify, for each range stored by the cluster, the nodes storing replicas of that range, the leaseholder node storing the leaseholder replica for that range, the leader node storing the leader replica for that range, and follower nodes storing the follower replicas for that range. The leaseholder information may be current as of a particular timestamp and may be updated as the nodes storing replicas of ranges change, such as changes in leaseholder and leader replicas. In some cases, leaseholder information may become out of date when the leaseholder information does not correctly identify the particular nodes storing particular replicas of a range. A first node may receive updated leaseholder information from a second, different node of the cluster, thereby causing the first node to update its leaseholder information with the timestamp at which the leaseholder information was updated.

In some embodiments, the DistSender may generate one or more Batch Requests based on determining the operations and the node(s) as described herein. The DistSender may send a first Batch Request for each range in parallel. Based on receiving a provisional acknowledgment from a leaseholder node's evaluator, the DistSender may send the next Batch Request for the range corresponding to the provisional acknowledgement. The DistSender may wait to receive acknowledgments for write requests and values for read requests corresponding to the sent Batch Requests.

As described herein, the DistSender of the gateway node may send Batch Requests to leaseholders (or other replicas) for data indicated by the Batch Requests. In some cases, the DistSender may send Batch Requests to nodes that are not the leaseholder for the range (e.g., based on out of date leaseholder information). Nodes may or may not store a replica indicated by the Batch Request. Nodes may respond to a Batch Request with one or more responses. A response may indicate the node is no longer a leaseholder for the range. The response may indicate the last known address of the leaseholder for the range. A response may indicate the node does not include a replica for the range. A response may indicate the Batch Request was successful if the node that received the Batch Request is the leaseholder. The leaseholder may process the Batch Request. As a part of processing of the Batch Request, each write request in the Batch Request may compare a timestamp of the write request to the timestamp cache. A timestamp cache may track the highest timestamp (e.g., the most recent timestamp) for any read request that a given range has served. The comparison may ensure that the write request has a higher timestamp than any timestamp indicated by the timestamp cache. If a write request has a lower timestamp than any timestamp indicated by the timestamp cache, the write request may be restarted at an advanced timestamp that is greater than the value of the most recent timestamp indicated by the timestamp cache.

In some embodiments, operations indicated in the Batch Request may be serialized by a latch manager of a leaseholder node. For serialization, each write request may be granted a latch on a row. Any read and/or write requests that arrive after the latch has been granted on the row may be required to wait for the write request to complete. Upon completion of the write request, the latch may be released and subsequent requests may proceed to execute. In some cases, a batch evaluator may ensure that write requests are valid. The batch evaluator may determine whether the write request is valid based on the leaseholder node's data. The leaseholder's data may be evaluated by the batch evaluator based on the leaseholder node coordinating write requests to the range. If the batch evaluator determines the write request to be valid, the leaseholder node may send a provisional acknowledgement to the DistSender of the gateway node, such that the DistSender may begin to send subsequent Batch Requests for the range to the leaseholder.

In some embodiments, requests may read from the local instance of the storage engine as described herein to determine whether write intents are present at a key. If write intents are present at a particular key, a request may resolve write intents as described herein. When the request is a read request and write intents are not present at the key, the read request may read the value at the key from the leaseholder's storage engine. Read responses corresponding to a transaction may be aggregated into a Batch Response by the leaseholder. The Batch Response may be sent to the DistSender of the gateway node. When the request is a write request and write intents are not present at the key, the KV operations included in the Batch Request corresponding to the write request may be converted to distributed consensus (e.g., Raft) operations and write intents, thereby enabling replication of the write request to the replicas of the range.

With respect to a single round of distributed consensus, the leaseholder may propose Raft operations to the leader replica of the Raft group (e.g., where the leader replica is typically also the leaseholder). Based on receiving the Raft operations, the leader replica may send the Raft operations to the follower replicas of the Raft group. Writing and/or execution of Raft operations as described herein may include writing one or more write intents to persistent storage. The leader replica and the follower replicas may attempt to write the Raft operations to their respective Raft logs. When a particular replica writes the Raft operations to its respective local Raft log, the replica may acknowledge success of the Raft operations by sending an indication of successful writing of the Raft operations to the leader replica. If a threshold number of the replicas acknowledge writing the Raft operations (e.g., the write operations) to their respective Raft log, consensus may be achieved such that the Raft operations may be committed (referred to as “consensus-committed” or “consensus-commit”). The consensus-commit may be achieved for a particular Raft operation when a majority of the replicas (e.g., including or not including the leader replica) have written the Raft operation to their local Raft log. The consensus-commit may be discovered or otherwise recognized by the leader replica as committed when a majority of the replicas have sent an indication of success for the Raft operation to the leader replica. Based on a Raft operation (e.g., write operation) being consensus-committed among a Raft group, each replica included in the Raft group may apply the committed entry to their respective local state machine. Based on achieving consensus-commit among the Raft group, the Raft operations (e.g., write operations included in the write transaction) may be considered to be committed (e.g., implicitly committed). The gateway node may update the status of the transaction record for the transaction corresponding to the Raft operations to committed (e.g., explicitly committed). A latency for the above-described distributed consensus round may be equal to a duration for sending a Raft operation from the leader replica to the follower replicas, receiving success responses for the Raft operation at the leader replica from at least some of the follower replicas (e.g., such that a majority of replicas write to their respective Raft log), and writing a write intent to persistent storage at the leader and follower replicas in parallel.

In some embodiments, based on the leader replica writing the Raft operations to the Raft log and receiving an indication of the consensus-commit among the Raft group, the leader replica may send a commit acknowledgement to the DistSender of the gateway node. The DistSender of the gateway node may aggregate commit acknowledgements from each write request included in the Batch Request. In some cases, the DistSender of the gateway node may aggregate read values for each read request included in the Batch Request. Based on completion of the operations of the Batch Request, the DistSender may record the success of each transaction in a corresponding transaction record. To record the success of a transaction, the DistSender may check the timestamp cache of the range where the first request of the write transaction occurred to determine whether the timestamp for the write transaction was advanced. If the timestamp was advanced, the transaction may perform a read refresh to determine whether values associated with the transaction had changed. If the read refresh is successful (e.g., no values associated with the transaction had changed), the transaction may commit at the advanced timestamp. If the read refresh fails (e.g., at least some value associated with the transaction had changed), the transaction may be restarted. Based on determining the read refresh was successful and/or that the timestamp was not advanced for a write transaction, the DistSender may change the status of the corresponding transaction record to committed as described herein. The DistSender may send values (e.g., read values) to the transaction coordinator. The transaction coordinator may send the values to the SQL layer. In some cases, the transaction coordinator may also send a request to the DistSender, where the request includes an indication for the DistSender to convert write intents to committed values (e.g., MVCC values). The SQL layer may send the values as described herein to the SQL client that initiated the query (e.g., operating on a client device).

### Database Architecture

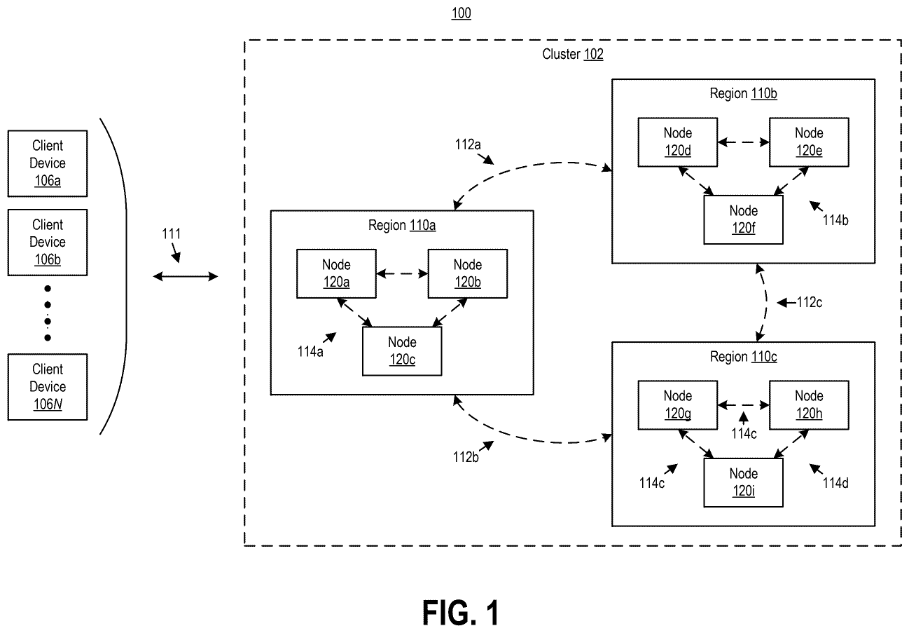

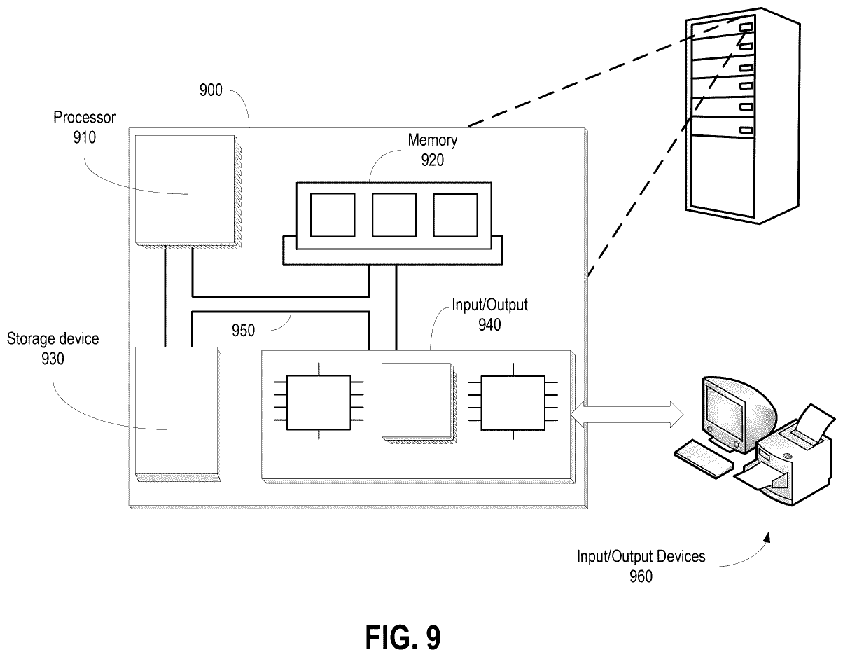

Referring to FIG. 1, an illustrative distributed computing system 100 is presented. The computing system 100 may include a cluster 102. In some cases, the computing system 100 may include one or more additional clusters 102 (not shown in FIG. 1). The cluster 102 may include one or more (e.g., a number of) nodes 120 distributed among one or more geographic regions 110. The geographic regions may correspond to cluster regions and database regions as described further below. A node 120 may be a computing device (e.g., a server computing device). In some cases, a node 120 may include at least portions of the computing system as described herein with respect to FIG. 9 As an example, a node 120 may be a server computing device. A node may store replicas of one or more ranges, where one or more SST files stored by the node 120 include the data (e.g., KV data) of the range. A region 110 may correspond to a particular building (e.g., a data center), city, state/province, country, geographic region, and/or a subset thereof. In some cases, each region 110 may be a distinct, non-overlapping geographic region. A region 110 may include multiple elements, such as a country and a geographic identifier for the country. For example, a region 110 may be indicated by Country=United States and Region=Central, which may indicate a region 110 as the Central United States. As shown in FIG. 1, the cluster 102 may include regions 110a, 110b, and 110c. In some cases, the cluster 102 may include one region 110. In an example, the region 110a may be the Eastern United States, the region 110b may be the Central United States, and the region 110c may be the Western United States. Each region 110 of the cluster 102 may include one or more nodes 120. In some cases, a region 110 may not include any nodes 120. The region 110a may include nodes 120a, 120b, and 120c. The region 110b may include the nodes 120d, 120e, and 120f. The region 110c may include nodes 120g, 120h, and 120i.

Each node 120 of the cluster 102 may be communicatively coupled via one or more networks 112 and 114. In some embodiments, the cluster 102 may include networks 112a, 112b, and 112c, as well as networks 114a, 114b, 114c, and 114d. The networks 112 may include a local area network (LAN), wide area network (WAN), and/or any other suitable network. In some cases, the networks 112 may connect nodes 120 of different regions 110. The nodes 120 of region 110a may be connected to the nodes 120 of region 110b via a network 112a. The nodes 120 of region 110a may be connected to the nodes 120 of region 110c via a network 112b. The nodes 120 of region 110b may be connected to the nodes 120 of region 110c via a network 112c. The networks 114 may include a LAN, WAN, and/or any other suitable network. The networks 114 may connect nodes 120 within a region 110. The nodes 120a, 120b, and 120c of the region 110a may be interconnected via a network 114a. The nodes 120d, 120e, and 120f of the region 110b may be interconnected via a network 114b. In some cases, the nodes 120 within a region 110 may be connected via one or more different networks 114. The node 120g of the region 110c may be connected to nodes 120h and 120i via a network 114c, while nodes 120h and 120i may be connected via a network 114d. In some cases, the nodes 120 of a region 110 may be located in different geographic locations within the region 110. For example, if region 110a is the Eastern United States, nodes 120a and 120b may be located in New York, while node 120c may be located in Massachusetts. In some embodiments, the nodes 120 forming the cluster 102 may store and operate one or more workloads. A workload may be a database including one or more ranges corresponding to a particular tenant. A tenant may be defined as corresponding to a particular entity, group of users, application, or a combination thereof. Different workloads operated by different tenants may be stored by the nodes 120 on one or more shared disks and/or one or more separate disks, such as virtual disks as described herein. Accordingly, a particular KV store operated on a disk configured as a primary disk for that KV store may include data for one or more workloads.

In some embodiments, the computing system 100 may include one or more client devices 106. The one or more client devices 106 may include one or more computing devices. In some cases, the one or more client devices 106 may each include at least portions of the computing system as described herein with respect to FIG. 9. In an example, the one or more client devices 106 may include laptop computing devices, desktop computing devices, mobile computing devices, tablet computing devices, and/or server computing devices. As shown in FIG. 1, the computing system 100 may include client devices 106a, 106b, and one or more client devices 106 up to client device 106N, where N is any suitable number of client devices 106 included in the computing system 100. The client devices 106 may be communicatively coupled to the cluster 102, such that the client devices 106 may access and/or otherwise communicate with the nodes 120. One or more networks 111 may communicatively couple the client devices 106 to the nodes 120. The one or more networks 111 may include a LAN, a WAN, and/or any other suitable network as described herein. As an example, the client devices 106 may communicate with the nodes 120 via a SQL client (e.g., an application) operating at each respective client device 106. To access and/or otherwise interact with data stored by the cluster 102, a client device 106 may communicate with a gateway node, which may be a node 120 of the cluster 102 that is closest (e.g., by latency, geographic proximity, and/or any other suitable indication of closeness) to the client device 106. The gateway node may route communications between a client device 106 and any other node 120 of the cluster. In some cases, one or more applications may operate on the client devices 106, with such application(s) interfacing with the nodes 120 to access, modify, and/or retrieve stored KV data. Tenants of the database(s) stored by the cluster 102 may interact with their respective databases using the client devices 106.

### Read Transaction Execution

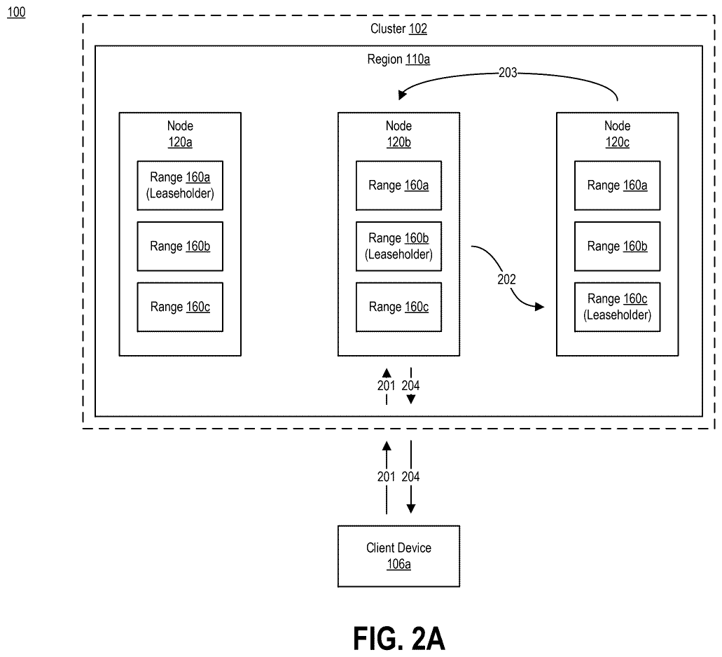

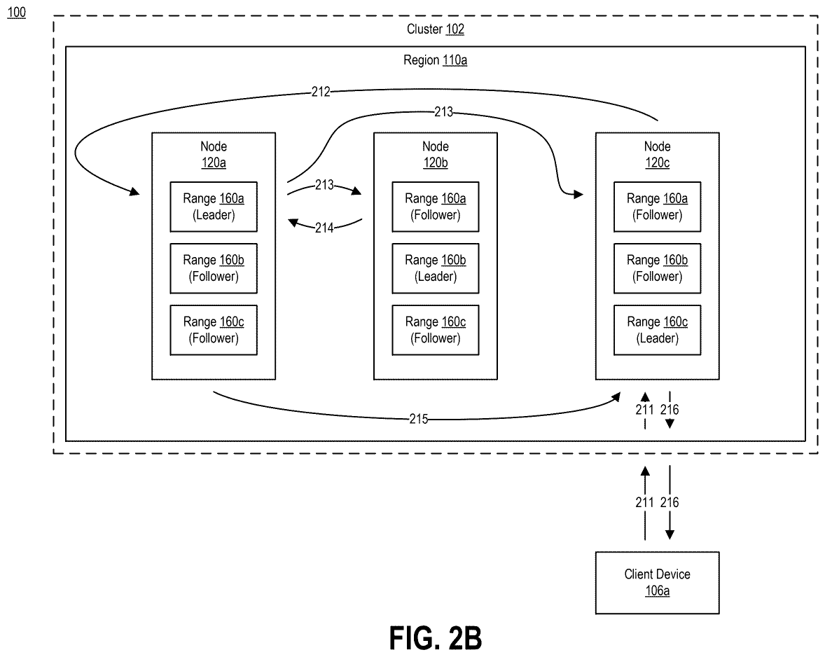

Referring to FIG. 2A, an example of execution of a read transaction including at least one read request at the computing system 100 is illustrated. In some embodiments, the nodes 120a, 120b, and 120c of the region 110a may include one or more replicas of ranges 160. The node 120a may store and operate replicas of a first range 160a, a second range 160b, and a third range 160c, where each of the ranges 160a, 160b, and 160c is a different range. The node 120a may store and operate the leaseholder replica for the range 160a (as indicated by “Leaseholder” in FIG. 2A). The node 120b may store and operate replicas of the first range 160a, the second range 160b, and the third range 160c. The node 120b may store and operate the leaseholder replica for range 160b (as indicated by “Leaseholder” in FIG. 2A). The node 120c may store and operate replicas of the first range 160a, the second range 160b, and the third 160c. The node 120c may store and operate the leaseholder replica for range 160c (as indicated by “Leaseholder” in FIG. 2A). While FIG. 2A is described with respect to communication between nodes 120 of a single region (e.g., region 110a), a read transaction may execute similarly using nodes 120 located within different geographic regions.

In some embodiments, a client device 106 may initiate a read transaction at a node 120 of the cluster 102 by sending the read transaction to the cluster 102. Based on the keys indicated by the read transaction, the node 120 that initially receives the read transaction from the client device 106 (e.g., the gateway node) may send the read request(s) of the read transaction to a node 120 storing and operating the leaseholder replica of the range 160 that includes the keys indicated by the read request(s). The node 120 storing and operating the leaseholder of the range 160 may receive and serve the read request(s) by reading a state of the data subject to the read request(s) from its state machine and sending the read data to the gateway node. For example, the node 120 storing and operating the leaseholder of the range 160 may serve the read request(s) by reading the values of the keys subject to the read request(s) and sending the read keys and values to the gateway node. The gateway node may receive the read data and may send the read data to the client device 106.

As shown in FIG. 2A, at step 201, the client device 106 may send a read transaction to the cluster 102. A node 120b functioning as the gateway node may receive the read transaction from the client device 106. The node 120b may be a node 120 of the cluster 102 that is located closest to the client device 106, with the closeness between the nodes 120 and the client device 106 being defined, for example, by a latency and/or a proximity as described herein. The read transaction may include at least one request directed to reading data stored by the range 160c. At step 202, the node 120b may send the read request(s) of the received read transaction to the node 120c. The read request(s) may be sent to the node 120c based on the node 120c being the leaseholder of the range 160c. The node 120c may receive the read request(s) from the node 120b and serve the read request(s) by reading a state of the data of the range 160c from the state machine of the node 120c. At step 203, the node 120c may send the read data from the range 160c to the node 120b. The node 120c may send the read data to node 120b based on the node 120b being the gateway node for the read transaction. The node 120b may receive the read data from node 120c. At step 204, the node 120b may send the read data to the client device 106a to complete the read transaction. If the node 120b had been configured to store and operate the leaseholder replica for the range 160c in place of the node 120c, the node 120b may have served the read data to the client device 106a directly after step 201 without sending the read request(s) of the read transaction to the node 120c.

### Write Transaction Execution

Referring to FIG. 2B, an example of execution of a write transaction including at least one write request at the computing system 100 is illustrated. In some cases, the nodes 120a, 120b, and 120c, of the region 110a may include one or more replicas of ranges 160. The node 120a may store and operate replicas of a first range 160a, a second range 160b, and a third range 160c, where each of the ranges 160a, 160b, and 160c are different ranges. The node 120a may store and operate the leaseholder replica and the leader replica for range 160a (as indicated by “Leaseholder” in FIG. 2A and “Leader” in FIG. 2B, respectively). The node 120b may store and operate replicas of the first range 160a, the second range 160b, and the third range 160c. The node 120b may store and operate the leader replica for range 160b (as indicated by “Leader” in FIG. 2B). The node 120c may store and operate replicas of the first range 160a, the second range 160b, and the third range 160c. The node 120c may store and operate the leader replica for range 160c (as indicated by “Leader” in FIG. 2B). While FIG. 2B is described with respect to communication between nodes 120 of a single region (e.g., region 110a), a write transaction may similarly execute using nodes 120 located within different geographic regions.

In some embodiments, a client device 106 may initiate a write transaction at a node 120 of the cluster 102 by sending the write transaction to the cluster 102, with the write transaction including at least one write request. Based on the keys indicated by the write transaction (e.g., the keys to which the write request(s) are directed), the node 120 that initially receives the write transaction (e.g., the gateway node) from the client device 106 may send the write request(s) of the write transaction to a leaseholder replica of the range 160 including the keys indicated by the write transaction. The node 120 storing and operating the leaseholder replica of the range 160 may receive and send the write request(s) to the node 120 storing and operating the leader replica of the range 160. In most cases, the leaseholder of the range 160 and the leader replica of the range 160 are configured to be same replica stored and operated on the same node 120. The node 120 storing and operating the leader replica may send the write request(s) to the corresponding nodes 120 storing and operating the follower replicas of the range 160 for replication, write intent(s) corresponding to the write request(s) to the leader replica, and append the write request(s) to a Raft log for the leader replica operated by the node 120. The node 120 storing and operating the leader replica may only append the write request(s) to its Raft log once a threshold number (e.g., a majority) of the nodes 120 storing and operating the replicas of the range (e.g., including the leader nodes and follower nodes) agree to append the write request(s) to their respective Raft logs by acknowledging the write request(s). The nodes 120 storing and operating the follower replicas of the range may receive the write request(s) from the node 120 storing and operating the leader replica, send acknowledgment of receipt of the write request(s) to the node 120 storing and operating the leader replica, append the write request(s) to the corresponding Raft logs for the follower replicas operated by the nodes, write intent(s) corresponding to the appended write request(s) to the follower replicas, and send an indication to the node 120 storing and operating the leader replica that the write request(s) were appended. The nodes 120 storing and operating the follower replicas of the range may only append the write request(s) to their respective Raft logs after sending an acknowledgment of receipt of the write request(s) to the node 120 storing and operating the leader node and receiving an indication from the node 120 storing and operating the leader replica to append the write requests to their Raft logs. Based on a threshold number (e.g., a majority) of the nodes 120 storing and operating the replicas acknowledging and/or sending an acknowledgment to the node 120 storing and operating the leader replica that the write request(s) were received and/or appended, the node 120 storing and operating the leader replica may commit the write transaction (e.g., by appending the write request(s) to its Raft log) by modifying a state of the range(s) in its state machine to which the write request(s) were directed. The node 120 storing and operating the leader replica may send an indication to the nodes 120 storing and operating follower replicas to commit the write request(s) (e.g., by appending the write request(s) to their Raft logs) and the write transaction. In some cases, write requests of the write transaction may be considered committed when appended to the leader replica's Raft log. The node 120 storing and operating the leader replica may send an acknowledgement of a commit of the write request(s) and the write transaction to the node 120 storing and operating the leaseholder replica, and the node 120 storing and operating the leaseholder replica may send the acknowledgement to the gateway node. The gateway node may send the acknowledgement to the client device 106. In some cases, the leaseholder node and/or the leader node may generate a log entry for a write request based on performing request evaluation as described herein. The log entry may be sent to follower nodes and appended to Raft logs as described herein in place of a write request.

As shown in FIG. 2B, at step 211, the client device 106 may send a write transaction to the cluster 102. A node 120c functioning as the gateway node may receive the write transaction from the client device. The node 120c may be a node 120 of the cluster 102 that is located closest to the client device 106, with the closeness between the nodes 120 and the client device 106 being defined, for example, by a latency and/or a proximity as described herein. The write transaction may include at least one write request directed to writing to data stored by the range 160a. At step 212, the node 120c may send the write request(s) of the received write transaction to the node 120a. The write request(s) may be sent to the node 120a based on the node 120a being the leaseholder node and storing the leaseholder replica of the range 160a. Based on the leaseholder replica stored by the node 120a also being configured as the leader replica for the range 160a, the leader replica of range 160a may perform request evaluation and append a generated log entry corresponding to the write request(s) to a Raft log at node 120a. The generated log entry may be indicative of the write request(s), such as by including the instructions and/or intended result of the write request(s). At step 213, the leader replica may synchronously (e.g., simultaneously) send the log entries to the follower replicas of range 160a stored and operating on the node 120b and the node 120c, respectively. The nodes 120b and 120c may receive the log entries and append the log entries to their respective Raft logs. At step 214, the follower replicas of the range 160a operating at nodes 120b and 120c may send an indication to the leader replica of the range 160a that the log entries were appended to their Raft logs. Based on a threshold number of replicas indicating the write request(s) were appended to their Raft logs, the leader replica and follower replicas of the range 160a may commit the write request(s) and the write transaction by modifying states of their replicas of the range in their respective state machines according to the write request(s) (e.g., log entries generated for the write request(s)). At step 215, the node 120a may send an acknowledgement of the committed write transaction to the node 120c. At step 216, the node 120c may send the acknowledgement of the committed write transaction to the client device 106a to complete the write transaction.

### Features of LSM Trees

In some embodiments, the storage layer may operate at least one LSM tree at each node of the cluster to manage data storage and organize stored data, where each node stores replicas of one or more ranges of a database within the LSM tree. In some embodiments, other types of data storage structures, such as a B-tree, may be used in addition to or in place of an LSM tree at each node.

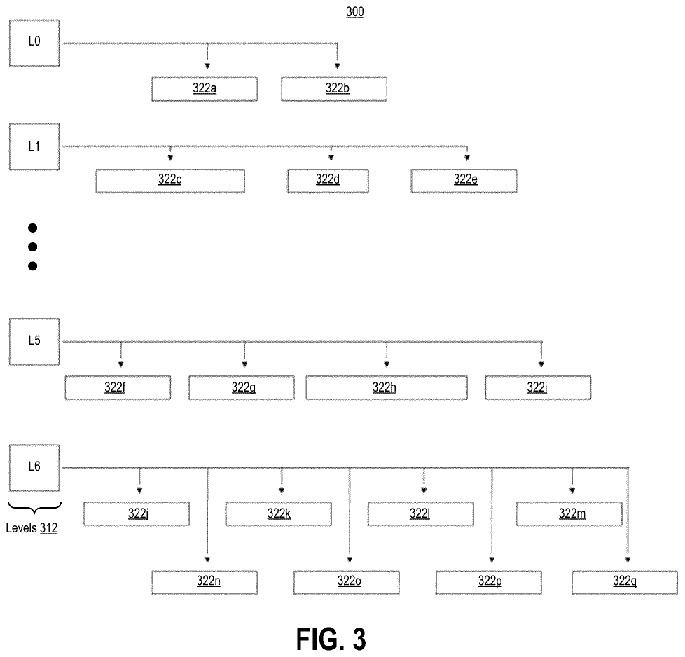

In some embodiments, levels of an LSM tree may be organized in descending order from level 0 (L0) to level 6 (L6), where L0 is the top-most (i.e., highest) level and L6 is the bottom-most (i.e., lowest) level. New data may be added (e.g., written or flushed) into L0 (e.g., using insert or import operations) and subsequently transferred downward into lower levels of the LSM tree over time. FIG. 3 shows an exemplary illustration 300 of an LSM tree. The LSM tree shown in the illustration 300 include a number of levels 312, including L0, L1, level 2 (L2) (not shown), level 3 (L3) (not shown), level 4 (L4) (not shown), level 5 (L5), and L6. Each level of an LSM tree may be associated with a set of SST files 322 spanning a key space of permissible keys, where each SST file 322: (i) includes keys spanning a segment (e.g., non-overlapping segment) of the key space, (ii) is immutable, and (iii) has a unique identifier (e.g., a monotonically increasing number). A span of sorted keys spanned by the keys of an SST file may be referred to as a “key span” of the SST file. As shown in FIG. 3, the L0 may include SST files 322a and 322b. The L1 may include SST files 322c, 322d, and 322e. L5 may include SST files 322f, 322g, 322h, and 322i. L6 may include SST files 322j, 322k, 322l, 322m, 322n, 3220, 322p, and 322q. While the levels 312 of the LSM tree shown and described with respect to FIG. 3 are described as including an exemplary number of SST files, each of the levels 312 may include any suitable number of SST files 322. The SST files 322 within some of the levels 312 may be non-overlapping, such that a segment of a key space spanned by a first SST file 322 in a particular level (e.g., L1) does not overlap with a segment of the key space spanned by a second SST file 322 in the same level. For example, if a first SST file of L1 includes a segment of the key space for the keys [A-F) (non-inclusive), a second SST file of L1 will contain a segment of the key space for keys [F-R), and so on. L0 may be an exception to such non-overlapping and may be the only level of the LSM tree that can contain SST files including respective segments of the key space that may overlap and have overlapping keys. Such an exception may be necessary to allow LSM tree-based storage engines to support ingesting large amounts of data, such as when using an import statement. Such an exception may be necessary to allow for easier and more efficient flushes of memtables to an LSM tree as described herein.

In some embodiments, a process of merging (e.g., combining) SST files and transferring the SST files from L0 to lower levels (e.g., L1-L6) in the LSM tree may be referred to as “compaction.” Compaction may include deleting one or more SST files in a first, higher level of the LSM tree and writing a new SST file including at least some (e.g., all) the data of the deleted SST file(s) in a second, lower level of the LSM tree that is below (e.g., immediately below) the first level. The storage engine may operate to compact data as quickly as possible. As a result of compaction, lower levels of the LSM tree may include larger numbers of SST files and/or larger-sized SST files that contain less recently updated keys, while higher levels of the LSM tree may include smaller numbers of SST files and/or smaller-sized SST files that contain more recently updated keys. A size of an SST file may be a storage (e.g., byte) size of the data included in the SST file. Generally, during normal operation of an LSM tree, lower levels of the LSM tree store more data (e.g., a greater number of bytes) than higher levels of the LSM tree. A compaction rate may refer to a rate at which sorted string table (SST) files are merged and moved from a top level (e.g., L0) of the LSM tree downward towards a bottom level (e.g., level 6 (L6)) of the LSM tree. In some cases, a compaction rate may refer to a rate at which SST files are merged and transferred from L0 of the LSM tree to level 1 (L1) of the LSM tree.

In some embodiments, the compaction process may be necessary to enable efficient operation of an LSM tree. From L0 down to L6 and during normal (e.g., healthy) operation of the LSM tree, each level of the LSM tree should have about 1/10 (10%) as much data (e.g., by storage size for the data) as the next level below. For example, L1 should store about 1/10 of the amount of data stored by L2, L2 should store about 1/10 of the amount of data stored by L3, and so on. For optimized operation of the LSM tree, as much data as possible is stored in larger SST files included in lower levels of the LSM tree. When compaction operations fall behind and SST files are not compacted to lower levels of the LSM tree at a sufficient rate, an inverted LSM tree may form based on accumulation of SST files at higher levels of the LSM tree as described herein.

In some embodiments, SST files are not modified during the compaction process, such that new SST files may instead be written and old SST files may be deleted. This design takes advantage of the fact that sequential disk access is faster than random disk access.

In some embodiments, the process of compaction may operate as follows: if two SST files referred to as SST file “A” and SST file “B” included in a first, higher level of an LSM tree are to be merged to be included in a second, lower level of the LSM tree, the contents thereof (e.g., KV pairs) may be read into memory (e.g., volatile storage of a node). Based on reading the contents of the SST files A and B, the contents may be sorted (e.g., sorted by key) in a list and merged together in memory, and a new SST file “C” may be opened and written to disk (e.g., non-volatile, persistent storage of a node) with the new, larger sorted list of KV pairs in the second level of the LSM tree. Based on the SST file C being written to disk, the old SST files A and B may be deleted from the first level of the LSM tree. Such compaction may be performed for more than two SST files being merged into a single SST file.

In some cases, to facilitate management of an LSM tree operating at a particular node of the cluster, the storage engine operating at a node may maintain an in-memory representation of the LSM tree referred to as a “memory table” or “memtable” stored by non-persistent, non-volatile storage media available to a node. In some cases, an LSM tree may not include any memtables (e.g., after a memtable is flushed to L0-L6 of the LSM tree). In some cases, an LSM tree may include one or more memtables. Write operations directed to the LSM tree may be considered durable when the write requests of write operations have been executed and written to (i) a memtable (e.g., thereby making the written value(s) visible to subsequent read operations), and (ii) a write-ahead-log (WAL) file mapped to that memtable. A memtable may have a fixed memory capacity (e.g., 128 megabytes (MB)), such that when a memtable reaches capacity, the memtable ceases to accept new write operations and a new memtable is generated to receive subsequent write operations. In some cases, the storage engine may enforce a maximum allowed number of memtables for an LSM tree. As an example, an LSM tree may not include more than between two and ten memtables and may preferably not include more than four memtables. In some cases, a process for copying (e.g., transferring) data from a memtable stored by non-persistent storage media of a node and writing the data to an SST file of the LSM tree stored by persistent storage media may be referred to as “flushing.” Data from a memtable may be flushed to levels (e.g., L0-L6) of the LSM tree when the memtable reaches a maximum memory capacity. In some cases, a WAL file stored by the persistent storage media of a node can be associated with each memtable to ensure durability in case of node failures (e.g., power loss or other unavailability), with the WAL file including a copy of the KV data and metadata written to the memtable. In some cases, memtables and WAL files may be mapped one-to-one, with a particular memtable mapped to one WAL file. The WAL file can store the newest (e.g., freshest or most recent) operations issued to the storage engine by the replication layer. Each WAL file may have a one-to-one correspondence with a memtable. Each WAL file and memtable can be kept in sync and updates from the WAL file and memtable can be written to SST files periodically as part of operations of the storage engine.

In some embodiments, a logical WAL file may include one or more physical WAL file segments. One or more physical WAL file segments may form a single logical WAL file. In some cases, as described herein with respect to WAL failover, WAL file segments of a WAL file may be deleted, combined, and rewritten to cause the data of each of the WAL file segments to be stored by a single disk (e.g., virtual disk and/or physical disk). In some cases, a write request directed to a range may be executed by writing at least one value for a key to a memtable and a WAL record of a WAL file segment. A WAL file segment may include one or more WAL records, with each WAL record corresponding to a batch of one or more executed write requests (e.g., KV write requests). Each WAL record of a WAL file segment may include the data (e.g., KV data) written by the batch of executed write requests corresponding to that record. In some cases, each WAL record may be assigned a sequence identifier (e.g., sequence number) for the batch of write requests corresponding to that WAL record. As an example, each batch of write requests and the WAL record corresponding to that batch may be assigned a monotonically increasing sequence identifier ordered by a timestamp at which the batch of write requests was executed and written to a WAL record. The timestamp may be read from the HLC of the node executing the batch of write requests. Accordingly, in some cases, WAL file segments stored by different disks (e.g., primary and secondary disks) may include one or more of the same WAL records with the same sequence identifiers when the batch of write requests was executed and written to each of the disks, such that duplicate WAL records may exist between the different WAL file segments of the different disks. Duplicate WAL records between different WAL file segments of the different disk may be de-duplicated and re-ordered in sequence (e.g., by assigned sequence identifier) when a node recovers a WAL file segment from a secondary disk for storage on a primary disk as described herein (e.g., during recovery from WAL failover).

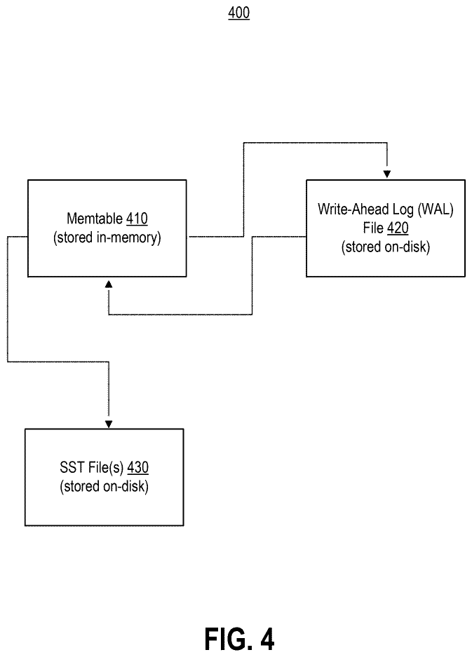

FIG. 4 shows an exemplary block diagram 400 illustrating a relationship between the memtable 410, the WAL file 420, and one or more SST files 430 included in the storage layer of the database. The memtable 410 may be stored by volatile storage media (e.g., random-access memory (RAM)) of a node. The WAL file 420 may be stored by persistent, non-volatile storage media of a node. One or more SST files 430 may be stored by persistent, non-volatile storage media of a node. As shown in FIG. 4, new values may be simultaneously written to the WAL file 420 and the memtable 410. From the memtable 410, the stored values may eventually be written to the one or more SST files 430 on disk for longer-term storage. As described herein, one or more memtables 410 may be included in an LSM tree that each correspond to a respective WAL file 420.

In some embodiments, a design of the LSM tree can optimize write operation performance over read operation performance. By storing sorted KV data in SST files, the storage engine avoids random disk searches when performing write operations. The storage engine of the storage layer may attempt to mitigate the cost of read operations (e.g., random searches) by executing read operations at SST files located in the lowest possible levels of the LSM tree, such that the storage engine reads from fewer, larger SST files. The storage engine may perform compaction operations to compact and merge SST files to produce the fewer, larger files located in lower levels of the LSM tree. In some cases, the storage engine may use a block cache to increase the speed of read operations. The tradeoffs in the design of the LSM tree are intended to take advantage of the operating parameters of modern disk storage, since modern disk storage can provide faster read operations of random locations on disk due to caches, but can perform relatively poorly on write operations directed to random locations.

### Features of SST Files

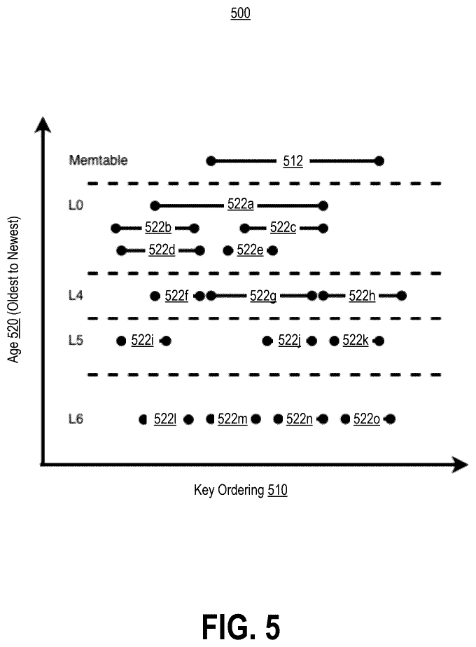

As described herein, an LSM tree-based storage layer of a distributed database system may be organized into a plurality of levels (e.g., L0-L6). FIG. 5 shows an exemplary illustration 500 of a relationship between an LSM tree and a memtable 512, where the memtable 512 and SST files 522 (e.g., included SST files 522a-522p) are organized based on a key ordering 510 and an age 520 of values included in the SST files. Key ordering 510 may refer to an ordering of keys of KV pairs included in a permissible key space, where the keys may be ordered using any suitable ordering technique (e.g., alphabetically, numerically, alphanumerically, and/or chronologically). The age 520 of values included in SST files may refer to a time at which values corresponding to keys were most recently updated, where the oldest keys are those with the least recently updated values and the newest keys are those with the most recently updated values. Boundaries of the memtable 512 and SST files 522 as shown in FIG. 5 may correspond to respective segments of the key space spanned by keys included in the memtable 512 and SST files 522. As described herein, levels L1 and lower (e.g., to L6) of the LSM tree may not include SST files with keys corresponding to overlapping segments of the key space, while L0 may include SST files with keys corresponding to overlapping segments of the key space. Read amplification as described herein may refer to a maximum number of files (e.g., memtables and SST files) in a vertical section of the LSM tree, which may be based on a number of memtables included in the LSM tree, a number of sublevels included in level L0 of the LSM tree, and a number of other levels (e.g., L1-L6) included in the LSM tree. A storage engine of the storage layer may control any and/or all operations corresponding to the LSM tree and a related admission queue for the LSM tree. For example, the storage engine may generate a number of tokens and may admit work items corresponding to write operations from an admission queue based on the work items consuming generated tokens as described herein.

In some cases, the number of files and sublevels included in L0 may dynamically change based on a rate of write operations to the LSM tree, such that there may be no limit (e.g., upper bound) to the number of files and sublevels included in L0. Accordingly, read amplification may increase without bound, which reduces speeds for read operations. Further, the number of memtables included in an LSM tree may be dynamically changing based on flush rates for flushing memtables to levels of the LSM tree.

In some embodiments, data included in memtables may be flushed to SST files included in L0 of the LSM tree. In some cases, there may be a maximum number of allowed memtables (e.g., 2, 3, 4, 6, 8, or 10 memtables) for an LSM tree. When a maximum (e.g., threshold) number of memtables is reached, write operations to the LSM tree may stall. Stalling of write operations to the LSM tree may occur when the rate of writing data to memtables based on write operations exceeds the rate of flushing of memtables to L0 of the LSM tree. In some cases, admission to the LSM tree as described herein may refer to admission of work items corresponding to write operations (e.g., included in transactions) to a memtable of one or more memtables, where a work item admitted and written to the memtable may be flushed to the LSM tree after admission from the admission queue.

In some embodiments, based on the use of admission control techniques to admit work items to the LSM tree, an admission queue may control work items corresponding to write operations admitted to the LSM tree. All write operations directed to a key space of KV data (e.g., stored by virtual SST files and/or physical SST files) included in the LSM tree may be required to enter the LSM tree through the admission queue. In some cases, work items (e.g., write operations) at a front (also referred to as “head”) of the admission queue are admitted to the LSM tree when a positive number of “byte tokens” are available for consumption by the work items. A number of byte tokens consumed by a particular work item may be based on (e.g., equivalent to, proportional to, etc.) a size (e.g., number of bytes) of the work item admitted to the LSM tree and/or a size (e.g., number of bytes) occupied by the admitted work item. For example, an amount of data (e.g., number of bytes) corresponding to a number of byte tokens consumed by a work item may be equivalent to a size of a work item. In some cases, a size of a particular work item may be equivalent to an amount of data added to an LSM tree when the work item is admitted to the LSM tree. Consumption of byte tokens by a work item may cause deletion or removal of the consumed byte tokens from the byte tokens available for consumption by other work items. Byte tokens may be computed and generated (e.g., replenished) as described herein. Byte tokens may be used to control and constrain a number of work items admitted from the admission queue to the LSM tree, where a number of available byte tokens may be consumed by work items for admission to the LSM tree, thereby causing other work items to wait for additional byte tokens to be made available. In some embodiments, tokens configured to admit data of any suitable size may be used in place of byte tokens as described herein. Additional features of admission of work items for write operations are described further in U.S. patent application Ser. No. 18/320,671, and published as U.S. Patent Publication No. 2023/0376476 on Nov. 23, 2023, which is hereby incorporated by reference herein in its entirety.

As described herein, LSM tree-based storage systems may store KV pairs in SST files organized in an LSM tree stored by an individual node. For an SST file, KV pairs may be stored and sorted by key in a sequence of data blocks. In some cases, an LSM tree storage system of a particular node may include a number of SST files. Each SST file may (i) correspond to a segment of a key space of permissible keys and (ii) have particular key boundaries, such that each SST file may include KV entries corresponding to a particular key span of the key space. A first SST file of a number of SST files may or may not include keys within a range of a second SST file of the number of SST files. For example, for keys ranging from integers of 1-9 (smallest to largest keys), a first SST file may have a key range of [1, 5) and a second SST file may have a key range of [4, 9). An SST file may be selected from a number of SST files of an LSM tree based on a key range of the SST file (e.g., according to a target and/or selected key range indicated by a query). To enable efficient key lookup and range scans, SST files may include an additional index structure referred to herein as a “BlockHandle” (also referred to as a “block handle”). An SST file may include a number (e.g., series) of second-level index blocks, where each second-level index block includes a key per data-block mapped to the second-level index block (e.g., where the key is typically the last key included in the respective data block). A second-level index block may have a maximum capacity (e.g., 256 kilobytes (KB)), such that a number of second-level index blocks may be needed for indexing mappings of data blocks to BlockHandles as described herein. Additional second-level index block(s) may be generated for an SST file based on the second-level index block(s) of an SST file reaching a maximum storage capacity.

In some embodiments, an index block can include one or more KV pairs that each map a key to a BlockHandle, where the BlockHandle is the value mapped to the key in the KV pair. A BlockHandle encodes and identifies the location of a particular block (e.g., an index block or a data block) within the SST file and may be represented as a tuple. An example tuple representing a BlockHandle may be (file-offset, block-length), where “file-offset” may indicate the location of a data block or index block within the SST file and “block-length” may indicate the length (e.g., data storage size) of the respective data block or index block. Such a tuple may be used by a node to read data from an SST file for a particular interval of the SST file (e.g., starting from a beginning of the SST file) as defined by a starting position and an ending position within the SST file. For example, based on a tuple corresponding to a BlockHandle, a node may read data from the SST file for a byte interval of [file-offset, file-offset+block-length) bytes from a beginning of the SST file. In some cases, an SST file can include a single top-level index block that includes a key per second-level index block (e.g., where the key is typically the last key included in the respective second-level index block). The top-level index block may be hierarchically layered above the second-level index block(s) of the SST file. The top-level index block may map keys to BlockHandles (e.g., where the BlockHandle is the respective value mapped to the key in the KV pair). A BlockHandle may function as a data pointer that is used to read the associated block (e.g., a second-level index block or a data block) indicated by the pointer.

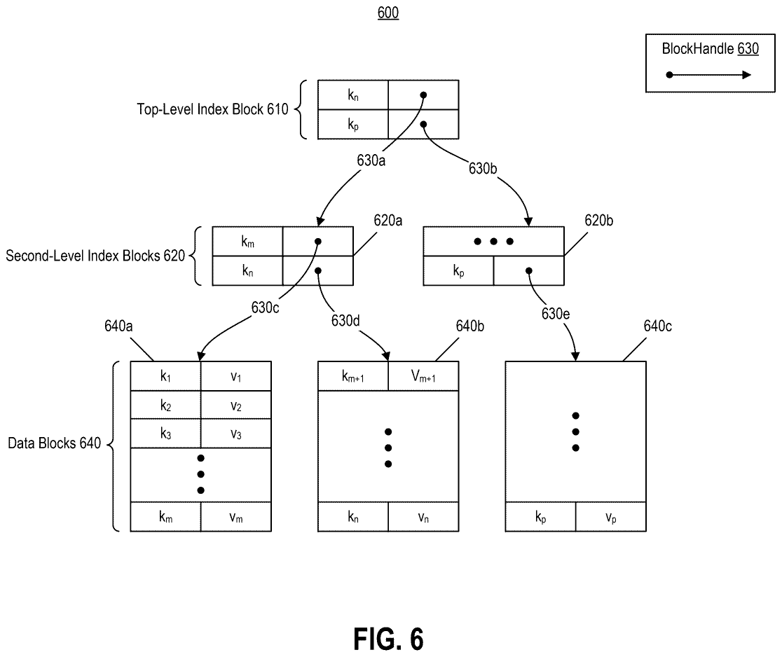

FIG. 6 shows an exemplary illustration of an SST file 600. The SST file 600 includes a top-level index block 610, one or more second-level index blocks 620, and one or more data blocks 640. As shown in FIG. 6, “k” may refer to a key of a particular KV pair and “v” may refer to a value of a particular KV pair. The top-level index block 610 includes a key per second-level index block 620 of the SST file 600. As an example, a top-level index block 610 may include a number of keys equivalent to a number of second-level index blocks 620 included in the SST file 600. As shown in FIG. 6, the top-level index block 610 includes keys kₙ and kₚ that map to BlockHandles 630a and 630b, respectively. The BlockHandle 630a encodes and identifies the location of the second-level index block 620a within the SST file 600. The BlockHandle 630b encodes and identifies the location of the second-level index block 620b within the SST file 600. The second-level index blocks 620 include a key per data block 640 mapped to each of the second-level index blocks 620. As shown in FIG. 6, the second-level index block 620a includes keys kₘ and kₙ that map to BlockHandles 630c and 630d, respectively, and the second-level index block 620b includes a key kₚ that maps to BlockHandle 630e.

Each of the data blocks 640 may include one or more KV pairs. As shown in FIG. 6, for the index blocks 610 and 620 and data blocks 640 of the SST file 600, “m”, “n”, and “p” can refer to any suitable identifier, including integers greater than 0. In some cases, keys in each data block 640 may be sorted. For example, for data block 640a, keys may be sorted from k₁ to kₘ, where m is an integer that is greater than 1. Keys in each data block may be sorted using any suitable technique including, for example, alphabetically, numerically, alphanumerically, and chronologically. As shown in FIG. 6, the data block 640a includes keys k₁ to kₘ which are mapped to values v₁ to vₘ, respectively. The data block 640b includes keys kₘ₊₁ to kₙ which are mapped to values vₘ₊₁ to vₙ, respectively, and where n is greater than m. The data block 640c includes one or more KV pairs, including at least key kₚ which is mapped to value vₚ. While the SST file 600 is shown as including the top-level index block 610, the second-level index blocks 620a and 620b, and the data blocks 640a, 640b, and 640c, the SST file 600 may include any suitable number of second-level index blocks 620 based on any suitable number of data blocks 640.

In some embodiments, an iterator operating at a node of the cluster storing an LSM tree and one or more SST files may be used to query, identify, and return data in response to a particular query operation. To query (e.g., search) the SST file 600, an iterator may first scan the top-level index block 610 and compare the search key (e.g., included in a received query) to the keys included in the top-level index block 610 to the appropriate second-level index block(s) 620 that includes key(s) corresponding to the search key. In some cases, the search key may include one or more search keys and/or one or more search key ranges. Based on identifying the appropriate key in the top-level index block 610 that corresponds to the search key, the iterator may decode the BlockHandle stored by the value mapped to the appropriate key and load the referenced second-level index block 620. The iterator may load the second-level index block 620 by reading block-length bytes from the SST file 600 starting at the position in the SST file indicated by the file-offset included in the BlockHandle tuple (e.g., defined by the [file-offset, file-offset+block-length) interval). Based on loading the second-level index block 620, the iterator may scan the second-level index block 620 and compare the search key to the keys included in the second-level index block 620 to identify the appropriate data block(s) 640 that include key(s) corresponding to the search key. Based on identifying the appropriate key in the second-level index block 620 that corresponds to the search key, the iterator may decode the BlockHandle stored in the value mapped to the appropriate key and load the referenced data block 640. Based on loading the referenced data block 640, the iterator may scan the data block 640 to identify the KV data included in the data block 640 corresponding to the search key. The iterator may then cause sending of the identified KV data corresponding to the search key to a client device (e.g., via a gateway node).

In some embodiments, SST files may include encoded block properties that encode attributes of the KV pairs included in the SST files within the keys and/or values of such KV pairs. Such block properties may be used to filter SST files during execution of queries directed to reading KV data included in the SST files. Additional features of block property collection and filtering are described further in U.S. patent application Ser. No. 18/448,301, and published as U.S. Patent Publication No. 2024/0054103 on Feb. 15, 2024, which is hereby incorporated by reference herein in its entirety.

### Techniques for WAL Failover

In some embodiments, a node of the cluster may receive one or more write requests included in a transaction (e.g., a transaction received from a client device). The write requests may be directed to replicas of one or more ranges stored by the node, with the node storing replicas of the ranges on-disk on one or more physical disks. A node may include and operate at least one memory, such as the memory 920 described herein with respect to FIG. 9. A node may include and operate one or more physical disks, such as the storage device 930 described herein with respect to FIG. 9. In some cases, a node may operate using one or more virtual disks provisioned from, mapped to, and/or otherwise backed by the one or more physical disks, with the node using the one or more disks for storage of KV data. As an example, a node may operate using one or more virtual disks multiplexed on the one or more physical disks. A node may be configured to write to a primary disk for generation of and writing to WAL files and SST files, such as a primary virtual disk and/or a primary physical disk. A node may be configured to write to a secondary disk for generation of and writing to WAL files, such as a secondary virtual disk and/or a secondary physical disk. Different disks may be configured as primary and secondary disks for different KV stores, such that a disk configured as a primary disk for a first KV store for one or more workloads may be configured as a secondary disk for a different, second KV store for one or more workloads as described herein. A particular disk may be configured as the primary disk 710 for one or more first KV stores and/or as the secondary disk for one or more secondary KV stores, where the one or more first KV stores may be the same as or different from the one or more secondary KV stores. Typically, a disk may be configured as a primary disk 710 for only one KV store to maintain the performance of read and write operations directed to that KV store.

Based on write operations directed to a primary disk (e.g., resulting in primary disk overload), the primary disk may experience transient unavailability that increases latencies for writing to the primary disk. Accordingly, write operations directed to the primary disk may dramatically slow and/or stall, thereby increasing latencies for execution of the write operations. Conventional buffered-write storage systems that involve executing a write request by writing to an in-memory memtable and an on-disk WAL file before flushing and compaction of written data lack techniques for remedying the performance deficiencies associated with transient unavailability. Accordingly, techniques for WAL failover are provided to allow for continued execution of write requests originally directed to a WAL file segment stored by a primary disk by causing failover of the write requests to a generated WAL file segment stored by a secondary disk. Further, such techniques for WAL failover may allow for execution of write requests originally directed to a primary disk by causing failover of the write requests to a generated WAL file segment stored by a secondary disk without initially writing any of the write requests to a WAL file segment stored by the primary before failing over and switching to the secondary disk. The secondary disk may be a secondary virtual disk and/or a secondary physical disk. By failing over to the secondary disk in the event of transient unavailability of the primary disk, a node may execute write operations directed to a WAL file by writing to a WAL file segment of the WAL file stored by the secondary disk while the transient unavailability is present.

Further, the node may probe the primary disk to determine when the transient unavailability is resolved and switch back to writing to a WAL file segment stored by the primary disk in response to determining the transient unavailability is resolved. Transient unavailability of a disk being resolved may be indicative of that disk healing from the transient unavailability, such that the disk operates with acceptable performance (e.g., write latency and/or rate, read latency and/or rate, or a combination thereof) after the transient unavailability is resolved and is no longer affecting that disk at the point in time in which the transient unavailability is resolved (e.g., as determined by the node). The node may further recover data written to a WAL file segment stored by the secondary disk to ensure the logical WAL file is stored by the primary disk (e.g., to provide durability for the written data) by copying the written data to the primary disk, while reordering and de-duplicating any copied data based on data written to the primary disk before switching from the primary disk to the secondary disk and after switching back to the primary disk from the secondary disk.

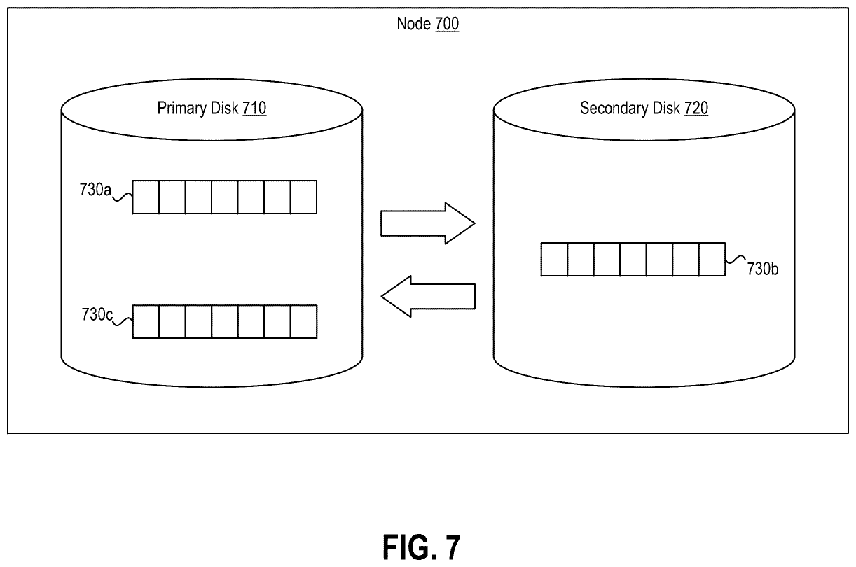

Referring to FIG. 7, an exemplary block diagram illustrating disk failover by a node 700 of the cluster operating using techniques for WAL failover is illustrated. The node 700 may be communicatively coupled to one or more other nodes of the cluster via one or more networks and may include at least one processor, a memory, a disk configured as a primary disk 710 for at least one KV store, and a disk configured secondary disk 720 for the at least one KV store. As an example, the node 700 may be a server positioned in a server rack, with the at least one processor, memory, primary disk 710, and secondary disk 720 positioned within the server rack. References made herein to a primary disk 710 and a secondary disk 720 may refer to configuration of the underlying disks as the primary disk 710 and the secondary disk 720 for a particular KV store.

A virtual disk and/or a physical disk of the node 700 may be configured to operate as the primary disk 710 for at least one KV store storing range data for one or more workloads. Accordingly, for at least one KV store corresponding to one or more workloads, the primary disk 710 may be configured to store replicas of one or more ranges. The node 700 may be configured to generate and store WAL files and SST files on the primary disk 710. As described herein, the WAL files and SST files may store the range data for a workload, such as KV data and related metadata. The SST files stored by the primary disk 710 may be organized in an LSM tree, with in-memory memtables being flushed to SST files stored by the primary disk 710, and SST files organized among levels of the LSM tree being compacted to lower levels of the LSM tree as described herein. In some cases, other types of buffered write storage structures, such as B-epsilon trees and/or STB-epsilon-trees, may additionally or alternatively be used to store range data.

A virtual disk and/or a physical disk of the node 700 different from the primary disk 710 may be configured to operate as the secondary disk 720 to receive WAL failover write operations for the at least one KV store storing range data for one or more workloads. The secondary disk 720 may be provisioned and/or configured to have a maximum storage capacity less than a maximum storage capacity of the primary disk 710, such that the secondary disk 720 operating to receive WAL failover write operations requires a lower maximum storage capacity than the primary disk 710. The secondary disk 720 may be provisioned and/or configured to have a minimum write performance less than a minimum write performance of the primary disk 710, such that the secondary disk 720 operating to receive WAL failover write operations requires a reduced write performance than the primary disk 710. As an example, the secondary disk 720 may be configured to have less bandwidth for write operations and write at a slower rate (e.g., input/output operations per second (IOPS), MB per second, etc.) than the primary disk 710. Such a configuration of the secondary disk 720 may be beneficial by reducing the necessary performance requirements and related cost of the secondary disk 720 and/or cost of operating the secondary disk 720 relative to the primary disk 710.

In some embodiments, the node 700 may use different disks as the primary disk 710 and the secondary disk 720 for different KV stores. Accordingly, different KV stores stored and operated by the same node 700 may utilize a primary disk of a different, peer KV store as a respective secondary disk, such that a particular disk of a number of disks operated by the node 700 may function as a primary disk 710 and/or a secondary disk 720 with respect to different KV stores and workload(s) thereof. As an example, for a particular KV store, a disk may be configured as a primary disk for generation of and writing to WAL files and SST files, as a secondary disk for generation of and writing to WAL files during WAL failover operations, or neither a primary disk nor a secondary disk.

In some embodiments, an individual node of the cluster may be configured to execute techniques for WAL failover and recovery in the event of transient unavailability of the node's disk configured as a primary disk for a KV store including a replica of a range of a particular workload during execution of write operations directed to the KV store based on one or more write requests. To initiate WAL failover, the node 700 may monitor a primary disk health parameter for the primary disk 710 during execution of write operations directed to writing to the primary disk 710. Some non-limiting examples of the primary disk health parameter include a latency of write operations directed to writing to the primary disk 710 and a rate of write operations directed to writing to the primary disk 710. The write operations directed to writing to the primary disk 710 may include write operations corresponding to one or more logical WAL files, including one or more of: generating and storing a new WAL file segment of one or more WAL file segments of one of the logical WAL file(s) on the primary disk 710, executing a write request (e.g., a batch of write requests) of one or more received write requests by writing data (e.g., a WAL record including KV data) to the generated WAL file segment stored by the primary disk 710, synchronizing a WAL file with a memtable mapped to the WAL file by copying and writing metadata from the memtable to the WAL file segment stored by the primary disk 710, and performing a synchronization operation (e.g., fsync operation) that forces writing of data from a buffer (e.g., non-persistent, volatile storage buffer connected to persistent, non-volatile storage of the primary disk 710) to the WAL file segment stored by the primary disk 710.

Monitoring the primary disk health parameter may include continuously or periodically determining one or more values of the primary disk health parameter by monitoring the write operations directed to the primary disk 710. As an example, the node 700 may continuously or periodically determine one or more values of the latency of write operations directed to the primary disk 710 by monitoring the write operations directed to the primary disk 710 over a period of time (e.g., during execution of the write operations thereto). Accordingly, the node 700 may determine and collect one or more values of the primary disk health parameter by monitoring the write operations directed to the primary disk 710 for comparison purposes to detect transient unavailability of the primary disk 710.

In the example of FIG. 7, the node 700 may store a first WAL file segment 730a, a second WAL file segment 730b, and a third WAL file segment 730c, two or more of which (e.g., each of which) may correspond to the same logical WAL file. In some cases, two or more of (e.g., each of) the first WAL file segment 730a, the second WAL file segment 730b, and the third WAL file segment 730c may correspond to different logical WAL files. Further, the node 700 may store one or more WAL file segments corresponding to one or more logical WAL files.

The primary disk 710 may store the first WAL file segment 730a and the third WAL file segment 730c and the secondary disk 720 may store the second WAL file segment 730b. The first WAL file segment 730a, second WAL file segment 730b, and third WAL file segment 730c may each include one or more WAL records corresponding to one or more batches of executed write requests. The second WAL file segment 730b may be generated and written to after generation of the first WAL file segment 730a and after switching from the primary disk 710 to the secondary disk 720. The third WAL file segment 730c may be generated and written to after generation of the first WAL file segment 730a and the second WAL file segment 730b and after switching from the secondary disk 720 back to the primary disk 710.

In some embodiments, while not shown in FIG. 7, a WAL file segment of a particular logical WAL file may first be generated and stored by the secondary disk 720, such that any WAL file segment of that particular logical WAL file may only be generated and stored by the primary disk 710 after a WAL file segment of that particular logical WAL file is first generated and stored by the secondary disk 720 and after switching back to writing to the primary disk 710 from the secondary disk 720. Such a scenario may occur when one or more earlier write requests directed to the primary disk 710 for which a primary disk health parameter is monitored causes the node 700 to switch from the primary disk 710 to the secondary disk 720, thereby causing one or more later write requests to write to the secondary disk 720 after the node 700 initially switches from the primary disk 710 to the secondary disk 720 and before the node 700 switches back to the primary disk 710 from the secondary disk 720. As an example, the WAL file segment 730b may correspond to a different logical WAL file than the WAL file segment 730a.

In some embodiments, the write operations may further include buffered-write storage system write operations, such as flushing of data from a memtable to one or more SST files stored by the primary disk 710 and/or compaction of one or more SST files stored by the primary disk 710 and organized in a higher level of an LSM tree to one or more SST files stored by the primary disk 710 and organized in a lower level of the LSM tree. In some cases, write operations directed to the primary disk 710 may be sequential, such that the node 700 monitors a primary disk health parameter (e.g., a latency and/or a rate) of one particular write operation directed to the primary disk 710 (e.g., executing a batch of write requests by writing to a WAL record). As an example, based on receiving one or more write requests directed to a replica of at least one range stored by the node 700, the node 700 may write to a memtable stored in-memory and generate and cause storage of one or more WAL file segments including a WAL file segment 730a of a WAL file stored by the primary disk 710. The node 700 may write one or more WAL records to the WAL file segment 730a as described herein, with the WAL records corresponding to one or more batches of executed write requests. In some cases, execution of write requests by writing to the primary disk 710 may occur sequentially, such that the node 700 may only execute one write request at a particular instant in time for a particular disk. In some cases, the node 700 may determine to execute a batch of one or more write requests by writing to a WAL file segment stored by the primary disk 710, such that the node 700 continues to execute the write requests included in that batch by writing to the primary disk 710 even after switching to the secondary disk 720 for WAL failover based on detecting a transient unavailability exists at the primary disk 710. Such techniques may guarantee that no write request and no WAL record(s) written by that write request are lost as a result of switching between the primary disk 710 and the secondary disk 720 due to a failure to write to either of the primary disk 710 or the secondary disk 720.

In some embodiments, a latency of write operations directed to writing to the primary disk 710 may be defined as an amount of time between beginning and completing execution of one or more particular write operations, such as one particular write operation of the write operations directed to the primary disk 710. As an example, a particular write operation of the write operations may include executing a write request by writing at least one value for (e.g., mapped to) a key (e.g., with the key and value forming a KV pair), executing a batch of one or more write requests by generating and writing to a WAL record of a WAL file segment, generating and storing a WAL file segment (e.g., an empty WAL file segment lacking any WAL records), synchronizing data as described herein, or a combination thereof. In some cases, the latency of write operations directed to writing to the primary disk 710 can be determined for one or more write operations. A rate of write operations directed to writing to the primary disk 710 may be defined as IOPS and/or MB per second written to the primary disk 710. In some cases, the rate of write operations directed to writing to the primary disk 710 can be determined for one or more particular write operations, such as one particular write operation of the write operations directed to the primary disk 710.

In some embodiments, when the node 700 is configured to use WAL failover in the event of transient unavailability of the primary disk 710, the node 700 may continuously or periodically monitor and determine a primary disk health parameter of write operations directed to the primary disk 710. The primary disk health parameter of write operations directed to the primary disk 710 may include at least one of the latency of write operations directed to the primary disk 710 or the rate of write operations directed to the primary disk 710. As an example, the node 700 may monitor and determine at least one of the latency or the rate of write operations directed to the primary disk 710 during execution of the write operations.

In some embodiments, in response to monitoring and determining the primary disk health parameter of write operations directed to the primary disk 710, the node 700 may determine whether the primary disk health parameter indicates that the primary disk 710 is experiencing transient unavailability. The node 700 may determine whether the primary disk health parameter indicates that the primary disk 710 is experiencing transient unavailability by comparing the primary disk health parameter to a threshold primary disk health parameter. When the primary disk health parameter includes the latency of write operations directed to the primary disk 710, the node 700 may determine whether the primary disk health parameter is indicative of the primary disk 710 experiencing transient unavailability by comparing the determined latency to a threshold latency. As an example, the threshold latency may be in a range of 50 milliseconds (ms) to 20 seconds and may preferably be 200 ms. When the primary disk health parameter includes the rate of write operations directed to the primary disk 710, the node 700 may determine whether the primary disk health parameter is indicative of the primary disk 710 experiencing transient unavailability by comparing the determined rate to a threshold rate. As an example, the threshold rate may be in a range of 1 MB per second to 3500 MB per second. The node 700 may continuously and/or periodically compare the primary disk health parameter to the threshold primary disk health parameter, such as by comparing the determined latency to the threshold latency or comparing the determined rate to the threshold rate.

In response to the comparison of the primary disk health parameter to the threshold primary disk health parameter, the node 700 may determine that a transient unavailability exists at the primary disk 710 and may switch from the primary disk 710 to the secondary disk 720, thereby failing over write operations to the secondary disk 720 while the transient unavailability exists at the primary disk 710. In response to the comparison of the primary disk health parameter to the threshold primary disk health parameter, the node 700 may determine that a transient unavailability does not exist at the primary disk 710 and may continue executing write operations by writing to the primary disk 710. When the primary disk health parameter includes the latency of write operations directed to the primary disk 710 and when the determined latency is greater than the threshold latency, the node 700 may determine that a transient unavailability exists at the primary disk 710 and may switch from the primary disk 710 to the secondary disk 720, thereby failing over write operations to the secondary disk 720 while the transient unavailability exists at the primary disk 710. When the primary disk health parameter includes the rate of write operations directed to the primary disk 710 and when the determined rate is less than the threshold rate, the node 700 may determine that a transient unavailability exists at the primary disk 710 and may switch from the primary disk 710 to the secondary disk 720, thereby failing over write operations to the secondary disk 720 while the transient unavailability exists at the primary disk 710.

In some embodiments, in response to switching from the primary disk 710 to the secondary disk 720, the node 700 may direct one or more (e.g., any) received write requests (e.g., batches of write requests) directed to the primary disk 710 and that have not completed execution to write to the secondary disk 720 instead of the primary disk 710. As an example, in response to switching from the primary disk 710 to the secondary disk 720, the node 700 may direct one or more (e.g., any) received write requests directed to the particular KV store for which a disk of the node is configured as the primary disk 710 and that have not completed execution to write to the secondary disk 720 instead of the primary disk 710. Accordingly, the node 700 may direct all received write requests (e.g., batches of write requests) directed to the particular KV store and that have not begun executing or are currently executing by writing to the primary disk 710 to instead write to the secondary disk 720.

In some cases, in response to switching from the primary disk 710 to the secondary disk 720, the node 700 may continue to execute a write request and/or a batch of write requests that was executing by writing to the WAL file segment 730a stored by the primary disk 710 when the node 700 switched from the primary disk 710 to the secondary disk 720. In some cases, in response to switching from the primary disk 710 to the secondary disk 720, the node 700 may generate and cause storage of one or more WAL file segments including a WAL file segment 730b of a WAL file by the secondary disk 720. Based on the received write requests and in response to switching to the secondary disk 720, the node 700 may write to both the memtable stored in-memory and to the generated WAL file segment 730b stored by the secondary disk 720. The WAL file segment 730b stored by the secondary disk 720 may be different from the WAL file segment 730a stored by the primary disk 710. The node 700 may write one or more WAL records to the WAL file segment 730b as described herein, with the WAL records corresponding to batches of executed write requests. In some cases, execution of write requests by writing to the secondary disk 720 may occur sequentially, such that the node 700 may only execute one write request at a particular instant in time for a particular disk. In some cases, the node 700 may determine to execute a batch of one or more write requests by writing to a WAL file segment stored by the secondary disk 720, such that the node 700 continues to execute the write requests included in that batch by writing to the secondary disk 720 even upon switching back to the primary disk 710 after recovering from WAL failover based on detecting that a transient unavailability no longer exists at the primary disk 710. In some cases, when a write request and/or batch of write requests was executing when the node 700 switched from the primary disk 710 to the secondary disk 720, the node 700 may execute that write request and/or batch of write requests by writing to both the WAL file segment 730a stored by the primary disk 710 and the WAL file segment 730b stored by the secondary disk 720, thereby causing the different WAL file segments 730a, 730b to have one or more of the same (i.e., duplicate) WAL records including the same KV data. Such duplicate WAL records may be de-duplicated and reordered as described herein upon recovery of the WAL file on the primary disk 710.

In some embodiments, in response to switching from the primary disk 710 to the secondary disk 720 and during execution of write requests by writing to the WAL file segment 730b stored by the secondary disk 720, the node 700 may probe the primary disk 710 to determine whether the transient unavailability still exists at the primary disk 710. To probe to the primary disk 710, the node 700 may perform a number of iterations of probe operations directed to writing to the primary disk 710. The probe operations may include executing probe write operations by writing to the primary disk to test whether the transient unavailability of the primary disk has been resolved. During each iteration of the probe operations, the node 700 may monitor a primary disk probe parameter for the probe operations directed to writing to the primary disk 710. Some non-limiting examples of the primary disk probe parameter include a latency of probe operations directed to writing to the primary disk 710 and a rate of probe operations directed to writing to the primary disk 710.

Monitoring the primary disk probe parameter may include continuously or periodically determining one or more values of the primary disk probe parameter by monitoring each iteration of the probe operations directed to the primary disk 710. As an example, the node 700 may continuously or periodically determine one or more values of the latency of probe operations to the primary disk 710 by monitoring the probe operations directed to the primary disk for an iteration of the probe operations. Accordingly, the node 700 may determine and collect one or more values of the primary disk probe parameter by monitoring the probe operations directed to the primary disk 710 for comparison purposes to detect whether transient unavailability of the primary disk 710 has been resolved.

The node 700 may execute the iterations of the probe operations sequentially and periodically. As an example, the node 700 may execute an iteration of the probe operations at an interval in a range of every 0.1 seconds to 10 seconds, and preferably every second, such that the node 700 does not execute an iteration of the probe operations simultaneously with any other iteration of the probe operations directed to the same primary disk 710. In some cases, each iteration of probe operations may include one or more of: (i) generating and storing a new probe WAL file segment of a probe WAL file; (ii) executing a write request (e.g., a batch of write requests) of one or more probe write requests by writing data (e.g., a WAL record) to the generated probe WAL file segment stored by the primary disk 710; (iii) performing a synchronization operation (e.g., fsync operation) that forces writing of data from a buffer (e.g., a non-persistent, volatile storage buffer connected to persistent, non-volatile storage of the primary disk 710) to the probe WAL file segment stored by the primary disk 710; and (iv) deleting the probe WAL file segment from storage by the primary disk 710. The probe WAL file and its included probe WAL file segments may be separate and distinct from WAL files and related WAL file segments generated and written to in response to received write requests. As an example, the probe WAL file and probe WAL file segment(s) may be generated and written to for testing purposes to monitor a primary disk probe parameter (e.g., a latency and/or a rate) of the probe operations directed to the primary disk 710 to determine whether the transient unavailability of primary disk 710 remains ongoing without modifying and/or interrupting ongoing write operations (e.g., from received write requests) directed to the primary disk 710. In some cases, an iteration of probe operations may include one or more additional or alternative steps.

For each iteration of the probe operations, the node 700 may determine a primary disk probe parameter for that iteration of the probe operations. The primary disk probe parameter may include at least one of a latency of probe operations directed to writing to the primary disk 710 or a rate of probe operations directed to writing to the primary disk 710. As an example, the node 700 may monitor and determine at least one of a latency or a rate of probe operations directed to writing to the primary disk 710 during execution of the probe operations.

In some embodiments, a latency of the probe operations directed to writing to the primary disk 710 may be defined as an amount of time to execute an iteration of the probe operations, such as an amount of time between beginning and completing execution of an iteration of the probe operations. A rate of the probe operations directed to writing to the primary disk 710 may be defined as IOPS and/or MB per second written to the primary disk 710 during execution of an iteration of the probe operations. The node 700 may continuously and/or periodically monitor the latency and/or rate of an iteration of probe operations directed to the primary disk 710 during execution of each iteration of the probe operations.

In some embodiments, in response to monitoring and determining the primary disk probe parameter of the probe operations directed to the primary disk 710, the node 700 may determine whether the primary disk probe parameter for the iteration is indicative of the primary disk 710 healing from and no longer experiencing transient unavailability, such that the transient unavailability is resolved. The node 700 may determine whether the primary disk probe parameter is indicative of the primary disk 710 healing from and no longer experiencing transient unavailability by comparing the primary disk probe parameter to a threshold primary disk probe parameter. When the primary disk probe parameter includes the latency of probe operations directed to the primary disk 710 for the iteration, the node 700 may determine whether the primary disk probe parameter is indicative of the primary disk 710 healing from and no longer experiencing transient unavailability by comparing the determined latency to a threshold latency. As an example, the threshold latency may be in a range of 1 ms to 20 seconds and may preferably be 25 ms. When the primary disk probe parameter includes the rate of probe operations directed to the primary disk 710 for the iteration, the node 700 may determine whether the primary disk probe parameter is indicative of the primary disk 710 healing from and no longer experiencing transient unavailability by comparing the determined rate to a threshold rate. As an example, the threshold rate may be in a range of 1 MB per second to 3500 MB per second. The threshold latency and/or threshold rate for the probe operations may be the same as or different from the threshold latency and/or threshold rate for the write operations. The node 700 may compare the primary disk probe parameter for the iteration to the threshold primary disk probe parameter in response to completing execution of the iteration of the probe operations.

Based on the comparison of the primary disk probe parameter to the threshold primary disk probe parameter, the node 700 may determine the transient unavailability is resolved and no longer exists at the primary disk 710 and may switch from the secondary disk back to the primary disk 710, thereby recovering from failing over write operations to the secondary disk 720 when the transient unavailability no longer exists at the primary disk 710. Based on the comparison of the primary disk probe parameter to the threshold primary disk probe parameter, the node 700 may determine the transient unavailability of the primary disk 710 remains ongoing and may continue executing write operations by writing to the secondary disk 720. When the primary disk probe parameter includes the latency of probe operations directed to the primary disk 710 and when the determined latency for the iteration is less than the threshold latency, the node 700 may determine the transient unavailability is resolved and no longer exists at the primary disk 710 and may switch from the secondary disk back to the primary disk 710, thereby recovering from failing over write operations to the secondary disk 720 when the transient unavailability no longer exists at the primary disk 710. When the primary disk probe parameter includes the rate of probe operations directed to the primary disk 710 and when the determined rate for the iteration is greater than the threshold rate, the node 700 may determine the transient unavailability is resolved and no longer exists at the primary disk 710 and may switch from the secondary disk back to the primary disk 710, thereby recovering from failing over write operations to the secondary disk 720 when the transient unavailability no longer exists at the primary disk 710.

In response to the comparison of the primary disk probe parameter to the threshold primary disk probe parameter indicating that the transient unavailability is resolved and no longer exists at the primary disk 710, the node 700 may cease execution of the probe operations directed to the primary disk 710. The node 700 may resume execution of the probe operations when transient unavailability of the primary disk 710 again exists and/or is indicated by the primary disk health parameter as described herein. Accordingly, the node 700 may only execute probe operations directed to the primary disk 710 in response to (i) switching from the primary disk 710 to the secondary disk 720 and/or (ii) the primary disk health parameter indicating transient unavailability of the primary disk 710. Further, the node 700 may stop execution of ongoing probe operations directed to the primary disk 710 in response to (i) switching from the secondary disk 720 to the primary disk 710, (ii) the at least one primary disk probe parameter indicating the transient unavailability of the primary disk 710 is resolved, and/or (iii) the secondary disk health parameter indicates transient unavailability of the secondary disk 720.

In some embodiments, when the primary disk probe parameter includes the latency of probe operations directed to the primary disk 710, the node 700 may only determine the transient unavailability is resolved and no longer exists at the primary disk 710 and switch from the secondary disk 720 back to the primary disk 710 when a threshold number of consecutive iterations of the probe operations have a determined latency less than the threshold latency. Accordingly, in some cases, the node 700 may continue to execute sequential iterations of the probe operations directed to the primary disk 710 until a threshold number of consecutive iterations of the probe operations have a determined latency less than the threshold latency. Further, when the primary disk probe parameter includes the rate of probe operations directed to the primary disk 710, the node 700 may only determine the transient unavailability is resolved and no longer exists at the primary disk 710 and switch from the secondary disk 720 back to the primary disk 710 when a threshold number of consecutive iterations of the probe operations have a determined rate greater than the threshold rate. Accordingly, in some cases, the node 700 may continue to execute sequential iterations of the probe operations directed to the primary disk 710 until a threshold number of consecutive iterations of the probe operations have a determined rate greater than the threshold rate. As an example, the threshold number of consecutive iterations may be in a range of two iterations and thirty iterations and may preferably be fifteen iterations. Any suitable threshold number of consecutive iterations may be used. Such a solution that requires particular conditions for a threshold number of consecutive iterations of the probe operations may be advantageous to use to ensure that the transient unavailability of the primary disk has resolved for more than a transient period of time before switching from the secondary disk 720 back to the primary disk 710.

In some embodiments, in response to switching from the primary disk 710 to the secondary disk 720 and during execution of write requests by writing to the WAL file segment 730b stored by the secondary disk 720, the node 700 may continuously or periodically monitor and determine a secondary disk health parameter of write operations directed to the secondary disk 720. The secondary disk health parameter of write operations directed to the secondary disk 720 may include at least one of the latency of write operations directed to the secondary disk 720 or the rate of write operations directed to the secondary disk 720. As an example, the node 700 may monitor and determine at least one of the latency or the rate of write operations directed to the secondary disk 720 during execution of the write operations.

In some embodiments, in response to monitoring and determining the secondary disk health parameter of write operations directed to the secondary disk 720, the node 700 may determine whether the secondary disk health parameter indicates that the secondary disk 720 is experiencing transient unavailability. The node 700 may determine whether the secondary disk health parameter indicates that the secondary disk 720 is experiencing transient unavailability by comparing the secondary disk health parameter to a threshold secondary disk health parameter. When the secondary disk health parameter includes the latency of write operations directed to the secondary disk 720, the node 700 may determine whether the secondary disk health parameter is indicative of the secondary disk 720 experiencing transient unavailability by comparing the determined latency to a threshold latency. As an example, the threshold latency may be in a range of 50 milliseconds (ms) to 20 seconds and may preferably be 200 ms. When the secondary disk health parameter includes the rate of write operations directed to the secondary disk 720, the node 700 may determine whether the secondary disk health parameter is indicative of the secondary disk 720 experiencing transient unavailability by comparing the determined rate to a threshold rate. As an example, the threshold rate may be in a range of 1 MB per second to 3500 MB per second. The node 700 may continuously and/or periodically compare the secondary disk health parameter to the threshold secondary disk health parameter, such as by comparing the determined latency to the threshold latency or comparing the determined rate to the threshold rate.

In response to the comparison of the secondary disk health parameter to the threshold secondary disk health parameter, the node 700 may determine that a transient unavailability exists at the secondary disk 720 and may switch from the secondary disk 720 to the primary disk 710, thereby failing over write operations to the primary disk 710 while the transient unavailability exists at the secondary disk 720. In response to the comparison of the secondary disk health parameter to the threshold secondary disk health parameter, the node 700 may determine that a transient unavailability does not exist at the secondary disk 720 and may continue executing write operations by writing to the secondary disk 720. When the secondary disk health parameter includes the latency of write operations directed to the secondary disk 720 and when the determined latency is greater than the threshold latency, the node 700 may determine that a transient unavailability exists at the secondary disk 720 and may switch from the secondary disk 720 to the primary disk 710, thereby failing over write operations to the primary disk 710 while the transient unavailability exists at the secondary disk 720. When the secondary disk health parameter includes the rate of write operations directed to the secondary disk 720 and when the determined rate is less than the threshold rate, the node 700 may determine that a transient unavailability exists at the secondary disk 720 and may switch from the secondary disk 720 to the primary disk 710, thereby failing over write operations to the primary disk 710 while the transient unavailability exists at the secondary disk 720. Accordingly, the node 700 may use at least one of the primary disk probe parameter or secondary disk health parameter to determine whether to switch back to the primary disk 710 from the secondary disk 720 using the techniques described herein. As an example, the node 700 may use both of the primary disk probe parameter and the secondary disk health parameter to determine whether to switch back to the primary disk 710 from the secondary disk 720 using the techniques described herein.

In some embodiments, in response to switching from the secondary disk 720 back to the healed primary disk 710, the node 700 may direct any received write requests (e.g., batches of write requests) that have not completed execution to write to the primary disk 710 instead of the secondary disk 720. Accordingly, in response to switching from the secondary disk 720 back to the healed primary disk 710, the node 700 may direct all received write requests (e.g., batches of write requests) that have not begun executing or are currently executing by writing to the secondary disk 720 to instead write to the primary disk 710. In some cases, in response to switching from the secondary disk 720 to the primary disk 710, the node 700 may continue to execute a write request and/or batch of write requests that was executing by writing to WAL file segment 730b stored by the secondary disk 720 when the node 700 switched from the secondary disk 720 to the primary disk 710. In some cases, in response to switching from the secondary disk 720 back to the primary disk 710, the node 700 may generate and cause storage of a WAL file segment 730c of the WAL file by the primary disk 710. Based on the received write requests and in response to switching to the primary disk 710, the node 700 may write to both the memtable stored in-memory and to the generated WAL file segment 730c stored by the primary disk 710. The WAL file segment 730c stored by the primary disk 710 may be different from the WAL file segment 730a stored by the primary disk 710 and the WAL file segment 730b stored by the secondary disk 720. The node 700 may write one or more WAL records to the WAL file segment 730c as described herein, with the WAL records corresponding to batches of executed write requests. In some cases, when a write request and/or batch of write requests was executing when the node 700 switched from the secondary disk 720 back to the primary disk 710, the node 700 may execute that write request and/or batch of write requests by writing to both the WAL file segment 730b stored by the secondary disk 720 and the WAL file segment 730c stored by primary disk 710, thereby causing the different WAL file segments 730b, 730c to have one or more of the same (i.e., duplicate) WAL records including the same KV data. Such duplicate WAL records may be de-duplicated and reordered as described herein upon recovery of the WAL file on the primary disk 710. In some cases, each of the different WAL file segments 730a, 730b, 730c may have one or more of the same (i.e., duplicate) WAL records including the same KV data. Such duplicate WAL records may be de-duplicated and reordered as described herein upon recovery of the WAL file on the primary disk 710.

In some embodiments, in response to switching from the secondary disk 720 back to the primary disk 710, the node 700 may recover any non-duplicative WAL records from the WAL file segment 730b stored by the secondary disk 720. To recover non-duplicative WAL records from the WAL file segment 730b, the node 700 may read from the WAL records included in the WAL file segment 730b to determine the sequence identifiers of each of the WAL records included in the WAL file segment 730b. The node 700 may further read from the WAL records included in the WAL file segments 730a, 730c to determine the sequence identifiers of each of the WAL records included in the WAL file segments 730a, 730c. In response to determining the sequence identifiers of each of the WAL records of the WAL file segments 730a, 730b, 730c, the node 700 may compare each of the sequence identifiers of the WAL records to identify any duplicative WAL records having the same sequence identifier. In response to identifying any duplicative WAL records having the same sequence identifier, the node 700 may proceed to copy and write the WAL records of the WAL file segment 730b stored by the secondary disk 720 that are not duplicative with the WAL records of the WAL file segments 730a, 730c to the WAL file segment 730c stored by the primary disk 710. Accordingly, the node 700 may identify and copy only the WAL file records and included written KV data from the WAL file segment 730b to the WAL file segment 730c that are different (i.e., non-duplicative) from the WAL file records of the WAL file segments 730a, 730c stored by the primary disk 710. By copying only the different WAL records having different sequence numbers, the node 700 can cause storage of each of the unique WAL records by the primary disk 710 and recover the logical WAL file and the written KV data included therein to be fully stored by the primary disk 710 for durability purposes. In response to copying WAL records from the WAL file segment 730b to the WAL file segment 730c, the node may delete the WAL file segment 730b from storage by the secondary disk 720.

In some embodiments, the node 700 may generate one or more additional WAL file segments of the logical WAL file, cause storage of the WAL file segments by the primary disk 710 and/or the secondary disk 720, and write to the stored WAL file segments. The node 700 may proceed to copy any non-duplicative WAL records from WAL file segments (e.g., including the WAL file segment 730b) stored by the secondary disk 720 to the primary disk 710 as described herein. Further, the node 700 may order the copied WAL records within the WAL file segment 730c by sequence number (e.g., in increasing order), such that older WAL records having lower sequence numbers are ordered before newer WAL records having higher sequence numbers. Accordingly, the node 700 may generate and store a de-duplicated, ordered set of WAL records of one or more WAL files stored by the primary disk 710 after switching back to the primary disk 710 from the secondary disk 720 after the node determines the transient unavailability of the primary disk 710 is resolved. The node 700 may proceed to execute write operations directed to the primary disk 710 (e.g., from received write requests) and monitor a latency and/or rate of the write operations directed to the primary disk 710 as described herein to determine whether a transient unavailability exists at the primary disk 710.

### Exemplary Method for Failover Between Disks in the Event of Transient Unavailability

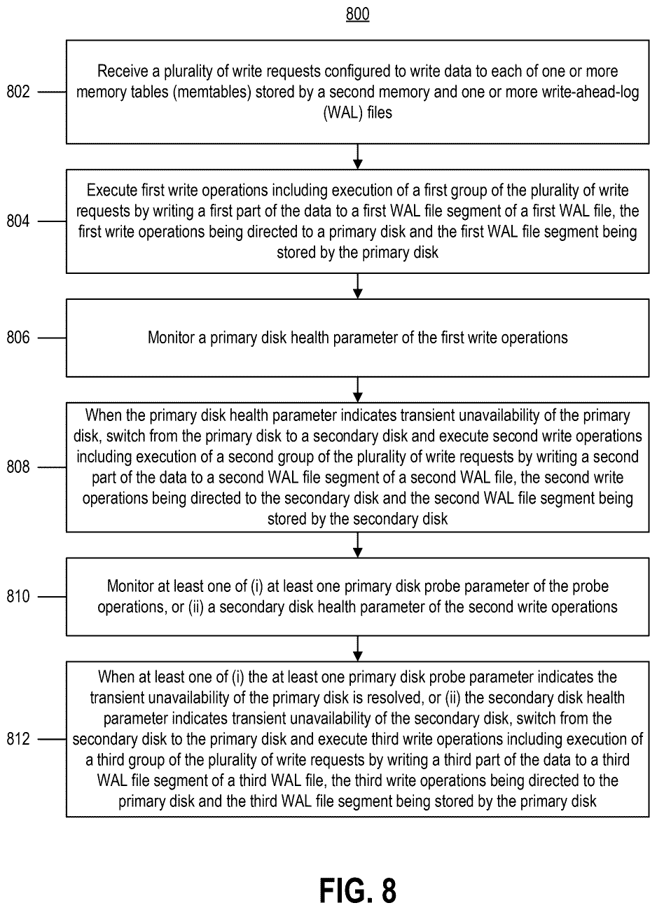

In some embodiments, as described herein, a disk configured as a primary disk for a particular logical KV store including data of one or more workloads may experience transient unavailability. To avoid increased latencies resulting from write requests slowing or stalling when writing to a WAL file segment stored by the primary disk, a node operating the primary disk may execute techniques for WAL failover. Referring to FIG. 8, an exemplary flowchart of a method 800 for failover between disks in the event of transient unavailability is illustrated. While the method 800 is described with respect to failover from a particular primary disk to a secondary disk for a KV store at a single node of the cluster based on detected transient unavailability of the primary disk, the method 800 may be executed in parallel (e.g., simultaneously) by a single node and/or by multiple nodes for multiple different KV stores operated by the node(s). As an example, a single node may execute the method 800 in parallel for a single physical disk when at least two virtual disks are stored by (e.g., multiplexed on) the physical disk and one of the virtual disks is configured as a primary disk for a particular KV store and another, different virtual disk of the virtual disks is configured as a secondary disk for the particular KV store. As another example, a single node may execute the method 800 in parallel for different KV stores having different configured primary and secondary disks operated and/or otherwise available to the node. Each of write requests described with respect to the method 800 may be directed to writing to the same KV store for which a first disk of a node is configured as a primary disk and a second disk of the node is configured as a secondary disk. In some cases, each of the write requests may correspond to the same workload. In some cases, a computer-readable storage medium may store instructions that are configured, when executed by one or more processing devices of a system, to cause the system to perform the operations o the method 800.

At step 802, a node may receive a number of write requests configured to write data to each of one or more memtables stored by a memory and one or more WAL files. The write requests may be included in one or more transactions originating from one or more client devices and directed to replicas of one or more ranges stored by a particular KV store operated by the node. The data may include KV data, with the KV data of each memtable of the one or more memtables being sorted by key (e.g., after being written to a memtable of the one or more memtables). The KV data may include a number of KV pairs each including a respective key mapped to a respective value. Each of the one or more memtables may be mapped to a respective one of the one or more WAL files. The memory may be a non-persistent, volatile storage device. The primary disk may be a first persistent, non-volatile storage device and the secondary disk may be a second persistent, non-volatile storage device different from the first persistent, non-volatile storage device. The primary disk may be a first virtual disk provisioned from, mapped to, and/or otherwise backed by one or more first persistent, non-volatile storage devices and the secondary disk may be a second virtual disk provisioned from, mapped to, and/or otherwise backed by one or more second persistent, non-volatile storage devices, the first virtual disk being different from the second virtual disk. As an example, the primary disk may be a first virtual disk multiplexed on one or more first persistent, non-volatile storage devices and the secondary disk may be a second virtual disk multiplexed on one or more second persistent, non-volatile storage devices, the first virtual disk being different from the second virtual disk.

At step 804, in response to receiving at least one of the write requests, the node may execute first write operations. The first write operations may be directed to the primary disk (e.g., by writing to the primary disk). The first write operations may include executing a first group of the number of write requests by writing a first part of the data to a first WAL file segment of a first WAL file of the one or more WAL files, the first WAL file segment being stored by the primary disk. The first write operations may include generating and causing storage of the first WAL file segment by the primary disk. The first write operations may include synchronizing first metadata of a first memtable of the one or more memtables with the first WAL file segment by writing the first metadata to the first WAL file segment.

At step 806, the node may monitor, during execution of the first write operations, a primary disk health parameter of the first write operations. The primary disk health parameter may include a primary disk latency of the first write operations. Accordingly, the node may monitor, during execution of the first write operations, the primary disk latency of the first write operations. In some cases, when the primary disk health parameter includes a primary disk rate of the first write operations, the node may additionally or alternatively monitor, during execution of the first write operations, the primary disk rate of the first write operations.

At step 808, when the node determines the primary disk health parameter indicates transient unavailability of the primary disk, the node may switch from the primary disk to a secondary disk and execute second write operations. The second write operations may be directed to the secondary disk (e.g., by writing to the secondary disk). The second write operations may include execution of a second group of the number of write requests by writing a second part of the data to a second WAL file segment of a second WAL file of the one or more WAL files. The second WAL file segment may be stored by the secondary disk. The primary disk health parameter may indicate transient unavailability of the primary disk when the primary disk latency is greater than a threshold primary disk latency. Accordingly, when the primary disk latency is greater than the threshold primary disk latency, the node may switch from the primary disk to the secondary disk and execute the second write operations directed to the secondary disk.

In some cases, the primary disk health parameter may indicate transient unavailability of the primary disk when the primary disk rate of the first write operations is less than a threshold primary disk rate. When the primary disk health parameter includes the primary disk rate of the first write operations and the node additionally or alternatively determines the primary disk rate of the first write operations is less than the threshold primary disk rate, the node may switch from the primary disk to the secondary disk and execute the second write operations directed to the secondary disk including execution of the second group of the number of write requests by writing the second part of the data to the second WAL file segment of the second WAL file.

In some cases, based on execution of a write request or a batch of one or more write requests during switching from the primary disk to the secondary disk, at least one write request of the first group of the number of write requests may be the same as at least one write request of the second group of the number of write requests. When at least one write request of the first group of the number of write requests is the same as at least one write request of the second group of the number of write requests, the first WAL file segment may include a first number of WAL records including the first part of the data, the second WAL file segment may include a second number of WAL records including the second part of the data, and at least one WAL record of the first number of WAL records may be a duplicate of at least one WAL record of the second number of WAL records.

In some cases, based on a lack of execution of a write request or a batch of one or more write requests during switching from the primary disk to the secondary disk, the first WAL file segment may include a first number of WAL records including the first part of the data, the second WAL file segment may include a second number of WAL records including the second part of the data, no WAL record of the first number of WAL records may be a duplicate of any WAL record of the second number of WAL records, and no WAL record of the second number of WAL records may be a duplicate of any WAL record of the first number of WAL records. In some cases, no WAL record of the first and second WAL file segments may be a duplicate.

At step 810, in response to switching from the primary disk to the secondary disk, the node may monitor at least one of (i) at least one primary disk probe parameter of probe operations directed to the primary disk, or (ii) a secondary disk health parameter of the second write operations. The node may monitor at least one of (i) the at least one primary disk probe parameter of the probe operations or (ii) the secondary disk health parameter of the second write operations during execution of at least one of (i) the second write operations or (ii) the probe operations. The node may monitor both the at least one primary disk probe parameter and the secondary disk health parameter of the second write operations during execution of both the second write operations and the probe operations. The node may monitor at least one primary disk probe parameter of the probe operations during execution of the probe operations. The node may monitor the secondary disk health parameter of the second write operations during execution of the second write operations.

The at least one primary disk probe parameter may include at least one disk probe latency of the probe operations. Accordingly, the node may monitor, in response to switching from the primary disk to the secondary disk and during execution of the probe operations, the at least one disk probe latency of the probe operations. In some cases, when the primary disk probe parameter includes at least one disk probe rate of the probe operations, the node may additionally or alternatively monitor, in response to switching from the primary disk to the secondary disk and during execution of the probe operations, the at least one disk probe rate of the probe operations.

In some cases, the node may execute the probe operations by iteratively executing a number of iterations of the probe operations, such as one or more iterations, two or more iterations, etc. In some cases, each iteration of the probe operations may include one or more of: generating and causing storage of a probe file by the primary disk; writing, in response to causing storage of the probe file, probe data to the probe file; synchronizing, in response to writing the probe data to the probe file, the probe data; and deleting, in response to synchronizing the probe data, the probe file from storage by the primary disk.

The secondary disk health parameter may include a secondary disk latency of the second write operations. Accordingly, the node may monitor, during execution of the second write operations, the secondary disk latency of the second write operations. In some cases, when the secondary disk health parameter includes a secondary disk rate of the second write operations, the node may additionally or alternatively monitor, during execution of the second write operations, the secondary disk rate of the second write operations.

At step 812, when at least one of (i) the at least one primary disk probe parameter indicates the transient unavailability of the primary disk is resolved or (ii) the secondary disk health parameter indicates transient unavailability of the secondary disk, the node may switch from the secondary disk to the primary disk and execute third write operations. The third write operations may be directed to the primary disk (e.g., by writing to the primary disk). The third write operations may include execution of a third group of the number of write requests by writing a third part of the data to a third WAL file segment of a third WAL file of the one or more WAL files. The third WAL file segment may be stored by the primary disk.

In some cases, one or more of the WAL files may be the same WAL file or different WAL files. Two or more of the first WAL file, the second WAL file, and the third WAL file may be the same WAL file. As an example, the first and second WAL files may be the same WAL file, the second and third WAL files may be the same WAL file, and/or each of the first, second, and third WAL files may be the same WAL file. Two or more of the first WAL file, the second WAL file, and the third WAL file may be different WAL files. As an example, the first and second WAL files may be different WAL files, the second and third WAL files may be different WAL files, and/or each of the first, second, and third WAL files may be different WAL files.

In some cases, when the at least one primary disk probe parameter includes the at least one disk probe latency, the at least one primary disk probe parameter may indicate the transient unavailability of the primary disk is resolved when the at least one disk probe latency is less than a threshold disk probe latency. Accordingly, when the at least one disk probe latency is less than a threshold disk probe latency, the node may switch from the secondary disk to the primary disk and execute the third write operations directed to the primary disk.

In some cases, when the at least one primary disk probe parameter includes the at least one disk probe latency, the at least one disk probe latency may further include a number of disk probe latencies, such as two or more disk probe latencies each determined for different iterations of the probe operations. The node may determine, for each iteration of the probe operations, a respective disk probe latency of the number of disk probe latencies, the respective disk probe latency being for that iteration of the probe operations. When the node determines the respective disk probe latencies of a threshold number of consecutive iterations of the probe operations are each less than the threshold disk probe latency, the node may switch from the secondary disk to the primary disk and execute the third write operations directed to the primary disk.

In some cases, when the at least one primary disk probe parameter includes the at least one disk probe rate, the at least one primary disk probe parameter may indicate the transient unavailability of the primary disk is resolved when the at least one disk probe rate is greater than a threshold disk probe rate. Accordingly, additionally or alternatively, when the at least one primary disk probe parameter includes at least one disk probe rate of the probe operations and the at least one disk probe rate is greater than the threshold disk probe rate, the node may switch from the secondary disk to the primary disk and execute the third write operations directed to the primary disk. In some cases, the at least one disk probe rate may further include a number of disk probe rates, such as two or more disk probe rates each determined for different iterations of the probe operations. The node may determine, for each iteration of the probe operations, a respective disk probe rate of the number of disk probe rates, the respective disk probe rate being for that iteration of the probe operations. When the node determines the respective disk probe rates of a threshold number of consecutive iterations of the probe operations are each greater than the threshold disk probe rate, the node may switch from the secondary disk to the primary disk and execute the third write operations directed to the primary disk.

In some cases, the secondary disk health parameter may indicate transient unavailability of the secondary disk when the secondary disk latency is greater than a threshold secondary disk latency. Accordingly, when the secondary disk latency is greater than the threshold secondary disk latency, the node may switch from the secondary disk to the primary disk and execute the third write operations directed to the primary disk.

In some cases, the secondary disk health parameter may indicate transient unavailability of the secondary disk when the secondary disk rate is less than a threshold secondary disk rate.

When the secondary disk health parameter includes the secondary disk rate of the second write operations and the node additionally or alternatively determines the secondary disk rate of the second write operations is less than the threshold secondary disk rate, the node may switch from the secondary disk to the primary disk and execute the third write operations directed to the primary disk.

In some cases, each write request of the first group of the number of write requests may be different from each write request of the third group of the number of write requests. Based on execution of a write request or a batch of one or more write requests during switching from the secondary disk back to the primary disk, at least one write request of the second group of the number of write requests may be the same as at least one write request of the third group of the number of write requests. When at least one write request of the second group of the number of write requests is the same as at least one write request of the third group of the number of write requests, the second WAL file segment may include a second number of WAL records including the second part of the data, the third WAL file segment may include a third number of WAL records including the third part of the data, and at least one WAL record of the second number of WAL records may be a duplicate of at least one WAL record of the third number of WAL records. In some cases, based on a lack of execution of a write request or batch of one or more write requests during switching from the secondary disk back to the primary disk, the second WAL file segment may include a second number of WAL records including the second part of the data, the third WAL file segment may include a third number of WAL records including the third part of the data, no WAL record of the second number of WAL records may be a duplicate of any WAL record of the third number of WAL records, and no WAL record of the third number of WAL records may be a duplicate of any WAL record of the second number of WAL records. In some cases, no WAL record of the second and third WAL file segments may be a duplicate.

In some cases, one or more of: the execution of the first group of the number of write requests may further include writing the first part of the data to a first memtable of the one or more memtables, the execution of the second group of the number of write requests may further include writing the second part of the data to a second memtable of the one or more memtables, and the execution of the third group of the number of write requests may further include writing the third part of the data to a third memtable of the one or more memtables.

In some cases, one or more of the memtables may be same memtable or different memtables. Two or more of the first memtable, the second memtable, and the third memtable may be the same memtable. As an example, the first and second memtables may be the same memtable, the second and third memtables may be the same memtable, and/or each of the first, second, and third memtables may be the same memtable. Two or more of the first memtable, the second memtable, and the third memtable may be different memtables. As an example, the first and second memtables may be different memtables, the second and third memtables may be different memtables, and/or each of the first, second, and third memtables may be different memtables.

In some cases, the method 800 may additionally or alternatively include one or more steps. In some cases, in response to switching from the secondary disk to the primary disk, the node may write and cause storage of, at least part of the second part of the data of the second WAL file segment to the primary disk. In some cases, writing and causing storage of at least part of the second part of the data of the second WAL file segment to the primary disk may include ordering and de-duplicating one or more of (e.g., each of) (i) a first number of WAL records of the first WAL file segment, (ii), a second number of WAL records of the second WAL file segment, or (iii) a third number of WAL records of the third WAL file segment based on the first part of the data, the second part of the data, and the third part of the data. In some cases, when a first memtable of the one or more memtables meets or exceeds a threshold storage size, the node may flush the first memtable to generate a first SST file of a number of SST files stored by the primary disk. The SST files may be organized in an LSM tree including one or more levels. In response to the flushing of the first memtable, the node may delete both the first memtable from storage by the memory and the first WAL file from storage by the primary disk and generate a second memtable of the one or more memtables stored by the memory. The second memtable may be a new memtable stored in the memory that is separate and distinct from the first memtable. An additional WAL file and a related WAL file segment may be generated and mapped to the second memtable as described herein.

### FURTHER DESCRIPTION OF SOME EMBODIMENTS

FIG. 9 is a block diagram of an example computer system 900 that may be used in implementing the technology described in this document. General-purpose computers, network appliances, mobile devices, or other electronic systems may also include at least portions of the system 900. The system 900 includes a processor 910, a memory 920, a storage device 930, and an input/output device 940. Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-state drive, a flash drive, or some other large capacity storage device. For example, the storage device may store long-term data (e.g., database data, file system data, etc.). The input/output device 940 provides input/output operations for the system 900. In some implementations, the input/output device 940 may include one or more of a network interface devices, e.g., an Ethernet card, a serial communication device, e.g., an RS-232 port, and/or a wireless interface device, e.g., an 802.11 card, a 3G wireless modem, a 4G wireless modem, or a 5G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 930 may be implemented in a distributed way over a network, for example as a server farm or a set of widely distributed servers, or may be implemented in a single computing device.

Although an example processing system has been described in FIG. 9, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for failover between disks during transient unavailability, the system comprising:
a processor; and
a memory storing instructions that, when executed by the processor, configure the system to perform operations comprising:
receiving a plurality of write requests configured to write data to each of one or more memory tables (memtables) stored by a second memory and one or more write-ahead-log (WAL) files;
executing first write operations comprising execution of a first group of the plurality of write requests by writing a first part of the data to a first WAL file segment of a first WAL file of the one or more WAL files, the first write operations being directed to a primary disk and the first WAL file segment being stored by the primary disk;
monitoring a primary disk health parameter of the first write operations;
when the primary disk health parameter indicates transient unavailability of the primary disk, switching from the primary disk to a secondary disk and executing second write operations comprising execution of a second group of the plurality of write requests by writing a second part of the data to a second WAL file segment of a second WAL file of the one or more WAL files, the second write operations being directed to the secondary disk and the second WAL file segment being stored by the secondary disk;
monitoring, in response to switching from the primary disk to the secondary disk, at least one of (i) at least one primary disk probe parameter of probe operations directed to the primary disk, or (ii) a secondary disk health parameter of the second write operations; and
when at least one of (i) the at least one primary disk probe parameter indicates the transient unavailability of the primary disk is resolved, or (ii) the secondary disk health parameter indicates transient unavailability of the secondary disk, switching from the secondary disk to the primary disk and executing third write operations comprising execution of a third group of the plurality of write requests by writing a third part of the data to a third WAL file segment of a third WAL file of the one or more WAL files, the third write operations being directed to the primary disk and the third WAL file segment being stored by the primary disk.

2. The system of claim 1, wherein the second memory is a non-persistent, volatile storage device, the primary disk is a first persistent, non-volatile storage device, and the secondary disk is a second persistent, non-volatile storage device different from the first persistent, non-volatile storage device.

3. The system of claim 1, wherein the second memory is a non-persistent, volatile storage device, the primary disk is a first virtual disk multiplexed on one or more first persistent, non-volatile storage devices, and the secondary disk is a second virtual disk multiplexed on one or more second persistent, non-volatile storage devices, the first virtual disk being different from the second virtual disk.

4. The system of claim 1, wherein (i) the data comprises key-value (KV) data, (ii) the KV data of each memtable of the one or more memtables is sorted by key, and (iii) each of the one or more memtables is mapped to a respective one of the one or more WAL files.

5. The system of claim 1, wherein two or more of the first WAL file, the second WAL file, and the third WAL file are a same WAL file of the one or more WAL files.

6. The system of claim 1, wherein two or more of the first WAL file, the second WAL file, and the third WAL file are different WAL files of the one or more WAL files.

7. The system of claim 1, wherein (i) the first WAL file segment comprises a first plurality of WAL records comprising the first part of the data, (ii) the second WAL file segment comprises a second plurality of WAL records comprising the second part of the data, and (iii) at least one WAL record of the first plurality of WAL records is a duplicate of at least one WAL record of the second plurality of WAL records.

8. The system of claim 1, wherein (i) the first WAL file segment comprises a first plurality of WAL records comprising the first part of the data, (ii) the second WAL file segment comprises a second plurality of WAL records comprising the second part of the data, (iii) no WAL record of the first plurality of WAL records is a duplicate of any WAL record of the second plurality of WAL records, and (iv) no WAL record of the second plurality of WAL records is a duplicate of any WAL record of the first plurality of WAL records.

9. The system of claim 1, wherein (i) the second WAL file segment comprises a second plurality of WAL records comprising the second part of the data, (ii) the third WAL file segment comprises a third plurality of WAL records comprising the third part of the data, and (iii) at least one WAL record of the second plurality of WAL records is a duplicate of at least one WAL record of the third plurality of WAL records.

10. The system of claim 1, wherein (i) the second WAL file segment comprises a second plurality of WAL records comprising the second part of the data, (ii) the third WAL file segment comprises a third plurality of WAL records comprising the third part of the data, (iii) no WAL record of the second plurality of WAL records is a duplicate of any WAL record of the third plurality of WAL records, and (iv) no WAL record of the third plurality of WAL records is a duplicate of any WAL record of the second plurality of WAL records.

11. The system of claim 1, wherein the first write operations further comprise at least one of:
generating and causing storage of the first WAL file segment by the primary disk; and
synchronizing first metadata of a first memtable of the one or more memtables with the first WAL file segment by writing the first metadata to the first WAL file segment.

12. The system of claim 1, wherein:
the execution of the first group of the plurality of write requests further comprises writing the first part of the data to a first memtable of the one or more memtables,
the execution of the second group of the plurality of write requests further comprises writing the second part of the data to a second memtable of the one or more memtables, and
the execution of the third group of the plurality of write requests further comprises writing the third part of the data to a third memtable of the one or more memtables.

13. The system of claim 1, wherein the primary disk health parameter comprises a first latency of the first write operations, wherein the primary disk health parameter indicates the transient unavailability of the primary disk when the first latency is greater than a first threshold latency, and wherein the operations further comprise:
monitoring, during execution of the first write operations, the first latency of the first write operations; and
when the first latency is greater than the first threshold latency, switching from the primary disk to the secondary disk and executing the second write operations directed to the secondary disk.

14. The system of claim 1, wherein the operations further comprise iteratively executing one or more iterations of the probe operations, each iteration of the probe operations comprising:
generating and causing storage of a probe file by the primary disk;
writing, in response to causing storage of the probe file, probe data to the probe file;
synchronizing, in response to writing the probe data to the probe file, the probe data; and
deleting, in response to synchronizing the probe data, the probe file from storage by the primary disk.

15. The system of claim 1, wherein the at least one primary disk probe parameter comprises at least one second latency of the probe operations, wherein the at least one primary disk probe parameter indicates the transient unavailability of the primary disk is resolved when the at least one second latency is less than a second threshold latency, and wherein the operations further comprise:
monitoring, in response to switching from the primary disk to the secondary disk and during execution of the probe operations, the at least one second latency of the probe operations; and
when the at least one second latency is less than the second threshold latency, switching from the secondary disk to the primary disk and executing the third group of the plurality of write requests.

16. The system of claim 15, wherein the at least one second latency further comprises a plurality of second latencies, wherein the operations further comprise:
determining, for each iteration of the probe operations, a respective second latency of the plurality of second latencies, the respective second latency being for that iteration of the probe operations; and
when the respective second latencies of a threshold number of consecutive iterations of the probe operations are each less than the second threshold latency, switching from the secondary disk to the primary disk and executing the third write operations directed to the primary disk.

17. The system of claim 1, wherein the secondary disk health parameter comprises a third latency of the second write operations, wherein the secondary disk health parameter indicates the transient unavailability of the secondary disk when the third latency is greater than a second threshold latency, and wherein the operations further comprise:
monitoring, in response to switching from the primary disk to the secondary disk and during execution of the second write operations, the third latency of the second write operations; and
when the third latency is greater than the third threshold latency, switching from the secondary disk to the primary disk and executing the third write operations directed to the primary disk.

18. The system of claim 1, wherein the operations further comprise:
writing and causing storage of, in response to switching from the secondary disk to the primary disk, at least part of the second part of the data of the second WAL file segment to the primary disk.

19. The system of claim 18, wherein writing and causing storage of at least part of the second part of the data of the second WAL file segment to the primary disk further comprises:
ordering and de-duplicating one or more of: (i) a first plurality of WAL records of the first WAL file segment, (ii) a second plurality of WAL records of the second WAL file segment, or (iii) a third plurality of WAL records of the third WAL file segment based on the first part of the data, the second part of the data, and the third part of the data.

20. The system of claim 1, wherein each write request of the first group of the plurality of write requests is different from each write request of the third group of the plurality of write requests.

21. The system of claim 1, wherein at least one write request of the first group of the plurality of write requests is the same as at least one write request of the second group of the plurality of write requests, and wherein at least one write request of the second group of the plurality of write requests is the same as at least one write request of the third group of the plurality of write requests.

22. The system of claim 1, wherein the operations further comprise:
when a first memtable of the one or more memtables meets or exceeds a threshold storage size, flushing the first memtable to generate a first sorted string table (SST) file of a plurality of SST files stored by the primary disk, wherein the plurality of SST files are organized in a log-structured merge (LSM) tree data structure comprising one or more levels; and
in response to the flushing of the first memtable, deleting both the first memtable from storage by the second memory and the first WAL file from storage by the primary disk and generating a second memtable of the one or more memtables stored by the second memory.

23. A method for failover between disks during transient unavailability, the method comprising:
receiving a plurality of write requests configured to write data to each of one or more memory tables (memtables) stored by a memory and one or more write-ahead-log (WAL) files;
executing first write operations comprising execution of a first group of the plurality of write requests by writing a first part of the data to a first WAL file segment of a first WAL file of the one or more WAL files, the first write operations being directed to a primary disk and the first WAL file segment being stored by the primary disk;
monitoring a primary disk health parameter of the first write operations;
when the primary disk health parameter indicates transient unavailability of the primary disk, switching from the primary disk to a secondary disk and executing second write operations comprising execution of a second group of the plurality of write requests by writing a second part of the data to a second WAL file segment of a second WAL file of the one or more WAL files, the second write operations being directed to the secondary disk and the second WAL file segment being stored by the secondary disk;
monitoring, in response to switching from the primary disk to the secondary disk, at least one of (i) at least one primary disk probe parameter of probe operations directed to the primary disk, or (ii) a secondary disk health parameter of the second write operations; and
when at least one of (i) the at least one primary disk probe parameter indicates the transient unavailability of the primary disk is resolved, or (ii) the secondary disk health parameter indicates transient unavailability of the secondary disk, switching from the secondary disk to the primary disk and executing third write operations comprising execution of a third group of the plurality of write requests by writing a third part of the data to a third WAL file segment of a third WAL file of the one or more WAL files, the third write operations being directed to the primary disk and the third WAL file segment being stored by the primary disk.
